(19) United States
(12) Patent Application Publication
(10) Pub. No.: US 2007/0208597 A1
(43) Pub. Date: Sep. 6, 2007

(54) SYSTEM AND METHOD FOR OSTEOPOROSIS ASSESSMENT AND MEDICATION ADHERENCE EVALUATION

(76) Inventors: Chris Recknor, Gainesville, GA (US); Stephanie Grant, Gainesville, GA (US)

Correspondence Address: CANTOR COLBURN, LLP, 55 GRIFFIN ROAD SOUTH, BLOOMFIELD, CT, 06002, US

(21) Appl. No.: 11/684,481

(22) Filed: Mar. 9, 2007

Related U.S. Application Data
(63) Continuation-in-part of application No. 11/002,374, filed on Dec. 2, 2004.

(51) Int. Cl. G06Q 50/00

(52) U.S. Cl. 705/3

(57) ABSTRACT

An osteoporosis assessment system and method. The system and method generally include an input device that can be a computer that can be further connected to a network. The system can therefore be web-based. The system receives patient data and data related to osteoporosis. The method is implemented to correlate the patient data and the osteoporosis data and output is generated that personalizes the osteoporosis data to the patient based on the valued activities of the patient, so that the patient can understand his or her personal fracture risk assessment, therapy needs determination and therapy progress measurement. Therapy and treatment recommendations can also be generated.

This application claims priority to and is a Continuation-In-Part of U.S. Non-Provisional patent application, Ser. No. 11/002,374 filed Dec. 2, 2004, and entitled “System and Method for Osteoporosis Assessment”.

### BACKGROUND

I. Field of the Invention

The present invention relates generally to the field of medical evaluation tools and more particularly to a system and method for osteoporosis assessment, including fracture risk assessment, therapy needs determination and therapy progress measurement.

II. Description of the Related Art

It is estimated that 10 million Americans have osteoporosis and 44 million are at risk to develop osteoporosis because they have low bone density. Typically, many people with osteoporosis are not treated. The number of individuals who receive therapy treatment for prevention of osteoporosis or vertebral fractures is significantly less than the number of individuals referred for osteoporosis symptom management. Preventative therapy typically includes providing individuals with general osteoporosis information that simply includes recommendations not to twist or bend to prevent vertebral fractures. However, the information does not include any personalized information designed and catered to the activities in which the patient is presently engaged. No information is provided instructing patients how to modify their bodily motions to decrease risks associated with osteoporosis.

Furthermore, in the field of osteoporosis, healthcare providers are recognizing the growing need to evaluate medication adherence. Medication dosing and regimens are variable, leading to multiple reasons for non-adherence. Due to the complex analysis needed to determine the reasons for non-adherence, methods are needed to address and analyze non-adherence.

Historical approaches to clinic-based assessment of drug adherence have included informal questioning to the patient, pharmaceutical records review and inferring non-adherence from medical condition. There are no known osteoporosis medication adherence algorithms that combine information provided in patient interview with known risk factors for non-adherence to produce a recommendation report.

### SUMMARY

In general, the invention features an osteoporosis assessment system and method. The system and method generally include an input device that can be a computer that can be further connected to a network. The system can therefore be web-based. The system receives patient data and data related to osteoporosis including fracture risk assessment, therapy needs determination, and therapy progress measurement. The method is implemented to correlate the patient data and the osteoporosis data and output is generated that personalizes known risks associated with osteoporosis, such as fracture risks, so that a patient can use that knowledge to understand his or her personal fracture risk, therapy needs and therapy progress, based further on the valued activities of the patient. Therapy and treatment recommendations can also be generated. The method provides a standardized evaluation tool that evaluates a patient's movement patterns, including but not limited to ability to maintain the balance, and correlates those movement patterns with known risks associated with osteoporosis to cater a specific program for a patient quantifying the risks associated with the activities in which the patient is presently engaged. Since persons with osteoporosis are unaware of the negative effects that their movement patterns have on their bone safety, the method allows them to become aware. Several movement patterns such as twisting and spinal flexion and other dominant movement patterns used by an individual for performance of daily activities. However, twisting and spinal flexion may increase the risk for fracture in individuals with osteoporosis because they have low bone density. The method assesses the functional performance patterns of a person's daily life that can contribute to increased risk of fracture, such as twisting, flexion and balance. Because people have different interests such as gardening or playing tennis, a valued activities checklist assists in identifying the specific valued activities that a person wants and needs to do and a lifestyle change is effectively facilitated by the method. Individuals are provided with techniques for modifying or adapting movement patterns in order to decrease their risk for fractures. The techniques provided give the patient knowledge of the functional risk for fracture associated with their ordinary movements during their daily life activities.

Furthermore, the invention features a system and method, and related algorithms to meet the need to assess and address the complex analysis needed to determine the reasons for non-adherence. In a typical embodiment, an osteoporosis medication adherence questionnaire (OMAQ™) is implemented within an adherence system.

In general, in one aspect, the invention features a method of osteoporosis assessment, including collecting patient data, collecting data related to osteoporosis, correlating the patient data and the osteoporosis data and generating output that relates the osteoporosis data and risks such as functional risk for fracture, specifically to the patient based on the valued activities of the patient. In general, a predetermined set of tasks is given to a patient to perform. The patient is observed performing those tasks and the analysis of those tasks are applied to the valued activities in which a patient regularly engages.

In one implementation, the patient data includes demographic data.

In another implementation, the patient data includes bone mineral density.

In another implementation, the patient data includes physical symptoms assessment data.

In another implementation, the physical symptoms assessment data includes posture data.

In another implementation, the posture data includes lumbosacral angle.

In another implementation, the posture data includes L1/T12.

In another implementation, the posture data includes T1/C7.

In another implementation, the physical symptoms assessment data includes pain and dizziness data.

In another implementation, the physical symptoms assessment data includes dizziness data.

In another implementation, the patient data includes safe functional motion data.

In another implementation, the safe functional motion data includes balance and coordination.

In another implementation, the safe functional motion data includes spinal compression forces.

In still another implementation, the patient data includes valued activities checklist data.

In another implementation, correlating the patient data and the osteoporosis data includes developing therapy recommendations and developing activity modifications.

In another implementation, upper and lower extremity and trunk flexibility and strength are measured

In another implementation, the output includes spinal curve reports.

In another implementation, the output includes strength reports.

In another implementation, the output includes flexibility reports.

In yet another implementation, the output includes therapy recommendation reports.

In another implementation, the output includes known therapy recommendations based on analysis of typical problem combinations. In general, therapy recommendations can include both rehabilitation and pharmacological interventions.

In another implementation, the known therapy recommendations are based on a process that is based on safe functional motion data.

In another implementation, the output includes activity modification reports.

In another implementation, the activity modification reports are based on a process that is based on safe functional motion data.

In another implementation, the output includes activity risk reports.

In another implementation, the activity risk reports are generated from a process that generates data based on valued activities data and safe functional motion data.

In another implementation, the output includes bone safety evaluation reports.

In another implementation, the output is generated by a process that uses safe function motion data, physical symptom assessment data and bone mineral density data.

In another implementation, the reports include a safety domain performance graph.

In another implementation, the reports include a spinal abnormalities graph.

In another implementation, the graph indicates the extent of spine curvature as measured by a plurality of curve points.

In another implementation, the reports include an activities-based fracture risk.

In another aspect, the invention features a bone safety evaluation method, including determining a patient's valued activities, physical symptoms data, bone mineral density, height and weight, determining the patient's safe functional motion by evaluating the patient's performance of a group of pre-determined tasks, using the physical symptoms data, safe functional motion, bone density data, height and weight to calculate a compressive strength of a region of interest of the patient and generating an activity risk, therapy recommendation and activity modification report based on patient's valued activities and compressive strength.

In one implementation, the predetermined tasks are chosen from the group consisting of: pour; footwear; newspaper; reach-lift; sweep; washer; dryer; sit to floor; carry-climb; and night walk.

In another implementation, the compressive strength of a region of interest is calculated from a ratio of an actual force in the region of interest to a theoretical failure force in the region of interest.

In another implementation, the theoretical failure force is calculated by the following formula: F=(16875 N/g/cm²)*(Bone Mineral Density)−4875 N.

In another implementation, the ratio is optionally multiplied by a safety factor coefficient.

In another aspect, the invention features a bone safety evaluation method, including collecting physical symptoms assessment data, collecting safe functional motion data, collecting bone mineral density data, collecting patient demographic data and calculating a vertebral fracture risk based on the physical symptom assessment, safe functional motion, bone mineral density and demographic data.

In one implementation, the method further includes generating a bone safety evaluation report.

In another implementation, the method further includes collecting valued activities checklist data.

In another implementation, the method further includes analyzing patient performance of the valued activities checklist data.

In another implementation, the method further includes generating an activity risk report.

In another implementation, the method further includes performing an activity analysis based on a preselected task set.

In another implementation, the method further includes generating a therapy recommendation and activity modification report.

In another aspect, the invention features a method, including identifying a patient, applying a first criteria set to the identified patient, determining whether the patient has maintained within compliance as determined by the first criteria set and applying a second criteria set to the identified patient.

In one implementation, applying the first criteria set further comprises having the identified patient provide a history of whether the identified patient has used a medication type.

In another implementation, the method further includes soliciting responses from the identified patient.

In another aspect, the invention features a method, including identifying a patient, optionally soliciting responses based on a first criteria set from the patient if the patient has no prior use of a first medication, soliciting responses based on a second criteria set from the patient on the use of the first medication, determining whether the patient has maintained compliance with the first medication, soliciting responses based on a third criteria set if the patient has been non-compliant and soliciting responses based on a fourth criteria set if the patient has been compliant.

In one implementation, the first criteria set includes questions based on at least one of no prior use and no history of taking the first medication.

In another implementation, the second criteria set includes questions based on at least one of current use and history of taking the first medication type.

In another implementation, the third criteria set includes questions based on non-adherence or dissatisfaction in taking the first medication.

In another implementation, the fourth criteria set includes questions based on adherence to the medication.

In another implementation, the medication is bone building medication.

In another implementation, the bone building medication is chosen from the group consisting of: Fosamax®, Actonel® MAS, Evista® MAS, Ibandronate MAS, Didronel® MAS, Miacalcin® MAS, Forteo MAS, Zometa® MAS and Aredia® MAS.

In still another implementation, the method further includes allowing a first period of time to pass between optionally soliciting responses based on a first criteria set from the patient if the patient has no prior use of a first medication and soliciting responses based on a second criteria set from the patient on the use of the first medication.

In yet another implementation, the method further includes allowing a second period of time to pass between soliciting responses based on a second criteria set from the patient on the use of the first medication and soliciting responses based on a third criteria set if the patient has been non-compliant and soliciting responses based on a fourth criteria set if the patient has been compliant.

In another implementation, the first set of criteria includes patient risk factors.

In another implementation, the risk factors include lifestyle and health perception risk.

In another implementation, the risk factors include medication risk.

In another implementation, the risk factors include awareness risk.

In another implementation, the risk factors include cognition risk.

One advantage of the invention is that known osteoporosis data can be specifically applied to a patient to quantify risks associated with certain activities in which the patient engages.

Another advantage of the invention is that medication adherence can be predicted.

Another advantage of the invention is that medical adherence probability can be increased.

Another advantage of the invention is that osteoporosis risk can be assessed and medication adherence can be predicted based on similar criteria sets.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates an overall system level diagram of an osteoporosis management method;

FIG. 2 illustrates a more detailed system level diagram as illustrated in FIG. 1;

FIGS. 3A-3B illustrate an embodiment of a valued activities checklist;

FIG. 4 illustrates a graphical representation of the forces on a vertebral body;

FIGS. 5A-5B illustrate an embodiment of a safe functional motion-scoring sheet;

FIG. 6 illustrates an embodiment of a therapy if-then document;

FIGS. 7A-7E illustrate an embodiment of a bone safety evaluation report, including functional risk for fracture, strength and flexibility, safe functional motion, spinal curve, pain and dizziness;

FIG. 8 illustrates an embodiment of an activity risk report;

FIGS. 9A-9B illustrate an embodiment of an activity analysis report;

FIG. 10 illustrates a flowchart for an embodiment of an osteoporosis medication adherence questionnaire method;

FIGS. 11A-11C illustrate several pages of an embodiment of a medical adherence questionnaire;

FIGS. 12A-12C illustrate several pages of an alternate embodiment of a medical adherence questionnaire;

FIGS. 13A-13E illustrate several pages of an embodiment of a medical adherence-scoring sheet;

FIGS. 14A-14E illustrate several pages of an alternate embodiment of a medical adherence-scoring sheet;

FIG. 15 illustrates an alternate embodiment of a medical adherence-scoring sheet;

FIG. 16 illustrates an alternate embodiment of a medical adherence-scoring sheet;

FIGS. 17A-17D illustrate pages of alternate embodiments of medical adherence questionnaires;

FIGS. 18A-26 illustrates several pages of embodiments of medicine specific medical adherence questionnaires;

FIG. 27 illustrates an embodiment of a risk report;

FIGS. 28A-28C illustrate several pages of an alternate embodiment of a risk report;

FIG. 29 illustrates a map that can be implemented to set up the tasks in accordance with exemplary embodiments; and

FIGS. 30A-30D illustrates screenshots of webpages implemented in accordance with exemplary embodiments.

### DETAILED DESCRIPTION

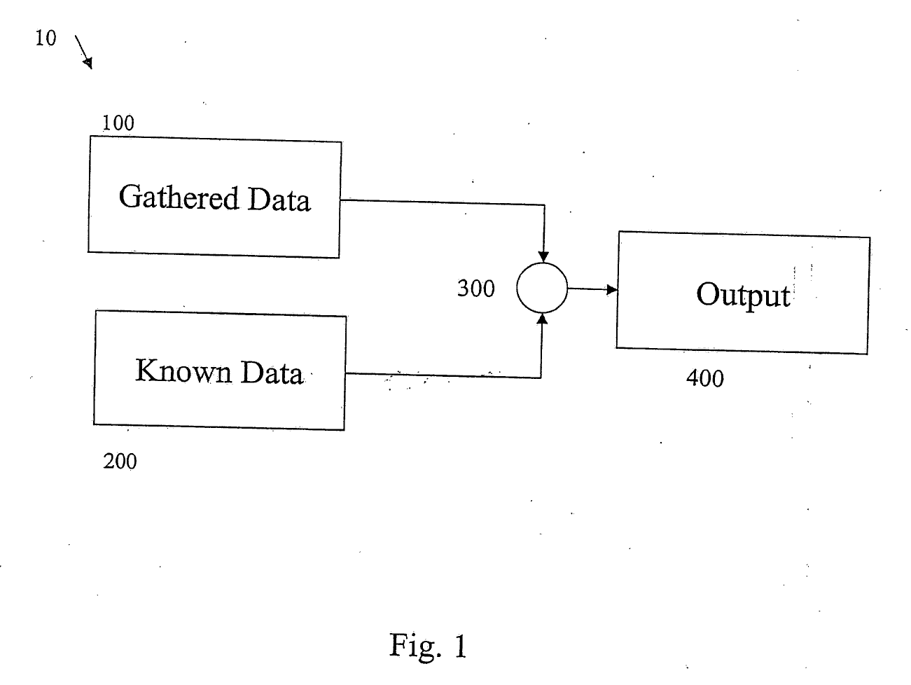

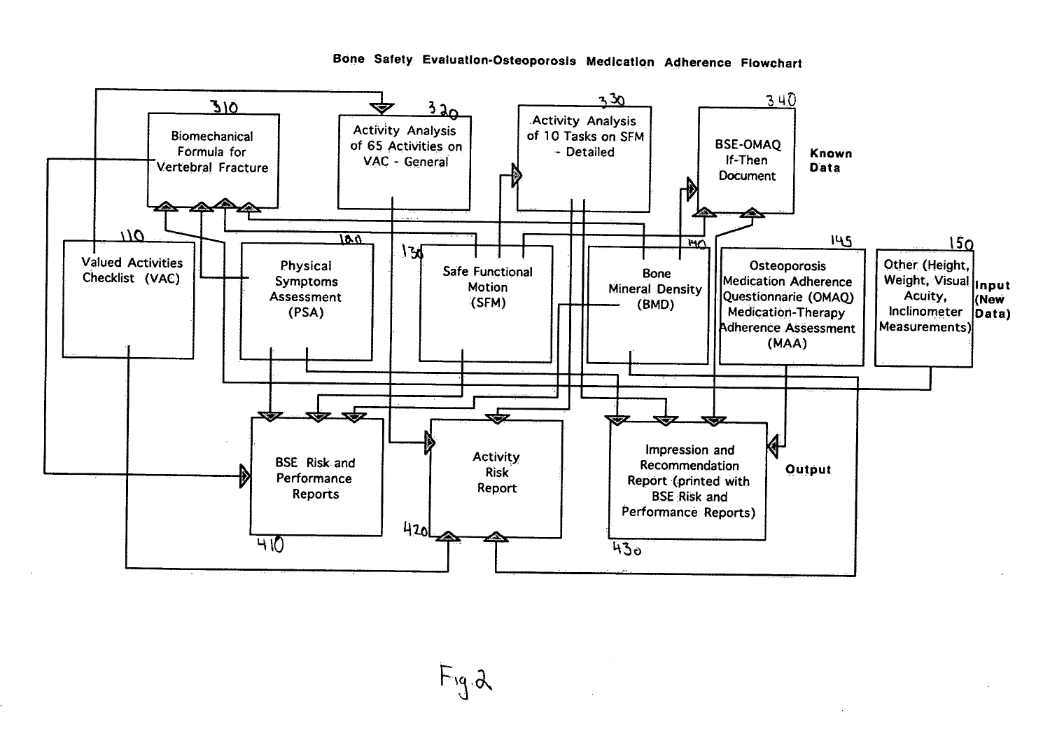

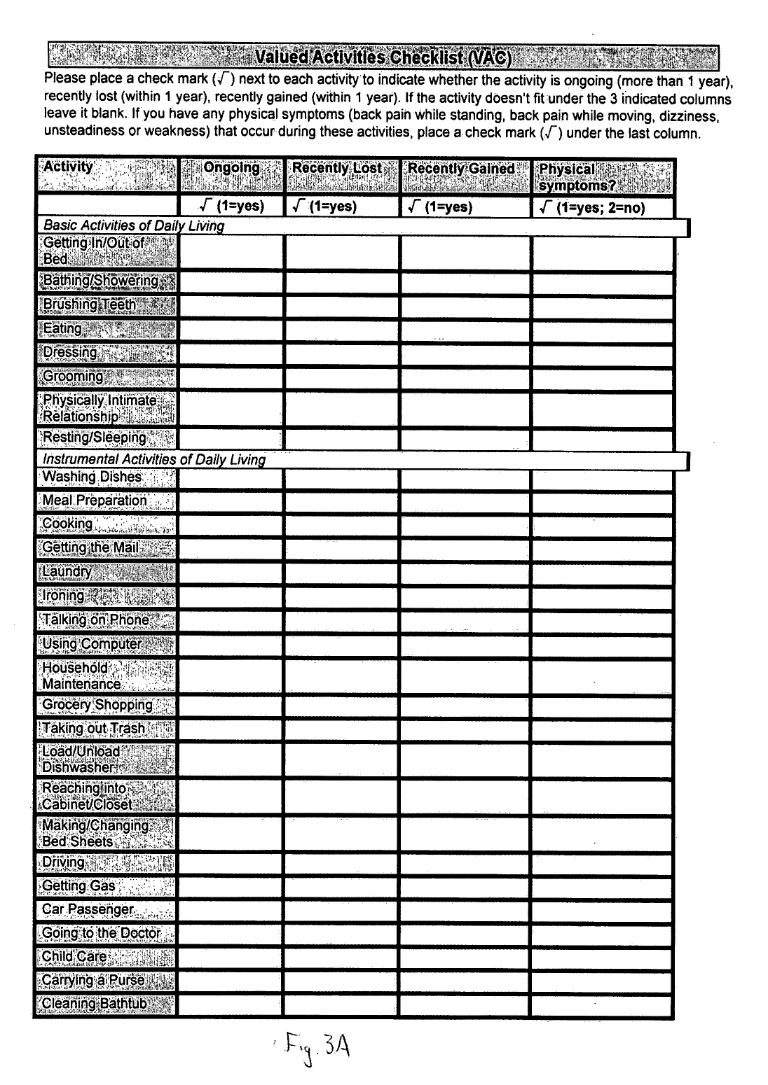

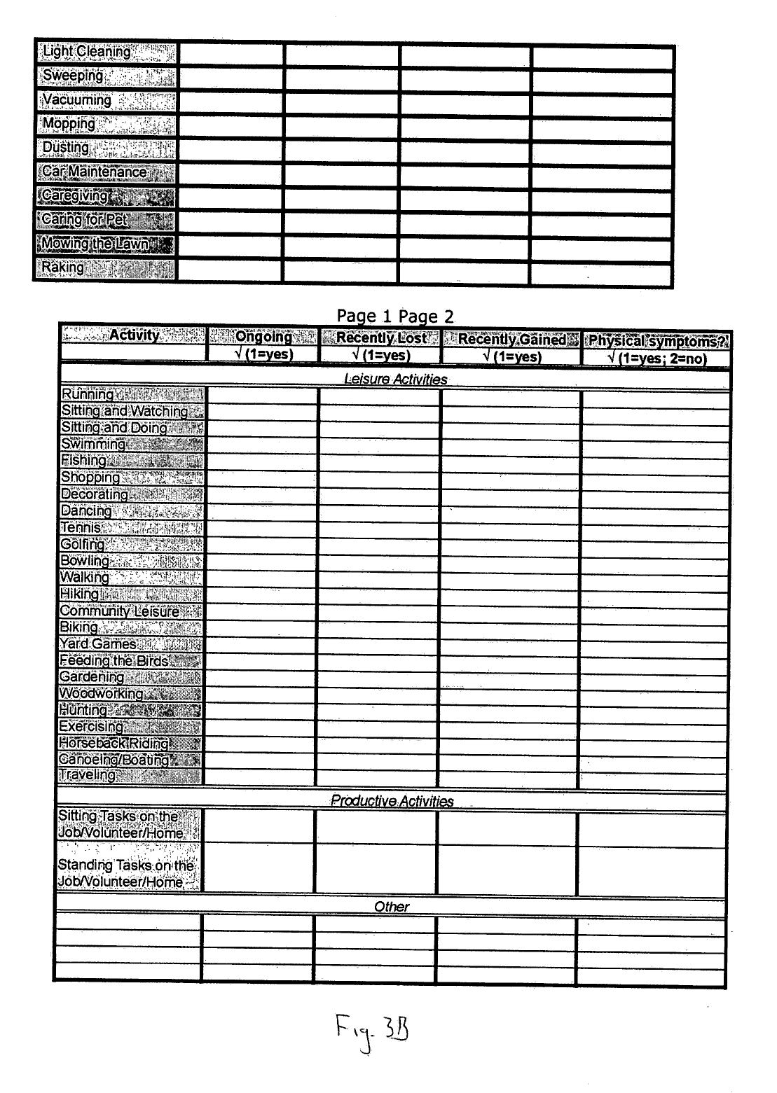

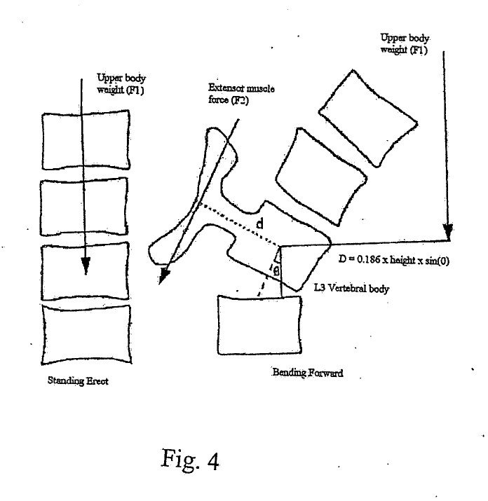

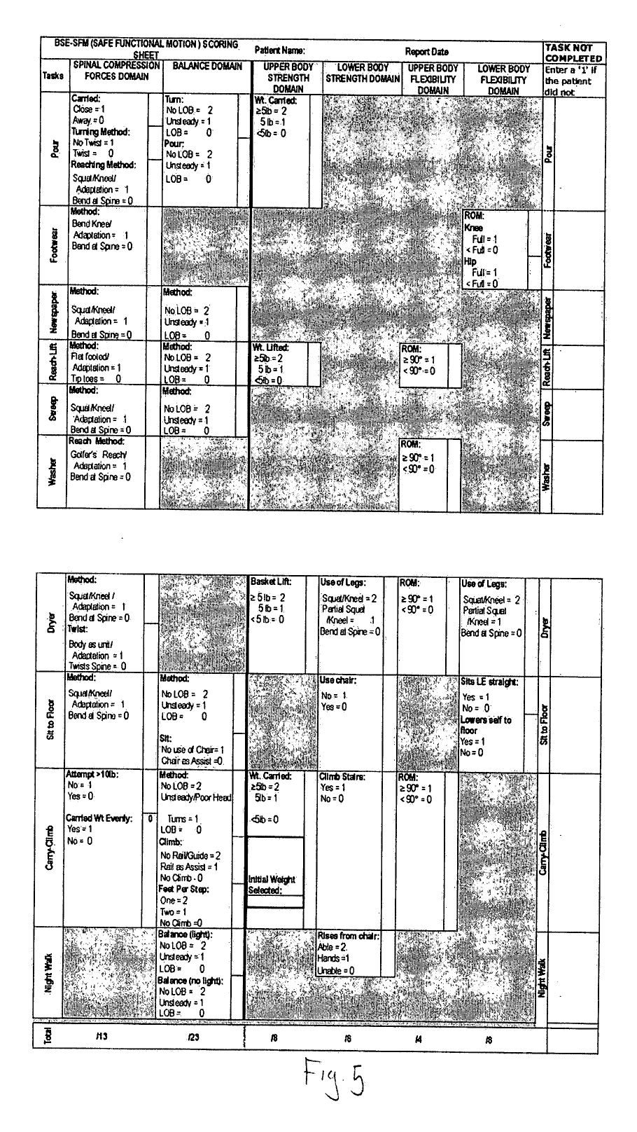

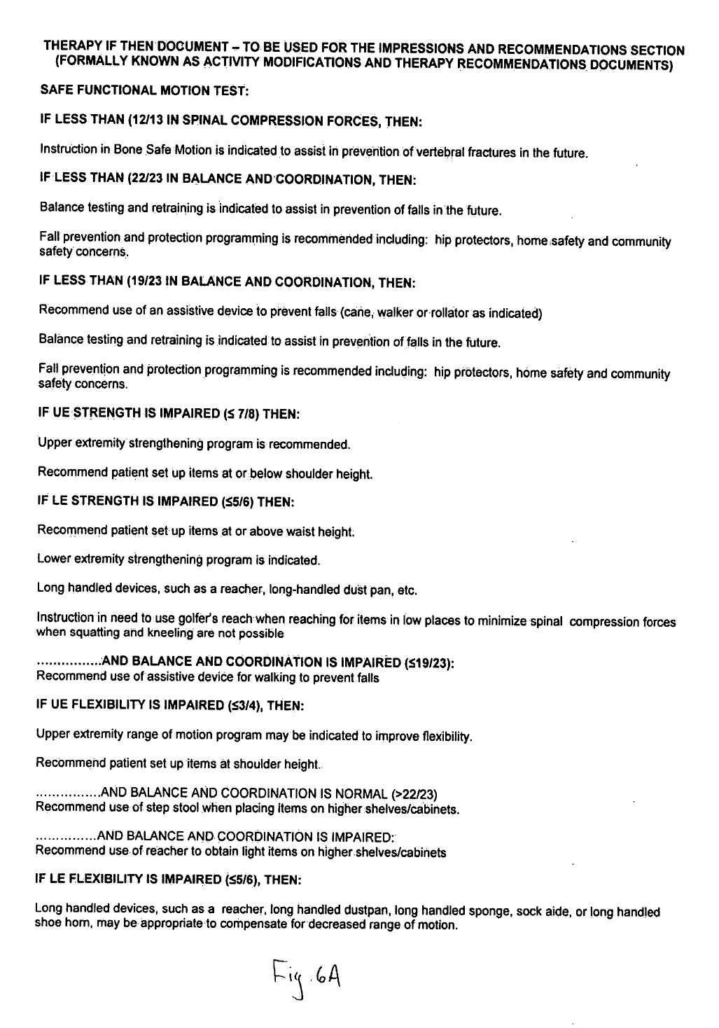

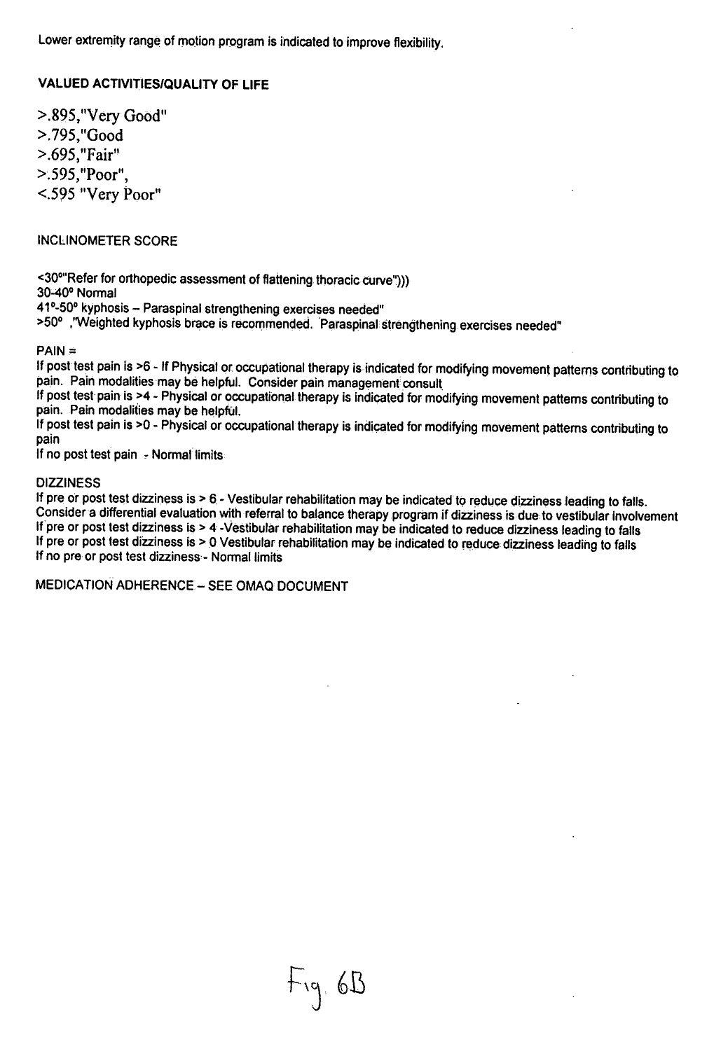

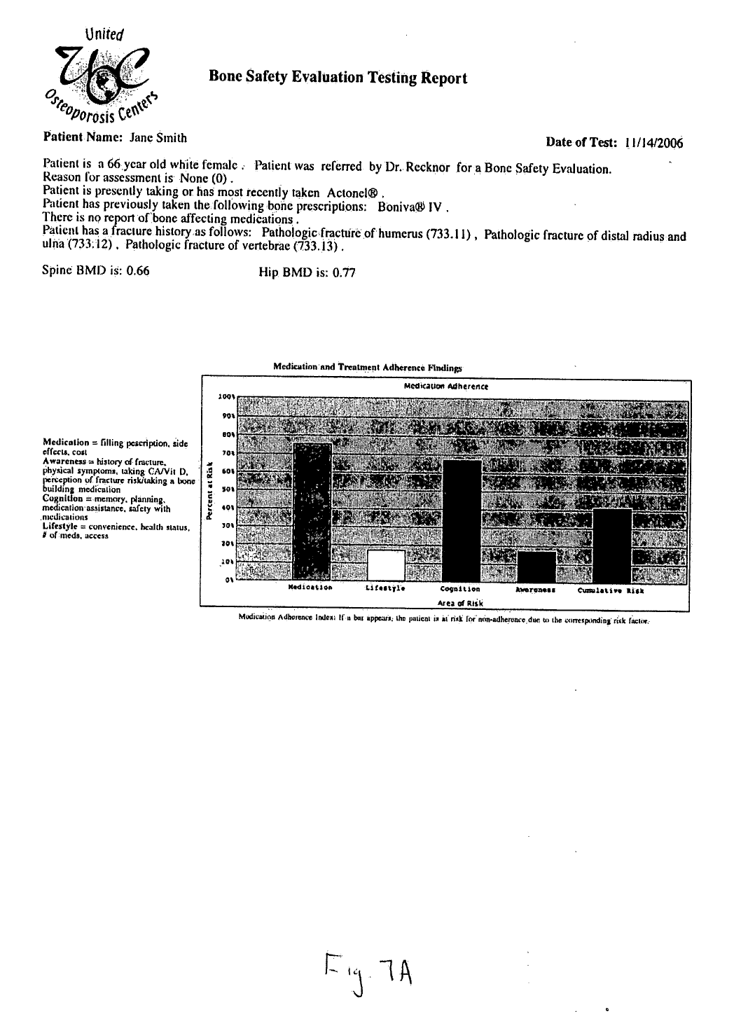

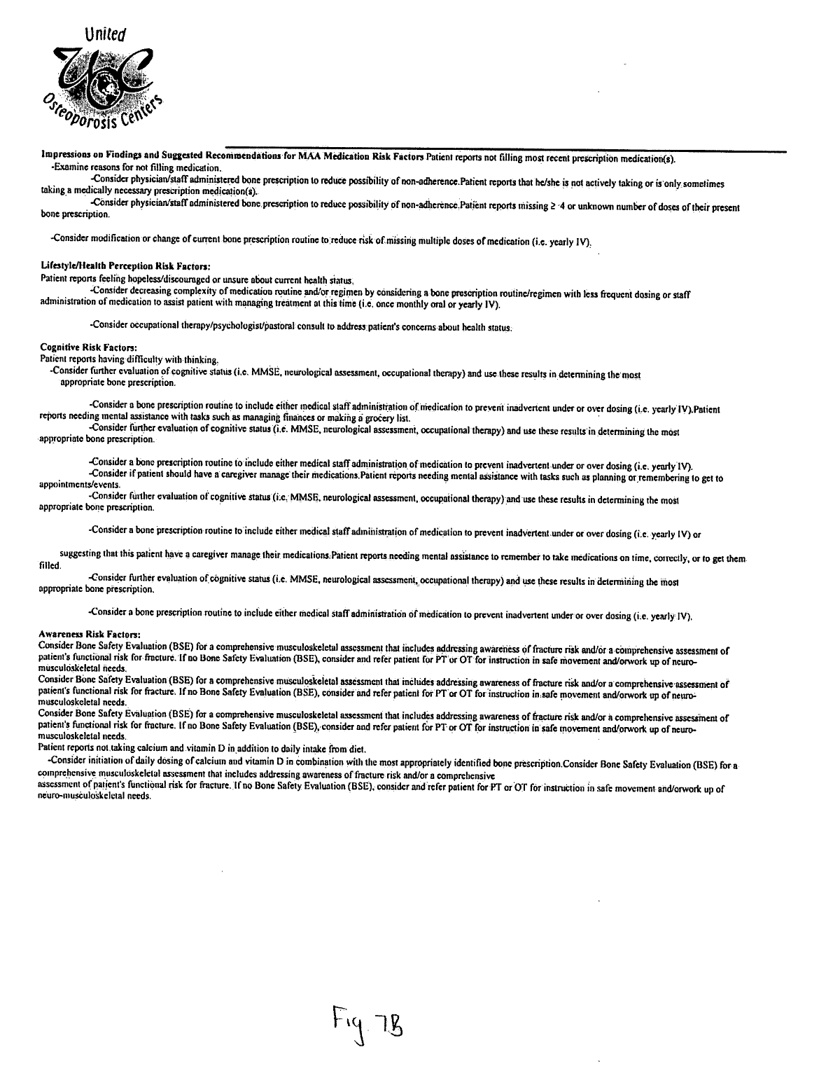

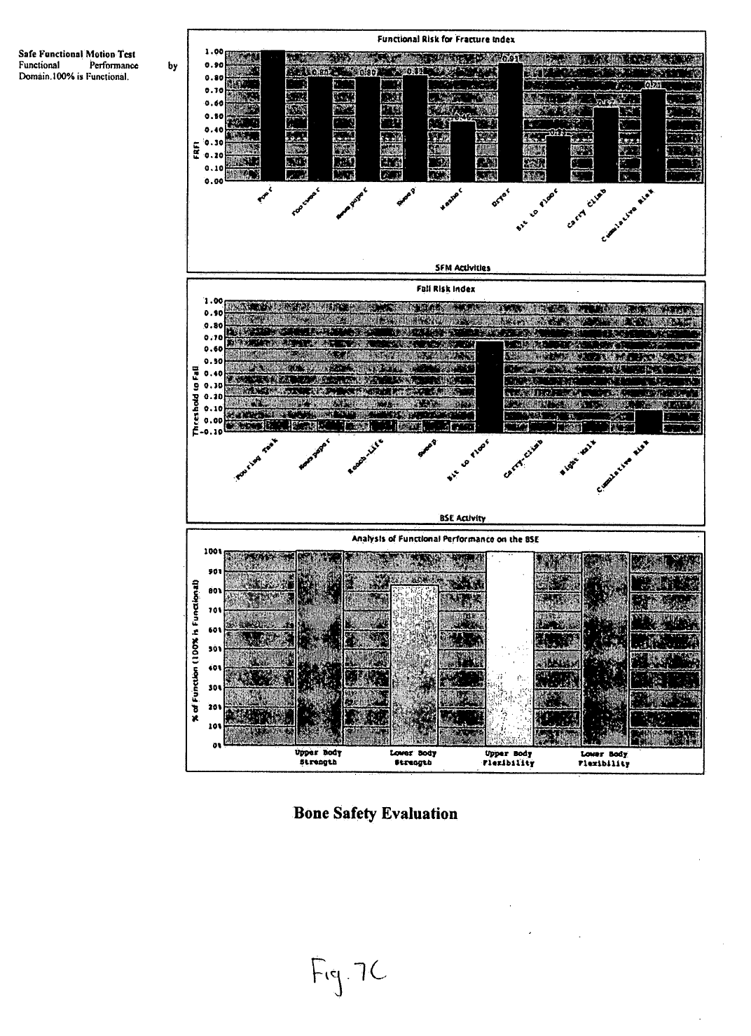

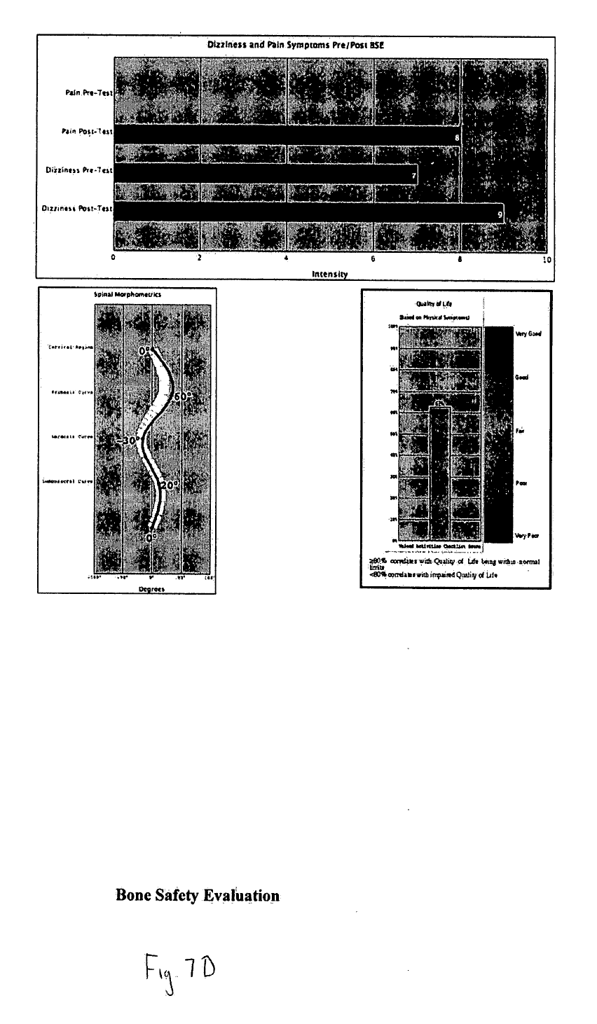

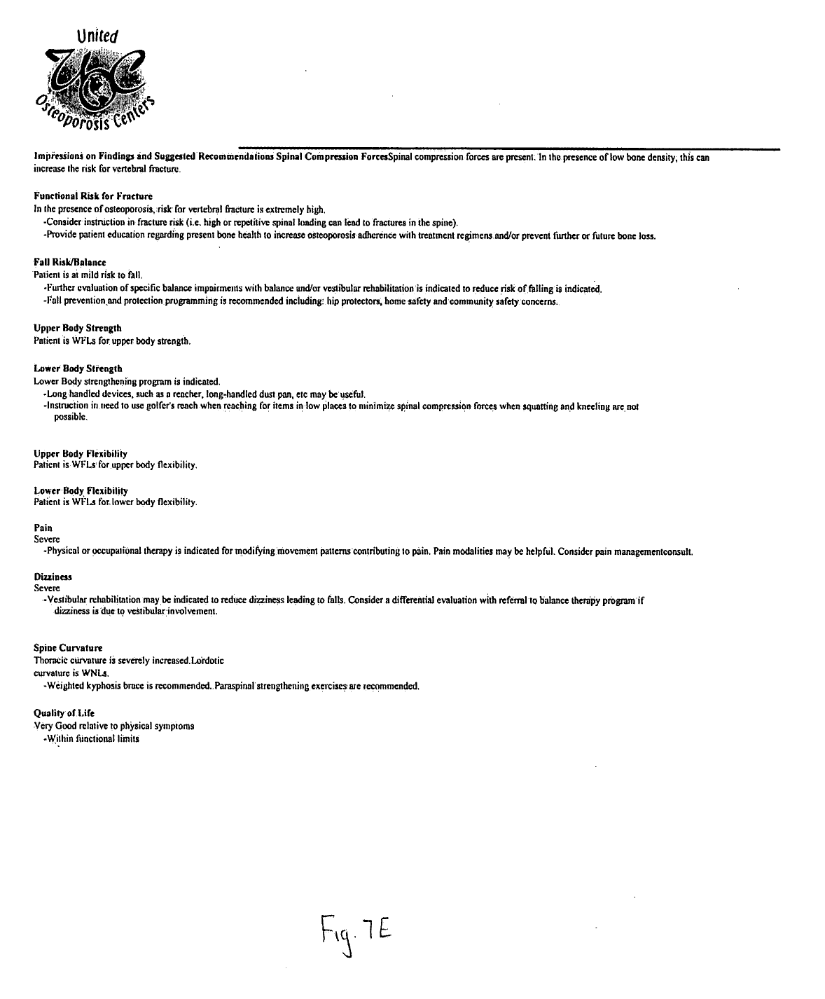

Referring to the drawings wherein like reference numerals designate corresponding parts throughout the several figures, reference is made first to FIG. 1 that illustrates an overall system level diagram of a bone safety evaluation method 10, which can be specific to analyzing the risks associated with osteoporosis, including but not limited to functional risk for fracture assessment, therapy needs determination and therapy progress measurement. In general, it is understood that the systems and methods described herein are performed by a trained practitioner including doctors, nurse practitioners, physician assistants, occupational therapists and the like. The term practitioner is used throughout and is understood to include all suitable professionals trained and educated to make the analyses discussed herein. In general, the method 10 and system implementing the method 10 includes collecting gathered data 100, typically related to the movement patterns and valued activities of a patient and known data 200 and entering the data 100, 200 into a process 300 that analyzes and assesses the data 100, 200 to generate out put 400.

In a typical embodiment, the gathered data 100 includes data about the patient as discussed further below. In addition, the known data 200 includes data related to bone safety and fracture risk in general and related to osteoporosis. Known data, or throughput, typically includes data about compression forces as well as bone mineral density, although bone mineral density is also patient-specific as described further below. In general, known data can include an analysis of a set of pre-determined tasks and how a patient performs those tasks. By analyzing the set of tasks, a practitioner can evaluate the movement patterns specific to that patient. Movement patterns can include, twisting, bending, upper and lower extremity strength and trunk strength. These movement patterns can be used and applied to the valued activities of a patient and certain conclusions can be made about the valued activities based on how the patient performed the pre-determined tasks. A logic flow can be used to come to these conclusions. For example, if the practitioner determines that the patient engages in certain spinal compression factors forces when performing a task using bending, the practitioner can inform the patient that the patient is at increased risk of fracture in all the valued activities that use the similar bending movement pattern. A further detailed description of these types of analyses is discussed below.

The process 300 generally includes correlating the patient data and the osteoporosis data, which can include developing therapy recommendations and developing activity modifications. The process 300 can typically include both software generated calculations as well as evaluations, for example, based on question and answer, as performed by a practitioners. The method 10 further includes generating the output 400 relating bone safety data specifically to the patient, fracture risks and other osteoporosis risks to the patient based on the valued activities of the patient.

FIG. 2 illustrates a more detailed system level diagram as illustrated in FIG. 1. In general, the method 10 includes input that can include a valued activities checklist 110, physical symptoms assessment 120, safe functional motion 130, bone mineral density 140 and demographic patient information 150, typically including height and weight. The method 10 can further include input for osteoporosis medication adherence and medication-therapy adherence 145, which can be in the form of questionnaire and assessment results. The method also include throughput 300. The process 300 or throughput can typically include software processes such as a formula for vertebral fracture 310 based on the physical symptoms assessment 120, safe functional motion 130, bone mineral density 140 and the patient's demographic data 150. A detailed discussion of the vertebral fracture process 310 is found in the description below. The process 300 can further include an activity analysis 320 of the activities from the valued activities checklist 110, an activity analysis 330 of a preselected group of activities based on the safe functional motion 130 and a therapy if-then document 340 based both on the physical symptoms assessment 120 and the safe functional motion 130. The pre-selected group of activities is a specific set of activities that have been pre-analyzed for the compression that they put on the spine, the movement patterns typically used to perform the activities, such as twisting and bending, and the upper and lower extremity and trunk strength typically used to perform them. Therefore, as discussed further in description below, the pre-selected group of safe functional motion activities are useful for the practitioner to analyze a patient's movement patterns and make conclusions about risks, such as functional risk for fracture, and recommendations for therapy and movement modifications, such as strength or flexibility training, or bending at the knees instead of at the waist when picking something from the floor.

Finally, the method 10 can also include the output including a bone safety evaluation report 410 that is generated from data from the vertebral fracture process 310 and the activity analysis 330, an activity risk report 420 generated from the vertebral fracture process 310 and the activity analysis 320 and a therapy recommendation and activity modification report 430 based on the data from the vertebral fracture process 310, the activity analysis and the therapy if-then document 340.

Patient Data Input

As described above, the method 10 includes input that can include a valued activities checklist 110, physical symptoms assessment 120, safe functional motion 130, bone mineral density 140 and demographic patient information 150, typically including height and weight.

The patient data typically also includes valued activities checklist 110 data. In general, the valued activities checklist 110 can be an all-inclusive list or an open list subject to changes, additions and deletions. It is understood that the valued activities checklist 110 can include a limitless number of activities. In one embodiment, the valued activities checklist 110 can include but is not limited to basic activities of daily living such as getting in and out of bed, bathing/showering, brushing teeth, eating, dressing, grooming, physical intimacy, resting and sleeping. The valued activities checklist 110 can further include instrumental activities of daily living such as washing dishes, preparing mantles, cooking, getting mail, laundry, ironing, talking on the phone, using a computer, maintaining the household, grocery shopping, taking out trash, loading and unloading a dishwasher, reaching into a cabinet or closet, making the bed and changing sheets, driving, getting gas, being a car passenger, going to the doctor, caring for a child, carrying a purse, cleaning a bathtub, light cleaning, sweeping, vacuuming, mopping, dusting, maintaining a car, caring for a pet, care giving, sitting and watching, sitting and doing, mowing the lawn and raking. The valued activities checklist 110 can further include leisure activities such as running, swimming, fishing, shopping, decorating, dancing, playing tennis, golfing, bowling, walking, hiking, community leisure, biking, playing yard games, feeding the birds, gardening, woodworking, hunting, exercising, horseback riding, canoeing/boating and traveling. The valued activities checklist 110 can further include productive activities such as sitting tasks on a job or volunteer position and standing tasks on a job or volunteer position. Typically, the patient can input the valued activities into the system implementing the method through data input such as a checklist or by choosing from a visual checklist such as images on a computer screen. For example, FIGS. 3A-3B illustrate an embodiment of a valued activities checklist, which can be implemented on a computer screen.

The patient data typically also includes physical symptoms assessment data 120. The physical symptoms assessment data can include several subtests such as a posture subtest and a pain and dizziness subtest. In a typical embodiment, for the posture subtest, a number of data points can be requested. In a typical implementation, three scores are used: a lumbosacral angle; L1/T12; and T1/C7. These three scores are typically obtained using an inclinometer at the three specific regions. These three regions and thus data points are used to determine a patient's spinal curvature. It is known that curvature can increase spinal compression forces, this increasing fracture risk. In particular, a pronounced T1/C7 score greatly increases fracture risk. Therefore, knowledge of the patient's curvature can further be used to know the fracture risk. As mentioned above, the physical symptoms assessment data includes pain and dizziness data derived from a pain and dizziness subtest. In general, the patient is asked to report the pain and dizziness as pain and dizziness scores before the test and the pain and dizziness as pain and dizziness scores after the test. The pain and dizziness are typically measured before and after the activities analysis 330 as discussed further below. In a typical embodiment, a algometer is used to measure pain and dizziness, however, the patient can simply be asked to rate the pain and dizziness on a scale from 0-10 for pain, where 0 is no pain and 10 is excruciating pain, and for dizziness, where 0 is no dizziness and 10 is unable to perform.

The patient data can further include safe functional motion data 130. In general, the safe function motional data is a series of tests that helps determine certain risks associated with basic activities. The safe functional data can include balance and coordination. In general, a determination of balance and coordination is made by determining whether a patient experiences no loss of balance, unsteadiness or loss of balance during the evaluation. Typically, with no loss of balance, the patient is able to maintain balance using ankle strategies and needs no assistance to complete a given task. With unsteadiness, the individual uses the upper extremities to steady him or herself. In addition, the practitioner giving the evaluation might also give some assistance to maintain balance. The individual may also use step strategy or a wide base of support to maintain balance. The individual also may need to lean on an object to support the body weight and maintain balance. With loss of balance, the individual is only able to maintain balance with assistance from the practitioner.

The safe functional motion 130 data can also include spinal compression forces. Spinal compression forces generally include all the known forces that act on the spine during various activities. In order to make a proper risk assessment for a patient, the known forces on the spine must be correlated with the activities in which the patient normally engages. The goal is to determine a functional risk for fracture index that can be correlated with certain activities to calculate a quantified risk associated with those activities. As such the index helps to quantify the patient's vertebral fracture risk for various activities based on factors including the bone material density, height, weight and position during the activity. The spinal compression forces are discussed in more detail below with respect to the vertebral fracture process 310.

The safe functional motion 130 data can also include specific tasks including: pour; footwear; newspaper; reach-lift; sweep; washer; dryer; sit to floor; carry-climb; and night walk. These tasks are representative of a group of tasks that are useful in making movement pattern determinations. It is understood that some tasks may be removed or other tasks be added in other embodiment. The group of tasks, also known as safe functional motion tasks, is discussed further in the description below. In general, the tasks have been assembled for the purpose of efficiently gathering the most information of human motion based on six areas of concern, including upper and lower extremity/body strength and flexibility, trunk strength and flexibility, balance and coordination and spinal compression forces. It is therefore understood the task list is exemplary and can be compiled from different exemplary tasks.

In general, as described further below, the observations of patient's movement patterns based on the ten tasks can be applied to the activities that the patient has checked on the valued activities checklist. If the patient is engaging in a safe functional motion activity in a way that uses spinal compression forces, the practitioner can make a conservative conclusion that the patient is probably using spinal compression in the activities on the valued activities checklist. In general, a patient with osteoporosis often must be advised that in an activity in which most people without osteoporosis engage, certain movement patterns are used that can cause no problems for the person without osteoporosis. However, those same movement patterns for a person with osteoporosis can cause risk such as fracture risk.

The patient data can further include bone mineral density (BMD) 140 that is typically acquired from various sources, including but not limited to dual energy x-ray absortiometry (DXA) and CT scans. The bone mineral density can be measured from a variety of locations along the spine, the hip or other areas of interest. In a typical embodiment for evaluating fracture risk associated with osteoporosis, the bone mineral density is measured in the L1/L4 region of the spine.

In general, the personalized demographic patient data 150 can include demographic data about the patient, such as the name and particular identification number assigned to the patient. In a typical embodiment, the data can be entered into the input device of the system when prompted.

Patient Data Throughput

As described above, the method 10 includes throughput including software processes such as a formula for vertebral fracture 310 based on the physical symptoms assessment 120, safe functional motion 130, bone mineral density 140 and the patient's demographic (such as height and weight) data 150, an activity analysis 320 of the activities from the valued activities checklist 110, an activity analysis 330 of a preselected group of activities based on the safe functional motion 130 and a therapy if-then document 340 based on the physical symptoms assessment 120, the safe functional motion 130 and bone mineral density 140.

The throughput 300 includes a vertebral fracture process 310. In determining the index calculation of the actual forces that occur in a vertebral body during particular activities. The theoretical force on a vertebral body based on the bone mineral density is also typically determined. Furthermore, calculation of the fracture risk, which is typically the ratio of the actual force to the failure force. A fracture risk greater than or equal to one indicates a high risk of vertebral fracture during the particular activities. This fracture risk greater than or equal to one is a theoretical fracture threshold, where a conservative assumption of functional fracture occurs in theory. Therefore, a practitioner can warn the patient that a fracture is imminent. As discussed further below, a safety factor can be multiplied into this fracture risk ratio so that the number can be factored up to leave a safety range before the fracture threshold is actually reached. It has been determined that although no actual fracture has occurred at the threshold, micro-fracturing does occur at the threshold. Therefore, a full fracture may occur over time each time the patient engages in a movement that meets or exceeds the threshold. It is thus desirable to multiply the safety fracture to help prevent full fracture and micro-fracture. In one embodiment, specific concern is given to the calculation of actual and theoretical forces and the fracture risk of L3 in the lumbar spinal region as the region of interest.

Typically, the loads and therefore forces on a vertebral body are determined using body weight, height and the moment arm of the muscle attached to the vertebral body. The force can be calculated by:
F=AW+(0.455)(Weight)[Cos(θ)+(0.186)(Height)(Sin(θ +SA))/d]
where AW is additional weight carried (in pounds), weight is the patient's body weight (in pounds), height is the person's height (in inches), theta is the angle of forward bending, SA is the angle of kyphosis (should be considered the angle from shoulder to hip) and d is the extensor muscle moment arm. In one implementation, d can be temporarily remain fixed, but is amendable based on information gained from reading x-rays. For the implementation in which d is fixed, d can be equal to 1.417. Furthermore, in general, the number 0.455 is and estimated weight of patient's trunk above L3. FIG. 4 illustrates a graphical representation of the forces on L3 based on the above formula. The values for the muscle moment arm can be obtained from various sources such as lateral dual energy x-ray absortiometry (DXA) scans. The values for d can be calculated from patient groups based on common data to the patients of concern. In one implementation, d=2.9 cm (d=1.14173) as chosen for a patient group of elderly women and women with vertebral fractures. It is understood that other criteria and patient groups can be used in other implementations.

Theoretical failure forces can be determined based on strong correlations between bone mineral density measured with DXA and the compressive strength of lumbar vertebral bodies. From the strong correlation a slope and equation of the linear trend line can be calculated. The following equation describes the relationship between lateral bone mineral density (g/cm²) and the maximum compressive strength (Fₘₐₓ) of a vertebral body:
Fₘₐₓ=(16875 N/g/cm²)*(BMD)−4875 N (load in Newtons)
Fₘₐₓ=(3793.65 lb/g/cm²)*(BMD)−1095.94 lb (load in pounds)
The above Fₘₐₓ were determined for L3. However, in addition, there is a strong relation between bone mineral properties measured with lumbar DXA and the compressive strength of the second lumbar body (L2) as well as the eleventh thoracic vertebral body (T11). This relation indicates that lumbar bone mineral properties can be useful indicators of fracture risk for both lumbar and thoracic fractures.

The fracture risk, or the functional risk for fracture index (FRFI) can be calculated as the ratio of the actual force during activities to the theoretical failure force (Fₘₐₓ):
FRFI=Actual Force/Failure Force
A value of FR> or =1 indicates that the patient is at high risk for vertebral fracture during that particular activity. In one embodiment, several assumptions can be factored into the model as a safety factor SF.
FRFI=Actual Force*(SF_{N}+SF_{A})/Failure Force
where the actual force is calculated as discussed above, SF_{N} is a basic safety factor, which can be 1.2 w/o kyphotic angle>40° or 1.4 w/kyphotic angle >40°, and SF_{A} can include a variety of additional factors such as, but not limited to, total of safety factors including reach with weight+twisting or seated+lateral bending, etc.. In this embodiment, the assumptions can include: a rigid body model that does not account for the individual joints of the spine; the exclusion of lordosis or individual variations in the trunk shape and the like of the patient; the exclusion of twisting and rotation and the association muscle forces; extensor force is the only force counteracting the body weight, excluding facet ligaments and joint with shorter moment arms; and that all flexion occurs at L3, which actually overestimates the effects of body weight as a more conservative assumption. It is understood that the assumption may or may not be included in the model in other embodiments.

The process 300 can further include an activity analysis 320 of activities from the valued activities checklist 110, an activity analysis 330 of a preselected group of activities based on the safe functional motion 130 and a therapy if-then document 340 based both on the physical symptoms assessment 120 and the safe functional motion 130. In general, the activity analysis 330 of the preselected group of tasks is an assessment made independent and prior to any interaction with a patient. For example, the preselected group can include 10 tasks including pour, footwear, newspaper, reach-lift, sweep, washer, dryer, sit to floor, carry-climb, and night walk. These ten tasks are analyzed based on whether or not they include certain movements such as bending, twisting, strength, flexibility and balance shift. Therefore, a practitioner has a priori knowledge that certain tasks involve certain movements. Then when the practitioner actually evaluates a patient and has the patient perform the tasks, the practitioner can observe how a patient actually performs the tasks, and then make recommendations based on these observations. The tasks are discussed further in the description below. Similarly, the patient can be given a large list of activities either in list form or graphical form and ask the patient if she performs any of these tasks, which can then become the valued activities checklist 110. The activities analysis 320 on these tasks can then be performed and a determination whether or not certain movements such as bending, twisting and balance shift are used in those tasks.

In general, during the testing of the patient to determine the functional risk for fracture, the patient can engage in several activities. Depending how the patient engages in the activities helps to determine the potential compression on the spine. For example, the patient can be asked to engage in certain activities that could involve bending and twisting of the spine. As such, compression forces can be determined depending on whether the patient squats or kneels to complete a task or uses adapted method to complete the task, such as using a reacher, sock aide, asks for assistance, golfer's reach, using a stool, a long handled dust pan or verbalizes safe method of completing a task. Furthermore, the compression forces can be determined depending on whether or not the patient bends at the waist or upper back (engages in spinal flexion at the lumbar or thoracic regions) at any time during the task, or whether or not the individual twists his spine or avoids spinal twisting.

In a typical implementation, the practitioner can use a variety of tasks to help determine the compression forces. As described above, the tasks are pre-determined and pre-analyzed for movement patterns. This predetermination and pre-analysis can then be applied to how the patient actually performs that tasks. It is understood that any suitable task group can be chosen, however, in one embodiment, the predetermined tasks are pour, footwear, newspaper, reach-lift, sweep, washer, dryer, sit to floor, carry-climb and night walk. In general, the patient can wear a safety belt throughout the tasks. Each task is now discussed separately.

The practitioner can ask the patient to engage in the pour task. Observations that can help determine the spinal forces include whether or not the patient carries the container close to her and uses her trunk to assist in carrying the container, or rather carries the container away from her trunk and uses only arms and hands to carry the container. The patient can be asked to empty a full container into a cup at intervals and a determination can be made on how the patient performs this task. The practitioner can give time to the patient to feel the differences in each way the patient performs the task. In one implementation, if the patient engages in any type of flexion movement, the practitioner can ask the patient to modify the movement without using flexion and then ask if the patient feels the difference.

The patient can also be asked to engage in the footwear task. The patient is asked to remove both shoes and socks and put them back on. The practitioner can observe how the patient carries out this task and whether or not the way the patient is performing the task is the typical way the patient performs the task daily. In one implementation, if the patient does not use the ankle to knee approach, the practitioner can ask the patient if he or she can place the ankle on the opposite knee.

The patient can also engage in the newspaper task. In this task the patient is asked to lift a newspaper from the floor. The newspaper is typically placed in front of the patient. The practitioner asks if the way that the patient picks up the newspaper is the way the patient always engages in the activity. In one implementation, if the patient bends to pick up the newspaper, the practitioner can recommend that the patient uses squatting or kneeling to pick up the newspaper.

The patient can also engage in the reach-lift task. The patient is asked to place a container on the highest shelf that the patient can reach. The patient picks up the container, places it on the highest shelf, and then removes it. The practitioner can observe whether or not the patient reaches with both feet flat on the floor or uses a reacher to retrieve an item, or whether or not the patient comes up one or both tip toes during the reach. The practitioner can also observe specific details such as whether or not there is a greater than of less than or equal to a ninety degree range of motion when the patient places on object on a high surface. Typically, the practitioner is observing whether or not the patient can attain a ninety degree or greater shoulder flexion.

The practitioner can also ask the patient to engage in the sweep task. In one implementation, the practitioner spreads a volume of substance such as aquarium rocks or kitty litter in a 4′×3′ (or other dimension) rectangle on the floor. The patient can be given a broom and dustpan and is asked to sweep the substance into the dustpan and set the dustpan on a counter. If the patient sweeps using spinal flexion, the practitioner can place the dustpan back on the floor and ask the patient if he or she can squat or kneel to pick up the dustpan.

The patient can also engage in the washer task. In one implementation, the practitioner can place towels and weights in the washer. From the front of the washer, the patient opens the washer door, transfers all the towels and weights to the dryer and closes the dryer door.

The patient can also engage in the dryer task. In one implementation, the patient starts in front of the dryer, opens the dryer door, transfers the contents of the dryer to a laundry basket. The patient then moves the basket anywhere the patient wishes. The patient then puts the basket on top of the dryer and closes the dryer door. The practitioner can then place the basket behind the patient and ask the patient to pick up the basket. IF the patient cannot pick up the basket, the practitioner can remove some of the towels and asked again to pick up the basket. In general, if the patient uses spinal flexion to remove towels from the dryer and pick up the basket, then the basket can be placed in the patient's arms and the patient can be asked if he or she can squat or kneel as low as possible with the back straight while holding the basket.

The patient can also engage in the sit to floor task. In one implementation, the patient is asked to sit down to the floor, stretch his or her legs out in front and then come back to the standing position. A chair can be placed next to the patient for help is needed. In addition, the practitioner can hold the patient's belt to prevent the patient from dropping to the floor or to assist in lifting the patient.

The patient can also engage in the carry-climb task. In one implementation, the patient carries groceries from the kitchen, out of the doorway, over to stairs, up the stairs and down the stairs. The patient can use a railing if needed. However, it is desirable for the patient to refrain from using the railing. The patient then walks back to the kitchen and looks from one wall to another ten times as fast as possible. This head movement helps to simulate looking around such as in a parking lot. This movement is used to determine whether or not the patient becomes unsteady. The patient then walks back to the kitchen and places the bags on a shelf above the sink. The patient is asked to place as much weight as possible in the bags, knowing how far he or she has to travel. The patient is asked to carry the bags in any way. In general, the practitioner adjusts the weight and observes how the patient carries the bags, that is evenly or all in one hand and the like.

The patient can also engage in the night walk task. In one implementation, the patient stands up from a sofa, walks over a rug and steps up on top of a foam obstacle under the rug two times. The lights are on the first trial, and off for the second. The patient can be asked to stand up without the use of hands, if possible, on both trials. The patient also wears sunglasses on the second trial to further dim the light. This task stimulates a night walk.

In general, the practitioner can determine pain and dizziness before and after the tests. In addition, during the performance of these task, the practitioner can take pain and dizziness readings as described above. Furthermore, the practitioner can take certain spinal measurements at this time. The practitioner can measure three spinal angles such as lumbosacral, T12-L1 (lordotic angle) interspace and C7-T1 (kephotic angle) interspace.

With the vertebral fracture analysis that provides the risk index based on spinal compression forces associated with a particular patient, and a knowledge of how a patient performs preselected tasks and valued activities tasks, therapy recommendations are risk reports can be provided to the patient. For example, by knowing the particular fracture risk and knowing that a patient bends during a particular known task, such as reaching, in which the patient should normally not be bending, that patient can be provided a risk analysis that she is at an increase fracture risk if she continues to bend when reaching and can be advised to modify her reaching to exclude bending. An additional example is if the same patient is at fracture risk for any twisting motion, she can be advised that if any of her valued activities include twisting, then she is at increased risk of fracture if she engages in those twisting activities. A suitable score can be associated with how the patient performs the tasks. In general, a score is associated with the balance and coordination with each task and a score is associated with the spinal compression present when the patient performs a particular task. FIG. 5 illustrates an embodiment of a safe functional mobility scoring sheet based on the tasks. In general, the score sheet is used by the practitioner to base relative scores based on how the patient performs the task. The resulting scores help the practitioner to make conclusions about the functional risk for fracture and other risks, and therefore further help the practitioner to make therapy recommendations and activity modifications. It is understood that these examples are not exhaustive of the type of recommendations and risks that can be reported to a patient but are simply illustrative examples of the recommendations and risks that can be generated from the method and system.

The process 300 can further include the therapy if-then document 340 based both on the physical symptoms assessment 120 and the safe functional motion 130. The therapy if-then document 340 is a logic flow that helps the practitioner to develop the therapy recommendations and activity modifications as described further below with respect to the output 400.

In general, the if-then document 340 is a series of logic questions that help to make a final determination of therapy recommendations and activity modifications based further in view of the data gathered above. FIG. 6 illustrates an embodiment of a therapy if-then document 340. The if-then statements in FIG. 4 are only illustrative of the logic questions that can be used. It is understood that many other if-then statements are possible to aid in the evaluation and determination of therapy recommendations and activity modifications.

Patient Data Output

As described above, the method 10 can also include the output including a bone safety evaluation report 410 that is generated from data from the bone mineral density data 140, the demographic data 150, the vertebral fracture process 310 and the activity analysis 330, an activity risk report 420 generated from the vertebral fracture process 310 and the activity analysis 320 and a therapy recommendation and activity modification report 430 based on the data from the vertebral fracture process 310, the activity analysis 330 and the therapy if-then document 340.

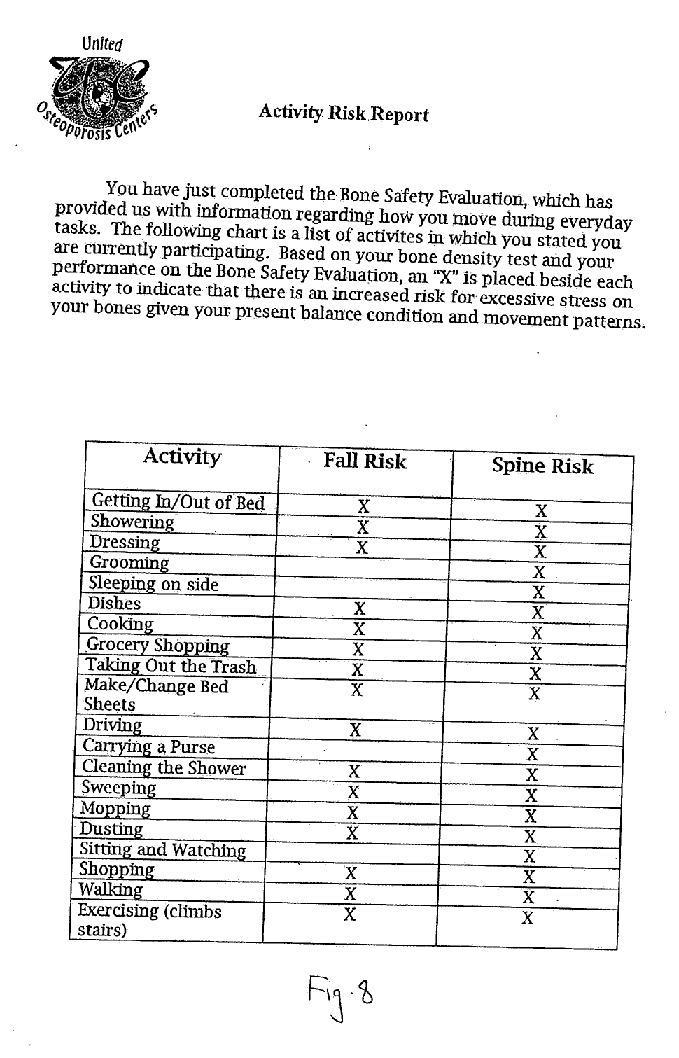

In a typical embodiment, the bone safety evaluation report 410 is a graphical report that illustrates important information specific to the patient including but not limited to activity-based fracture index, spinal morphemetrics, safety domain performance, physical symptoms, strength and flexibility. The graph helps to illustrate the compression forces on the spine based on the process 310 and the risk associated with particular activities from the activities analysis 330. The fracture risk typically differs from activity to activity. FIG. 7 illustrates an embodiment of a bone safety evaluation report. FIG. 7 includes an embodiment of a graphical bone safety evaluation report, including functional risk for fracture, strength and flexibility, safe functional motion, spinal curve, pain and dizziness.

The safety domain performance portion indicates the percentage of items in which the patient engaged in safe functional motion during the activities analysis. The number is typically calculated using the scores obtained as discussed above. The spinal morphemetrics portion indicates the extent of curvature as measured by the three points as discussed above. The flexibility portion indicated whether the patient has some decreased range of motion in either the upper or lower extremities. The activity based fracture risk portion indicated the risk of vertebral fracture for each of the activities based on the patient's movements, the bone mineral density and the actual force to failure force ratio multiplied with and without the safety factor. The visual representation of the patient's response to pain and dizziness is also illustrated.

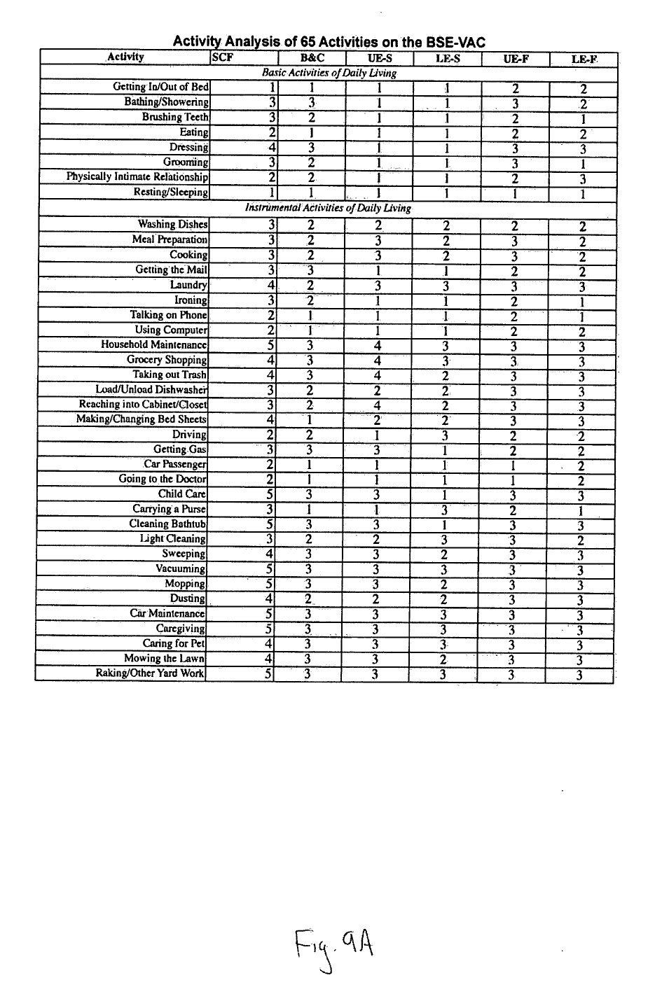

The output 400 can further include an activity risk report 420 generated from the vertebral fracture process 310 and the activity analysis 320. The activity risk report 420 helps to further characterize the fracture risks that the patient experiences with the day to day valued activities that the patient has previously identified. FIG. 8 illustrates an embodiment of an activity risk report 420. Typically, an X in one of the columns indicates that there is a risk of fall or fracture associated with the particular activity. In a typical implementation, if a patient has a score of less than 100% on the balance and coordination sub-domain or spinal compression sub-domain, then the column for the corresponding domain includes the X indicating a fracture risk.

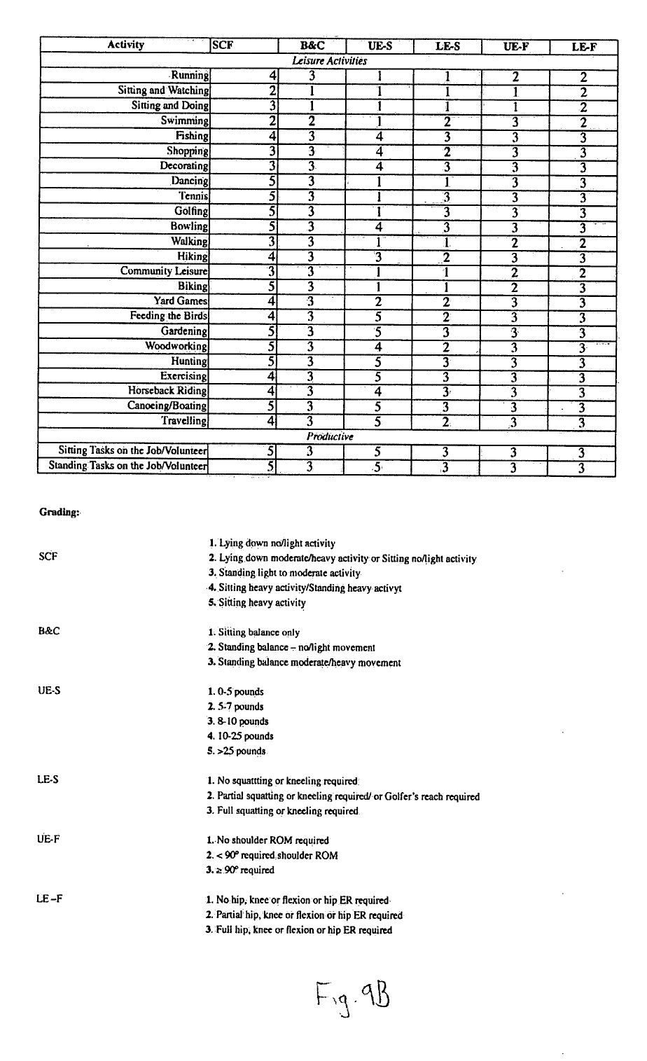

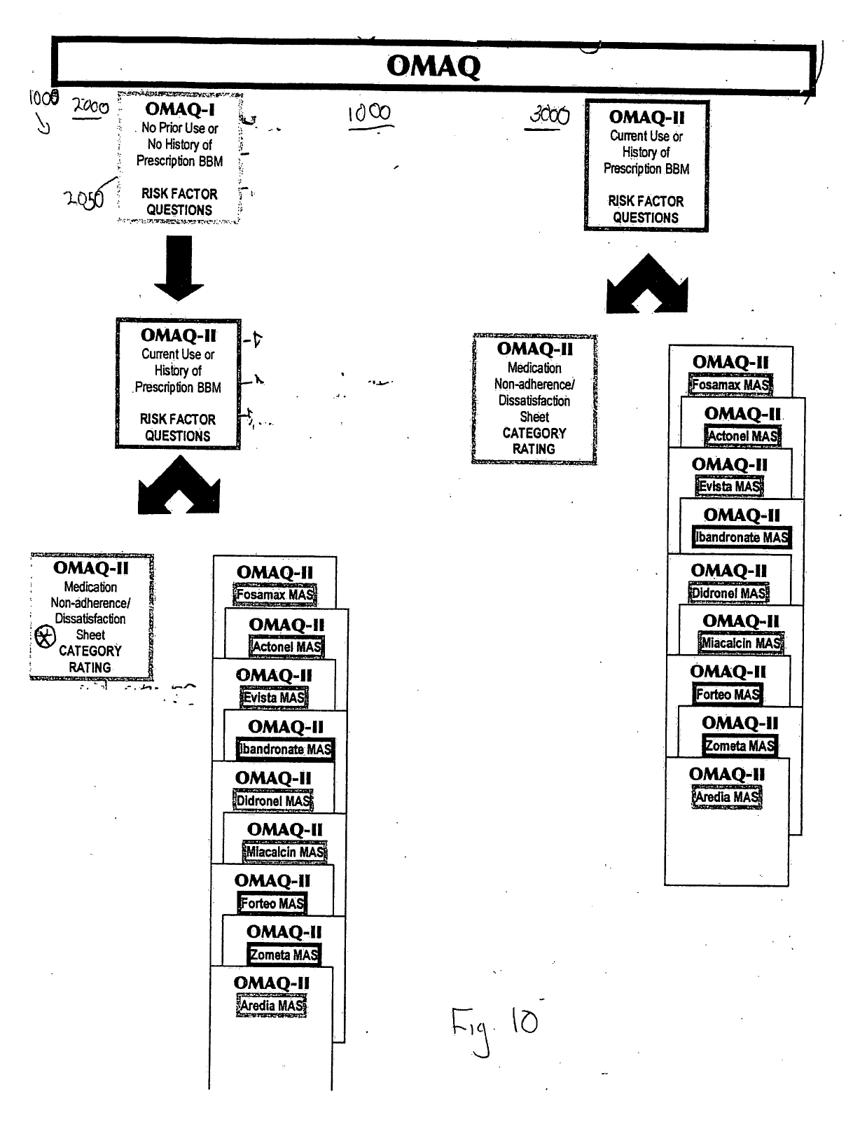

The output 400 can further include a therapy recommendation and activity modification report 430 based on the data from the vertebral fracture process 310, the activity analysis 330 and the therapy if-then document 340. The therapy recommendation and activity modification report 430 can instruct a patient not only on therapy recommendations that can help the patient reduce the fracture risk, but also recommendations on how to change how the patient performs activities to further reduce fracture risk. For example, if the patient is bending while reaching as used in the example above, which is a known way to increase spinal compressions and thus fracture risk, the report 430 can recommend that the patient perform the reaching activity by excluding bending. FIG. 9 illustrates an embodiment of a therapy recommendation and activity modification report 430. In general the report lists safety and physical limitations. The practitioner can use the report to guide interventions during treatment so that the patient receives the most accurate and personalized treatment.

### EXAMPLE

Mrs. J arrives for an appointment with a physician, has a bone density test, completes a clinical risk assessment screening form and is diagnosed (or has been diagnosed) with osteoporosis. Mrs. J has a T-score of −3.3 at L1-4 and −2.5 at both hips. She is given thorough medical care and is referred to engage in the methods as discussed herein.

Mrs. J arrives for the appointment to receive analysis based on the methods with the practitioner who begins to gather lifestyle information about the patient based on the valued activities checklist. Using physical symptoms assessment as described above, the practitioner assesses her spinal curves using an inclinometer, has Mrs. J rate the pain before the treatment on a visual analog scale and has her rate her dizziness on a visual analog scale as well.

The practitioner then explains to Mrs. J that she will be asked to perform ten typical tasks/motions of daily life and she will be rated in safety, balance, strength and flexibility (upper, lower and trunk). The practitioner then asks Mrs. J to engage in these tasks as described above. Mrs. J is then rated on the safe functional domain score sheet as shown in FIG. 5. Once the score sheet is completed, the document is transformed into the personalized performance of Mrs. J. Following the performance of the tasks, she is asked to rate her pain and dizziness once again on the visual analog scale.

At this point, the processing of all the information begins Referring again to FIG. 1, the above described analysis is the acquisition of the known and gathered data. The data is now processed at the juncture 300. First, the safe functional motion and physical symptoms assessment reports are combined with Mrs. J's bone mineral density score and the bimechanical formula is used to develop the bone safety evaluation report (see FIG. 7) as part of the output 400.

Mrs. J is then given the activity risk report (see FIG. 8) that summarizes her report of activities relative to her safe functional domain scores on balance and coordination, spinal compression forces and strength and flexibility. A visit can be scheduled to specifically address her risk areas.

The practitioner then uses the therapy recommendation and activity modification report (see FIG. 9). This report is based on the activity analysis of the typical tasks of everyday life (e.g., the ten tasks) and combined with traditional recommendations relative to strength, flexibility, engagement in spinal compression forces and risk for fall to provide thorough care to Mrs. J that is specific to her needs and abilities.

Medical Adherence Prediction

A key factor in not only osteoporosis assessment but also in osteoporosis treatment is the prediction of a patient's medication adherence and compliance.

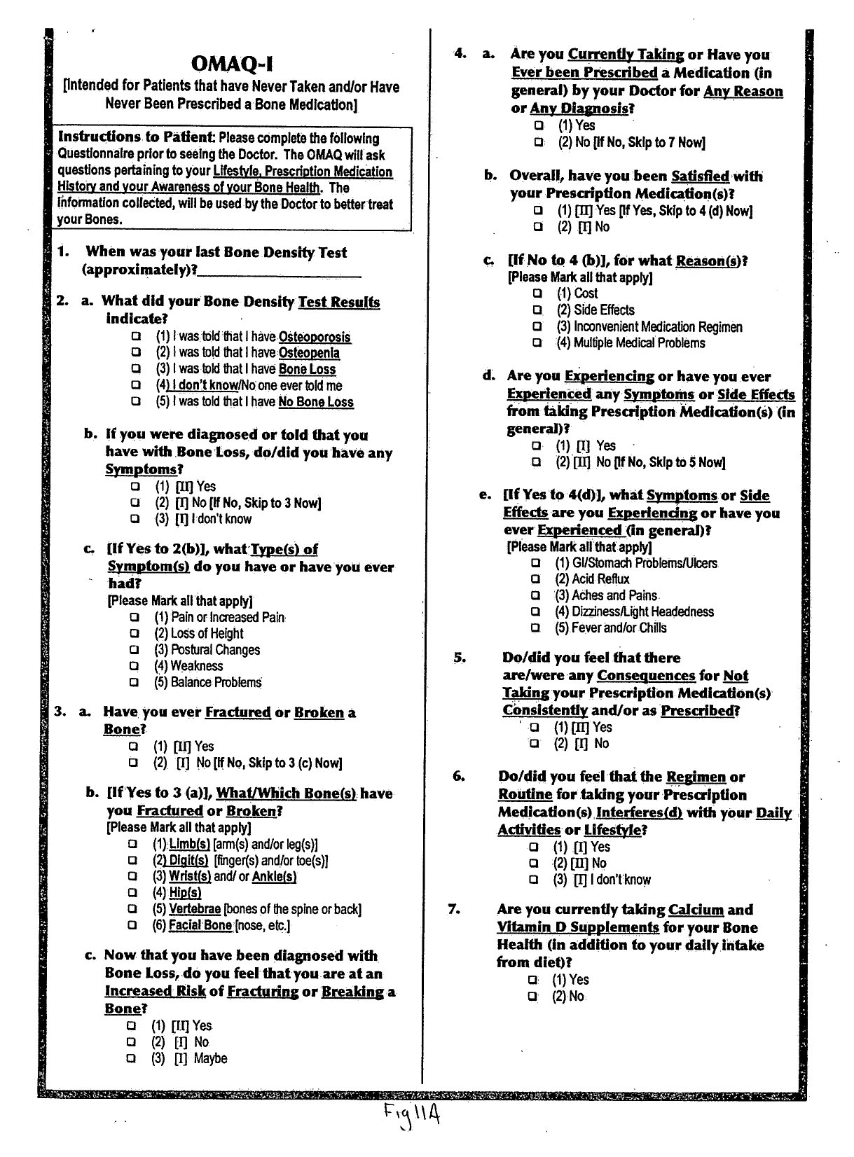

Reference is now made to FIG. 10 that illustrates a flowchart for an embodiment of an osteoporosis medication adherence questionnaire method 1000. In a typical implementation, the method 1000 includes two branches 2000, 3000 of inquiry, one for those patients with nor prior use or history of prescription bone-building medication and those patients with current use of history of prescription bone-building medication (PBBM). A basic initial inquiry 2050 in identifying the patient type is whether or not the patient has had prior use or history of PBBM. As such, the practitioner optionally solicits responses based on a first criteria set from the patient if the patient has no prior use of PBBM. The first criteria set typically includes considerations, a score sheet and a scoring summary that allows the practitioner to initially determine whether or not the patient is likely to adhere to a medication regimen. The considerations typically include patient risk factors in categories, including but not limited to lifestyle/perception, cognition, medication and awareness that may affect medication adherence. The patient risk factors can be presented as a total number of risk factors per category and a total number of risk factors for all categories.

Therefore, in a typical implementation, the method proceeds by first identifying a patient who is in need of medication adherence and who may be likely not to adhere to medication use. After the identification, responses can be optionally solicited from the patient, the responses based on a first criteria set from the patient if the patient has no prior use of a first medication. As further discussed in the description below, this first line of questioning is a first osteoporosis medication adherence questionnaire (OMAQ™-I). The method can also include soliciting responses based on a second criteria set from the patient on the use of the first medication. As further discussed in the description below, this second line of questioning is a second osteoporosis medication adherence questionnaire (OMAQ™-II). The method then includes determining whether the patient has maintained compliance with the first medication. Once the first and second lines of questioning are complete, the method then typically further includes soliciting responses based on a third criteria set if the patient has been non-compliant, based on dissatisfaction criteria. However, a fourth line of questioning can include soliciting responses based on a fourth criteria set if the patient has been compliant.

The osteoporosis medication adherence questionnaire (OMAQ™) is a healthcare evaluation tool designed to assess medication adherence in the osteoporosis population and suggest dosing, drug regimens and other helpful interventions to encourage osteoporosis medication adherence. The tool is designed to assess patients who may require a bone building medication for the first time or to assess the adherence of patients already taking a bone building medication. The tool provides logical recommendations that may improve medication adherence based upon research data and prior studies.

The osteoporosis medication adherence questionnaire (OMAQ™) is a tool that assesses and measures variables affecting osteoporosis medication adherence. The OMAQ™ is designed to address all osteoporosis medication regimens individually. In a typical embodiment, the tool has two parts: A risk factor assessment that has two versions (one for prior use of bone building medication and one for no prior use of bone building medication). The risk factor areas are: lifestyle/preference, cognition, medication, and awareness. In a typical implementation, a report is produced that indicates what risk factors were identified and suggests recommendations that based upon current literature and are individualized for the patient.

The second part of the OMAQ™ is a direct assessment of osteoporosis medication adherence (to be given only to those patients who either are or have taken bone building medication). The second part addresses identifies why the patient was non-adherent (not filling the prescription, not starting a filled prescription, starting and discontinuing the prescription, incorrect/unsafe self-administration of medication prescribed. The second part of the OMAQ™ determines a person to be either adherent or non-adherent to the medication prescribed based a percentage score out of 100%. In one implementation, a non-adherent score is calculated as <75%. The second part of the OMAQ™ provides information on actual adherence. If a patient is found to be adherent to a specific mediation, but also has risk factors for non-adherence, the clinician is advised to address possible concerns with the patient if indicated. Using a tool such as the OMAQ™, osteoporosis medication adherence issues can be more thoroughly scrutinized and measured by the osteoporosis practitioner.

Scoring

As discussed above, the risk factor areas are: lifestyle/preference, cognition, medication, and awareness. Lifestyle/Preference provides good qualitative information, but not necessarily considered a powerful predictor of non-adherence. Assistance also provides good qualitative information, but is also not considered a powerful predictor of non-adherence. In general, considering perception of health, a patient may be at risk for perceiving that taking medication for bone loss is hopeless due to decreased perception of health. Considering number of medications, a patient may be at risk of not initiating “another” medication due to multiple factors (that is, for example, cost, too many medications to take, and the like).

In considering cognition, a patient may be at risk of taking medication incorrectly, inconsistently, or not at all due to possible cognitive deficits. The type of instructor can also provide good qualitative information, but is also not considered a powerful predictor of non-adherence. The patient's calcium/Vitamin D intake as well as source/access are also good pieces of information but are not considered a powerful predictor of non-adherence. Regarding initiation/continuation, a patient may be at Risk to do the same with a new prescription.

In considering awareness, dxa/bmd results to provide good qualitative information, but are not considered a powerful predictor of non-adherence. Factors that are useful are patient instruction, fracture history, fracture risk and the presence of no symptoms.

BSE™-OMAQ™

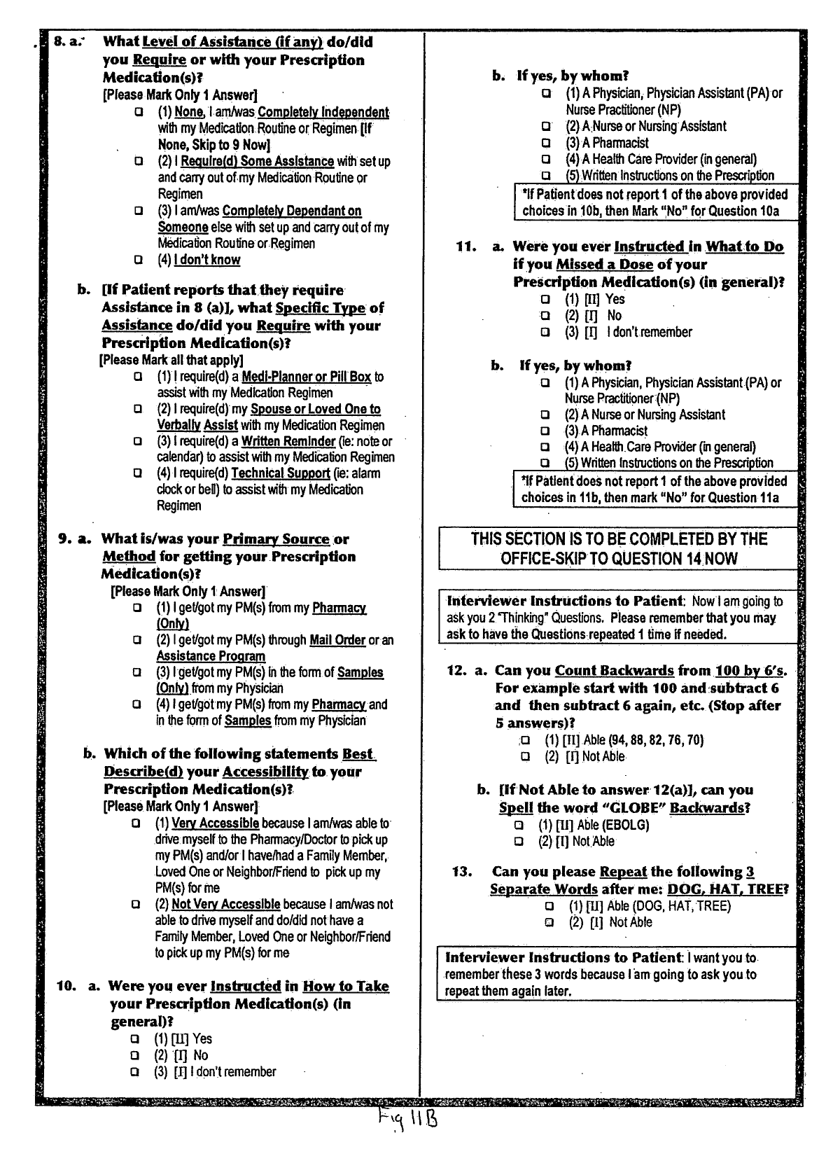

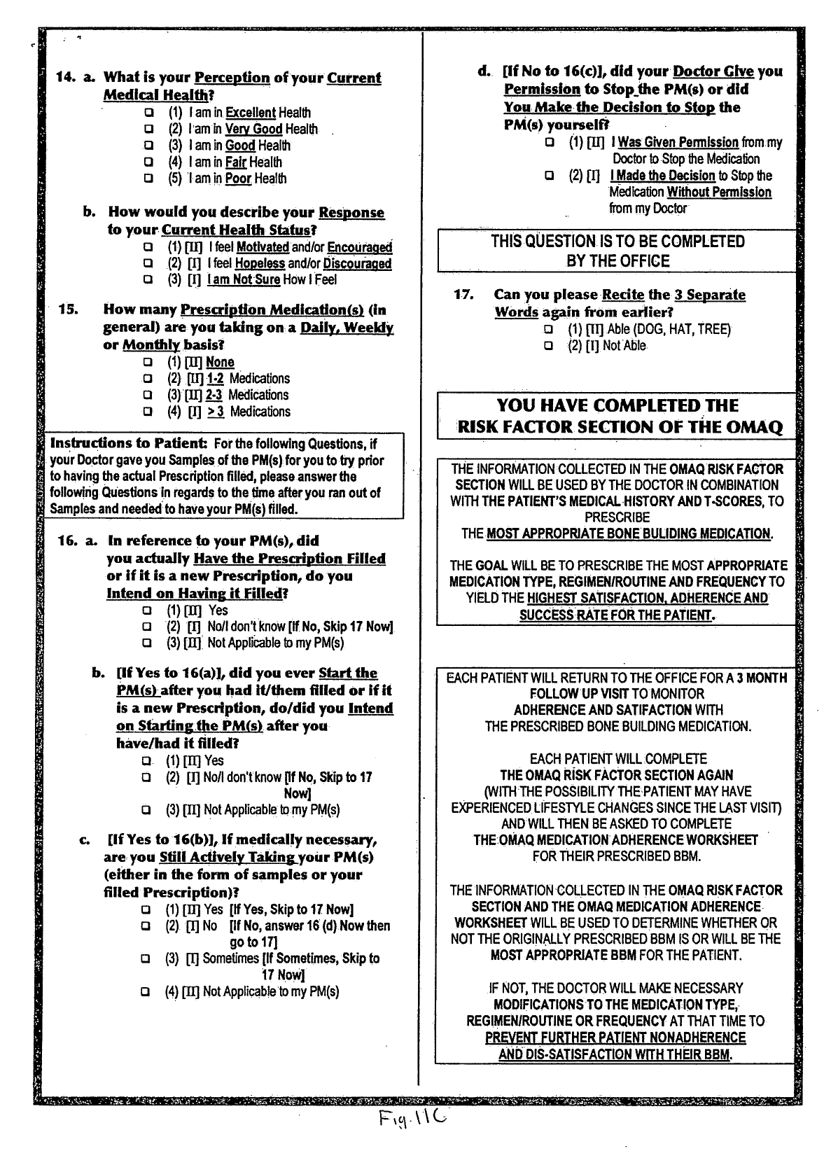

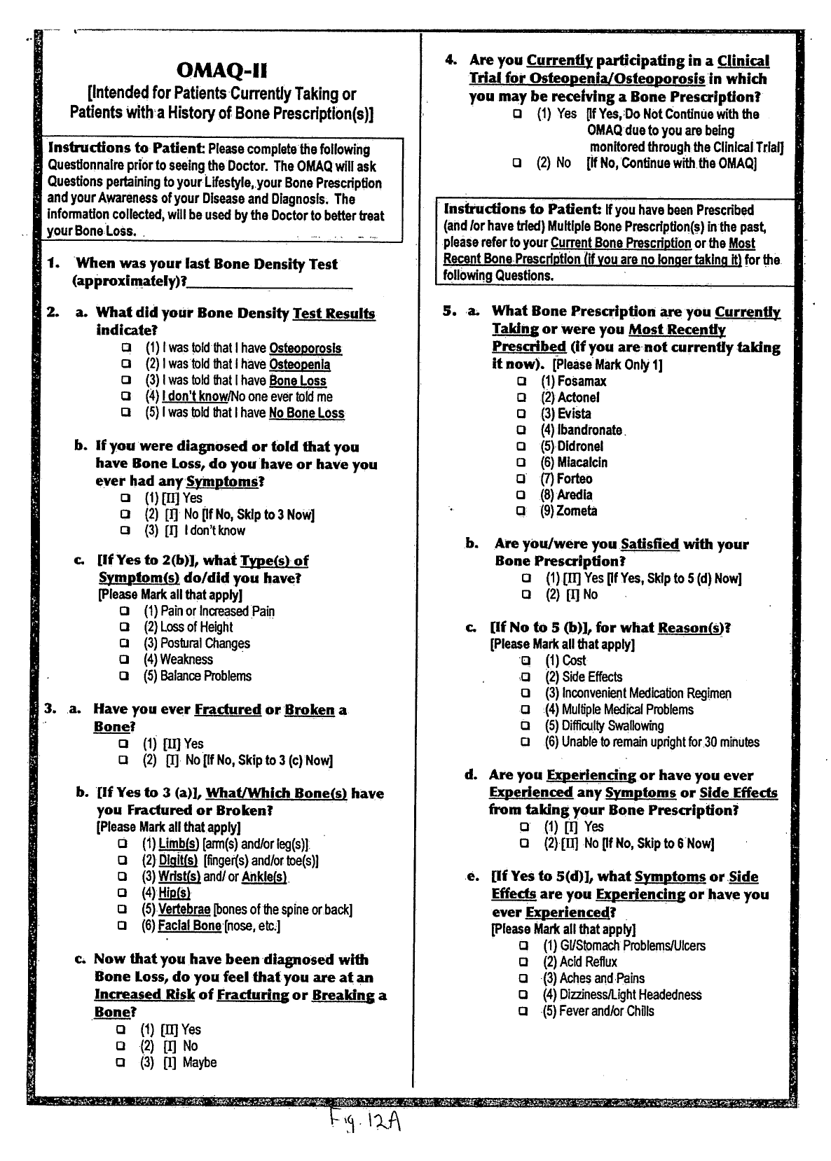

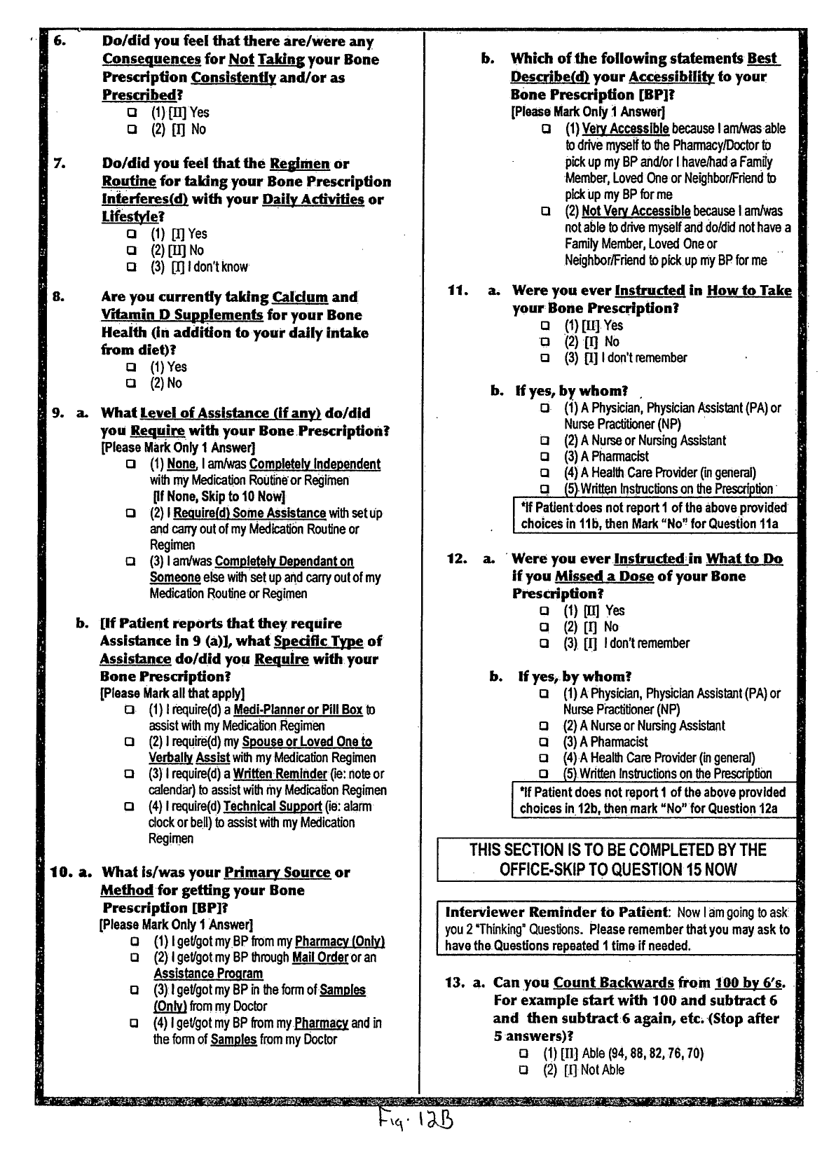

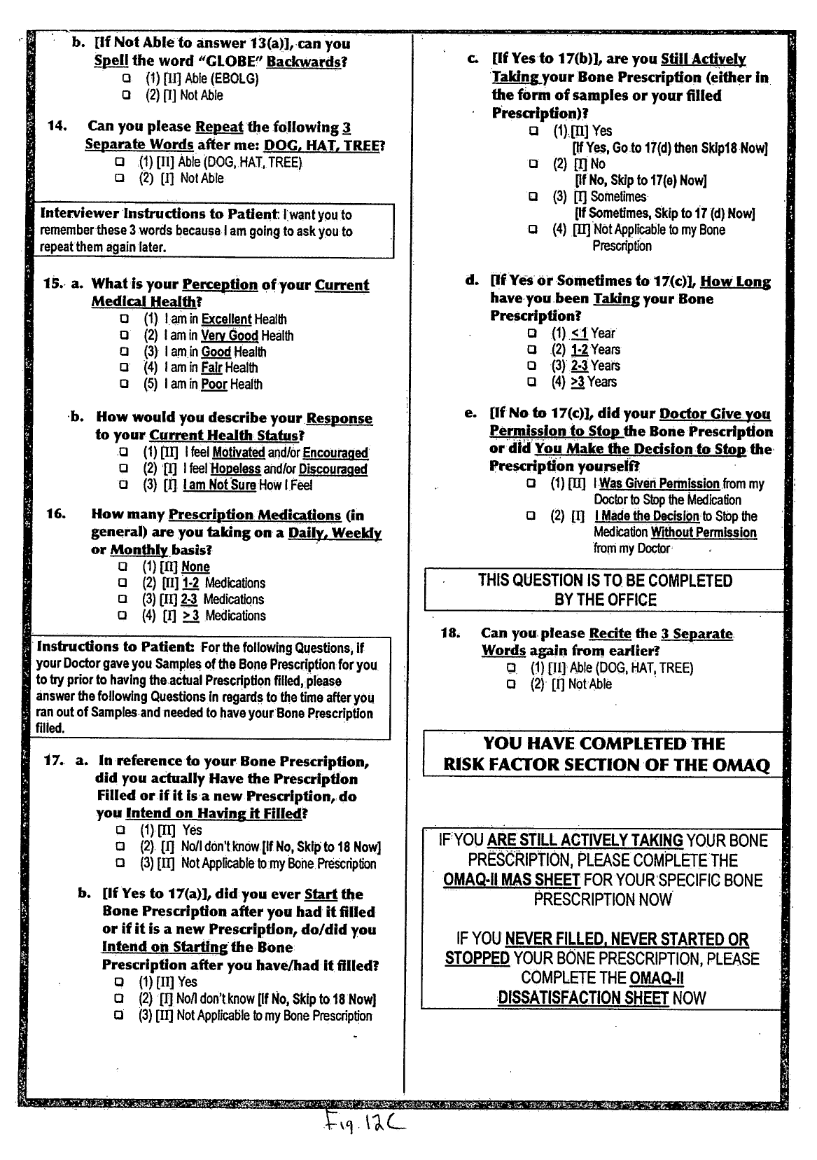

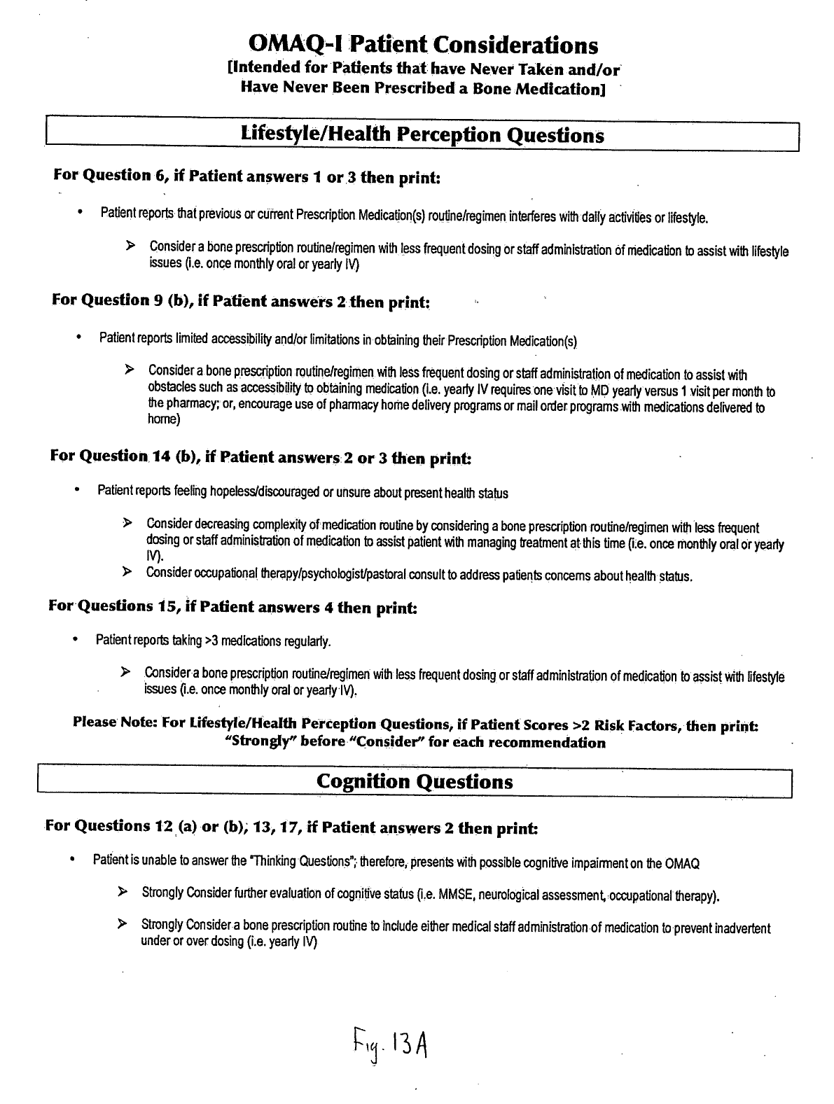

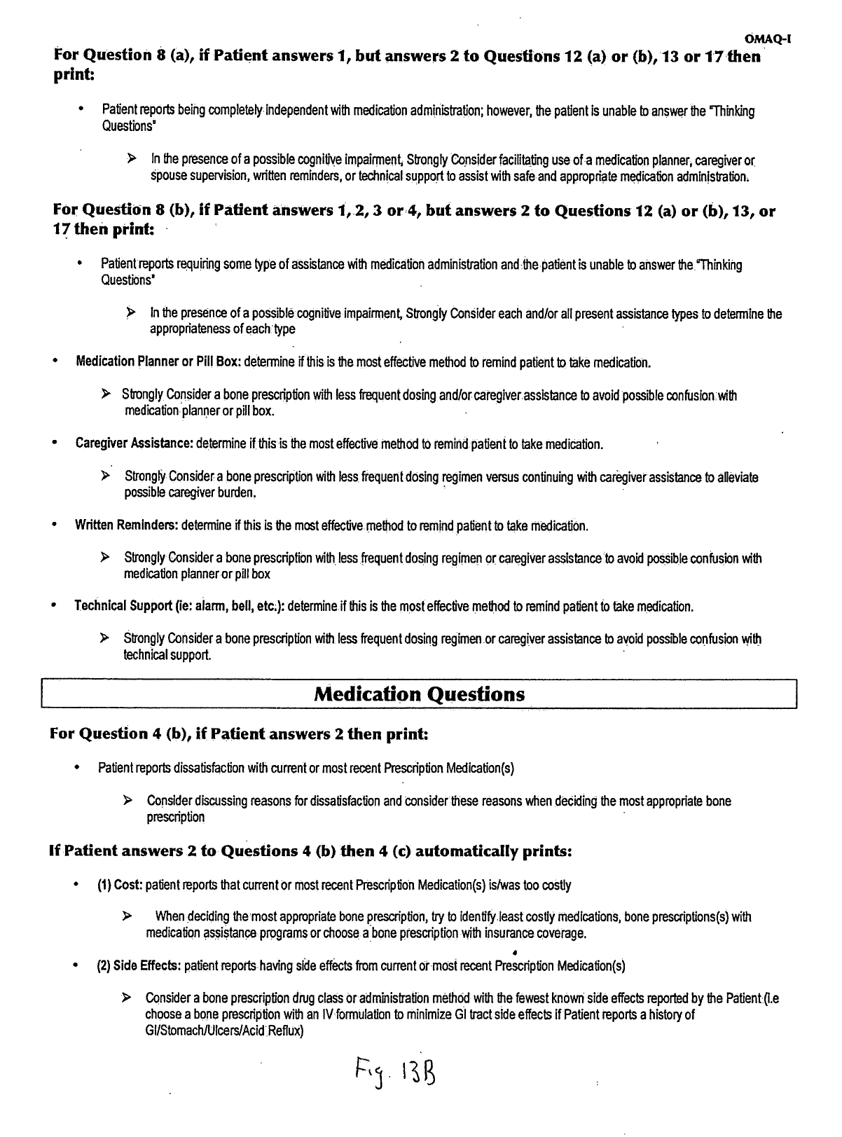

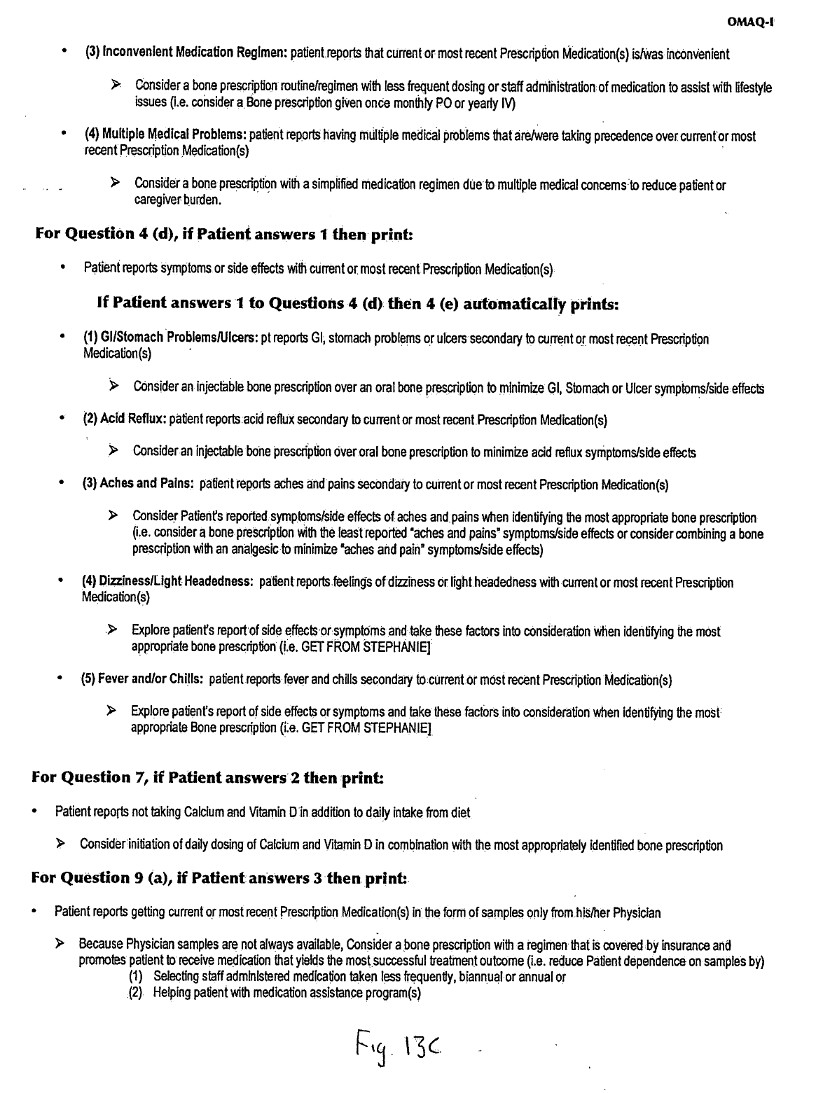

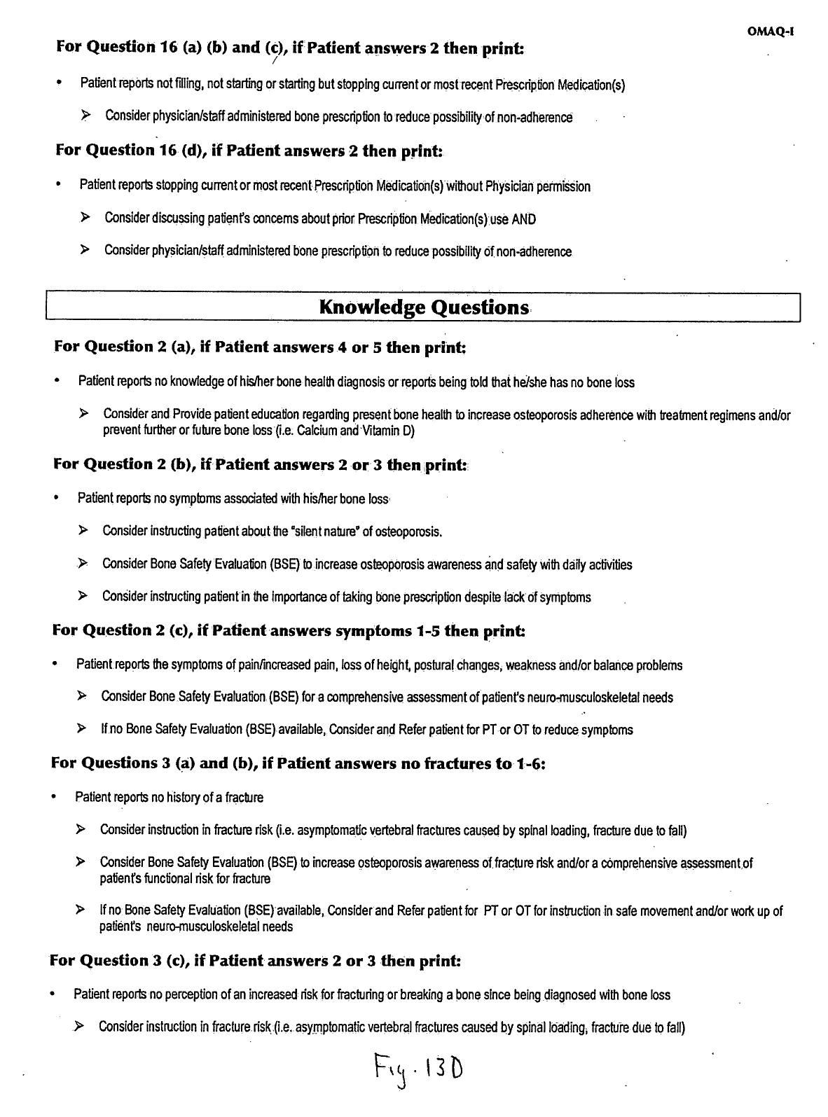

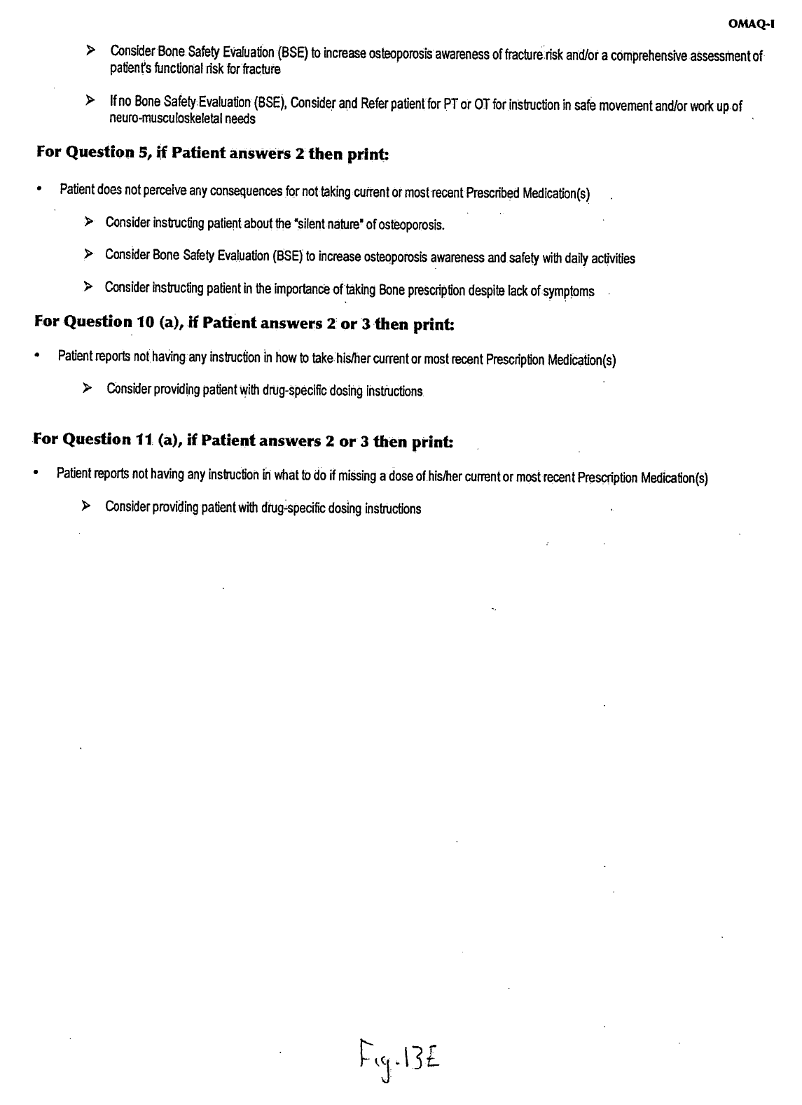

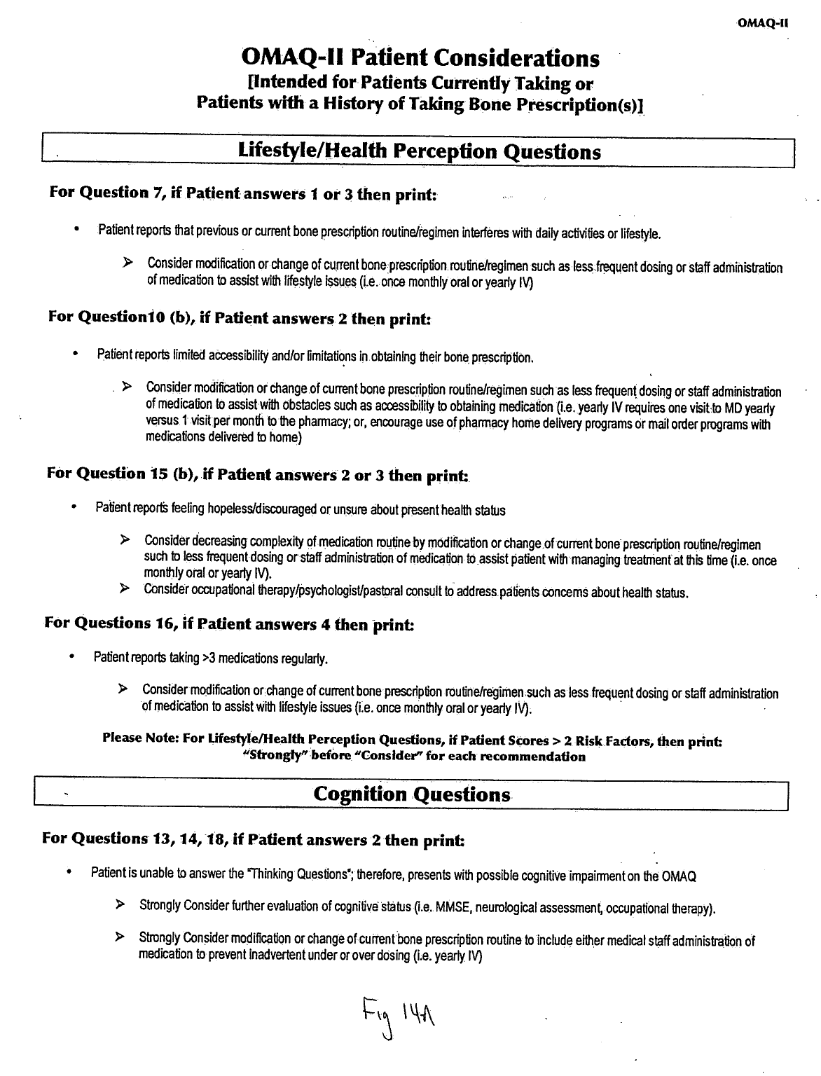

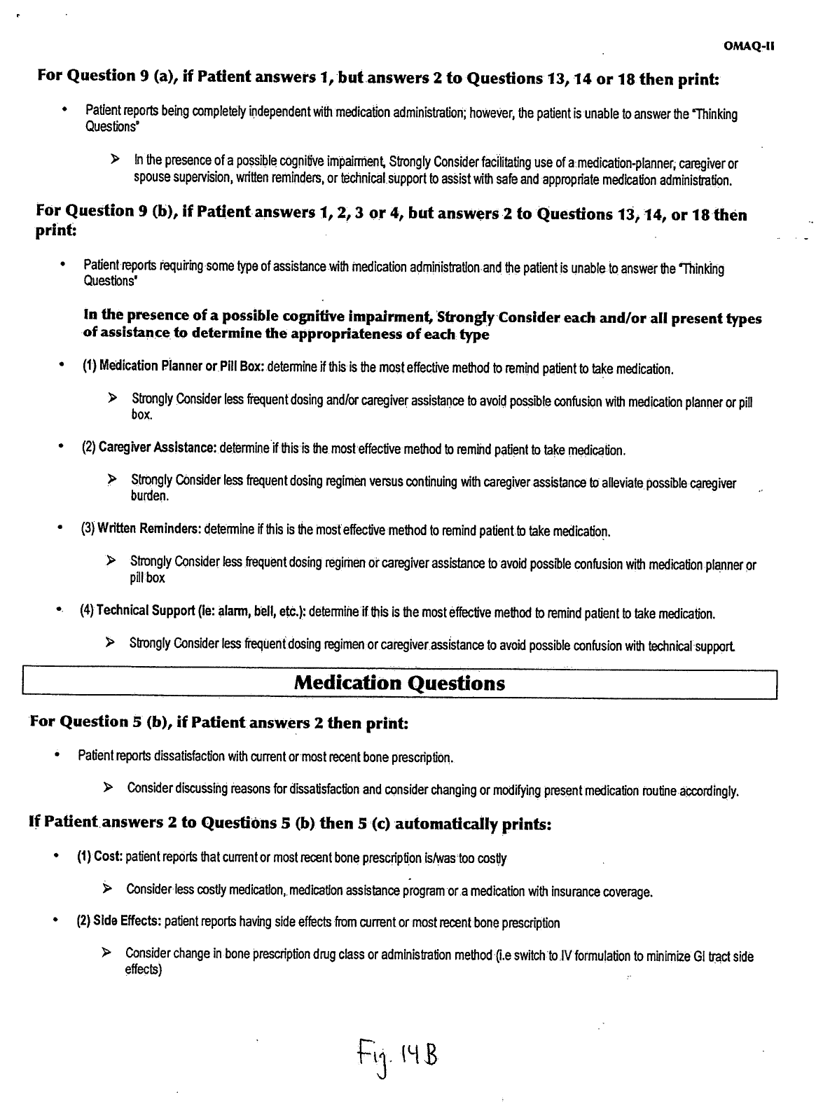

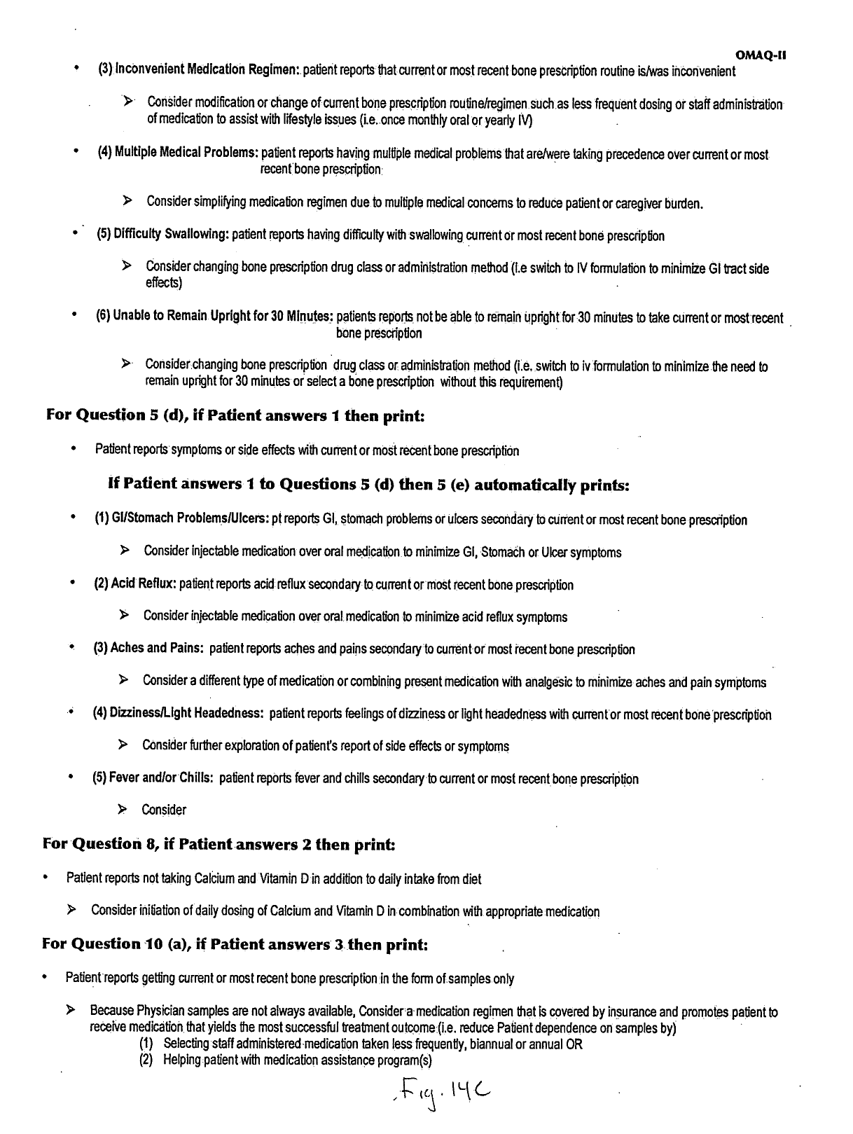

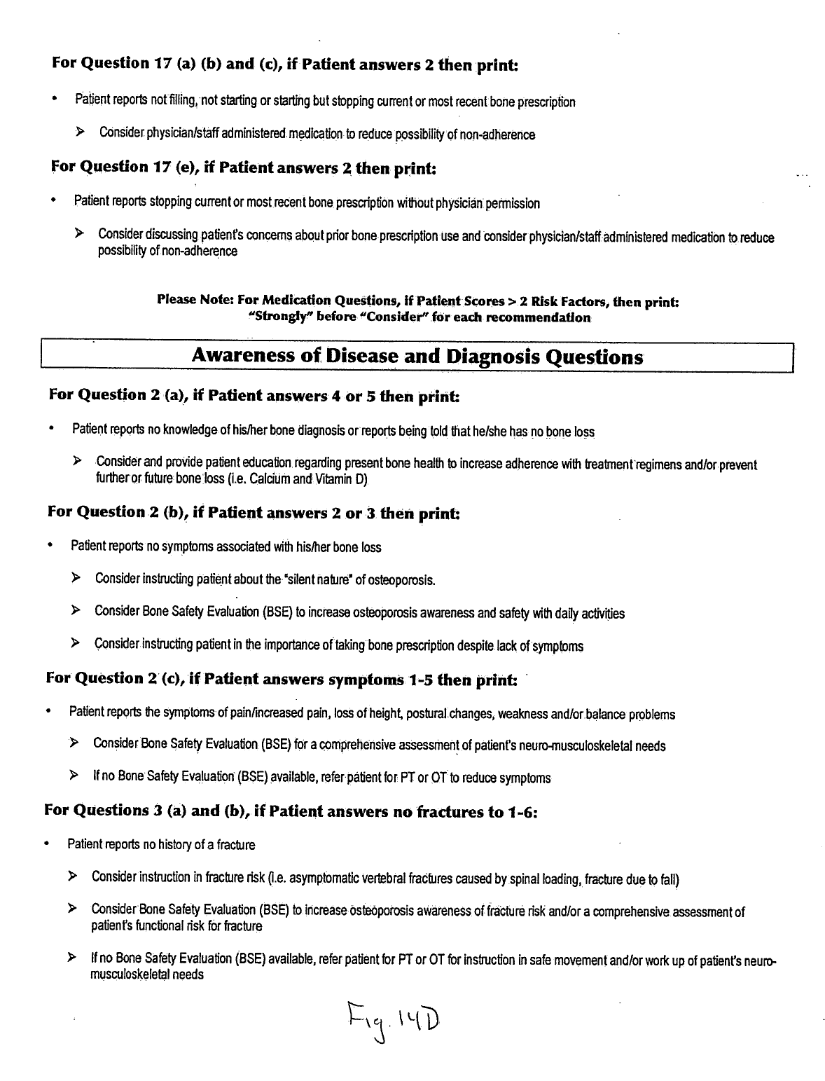

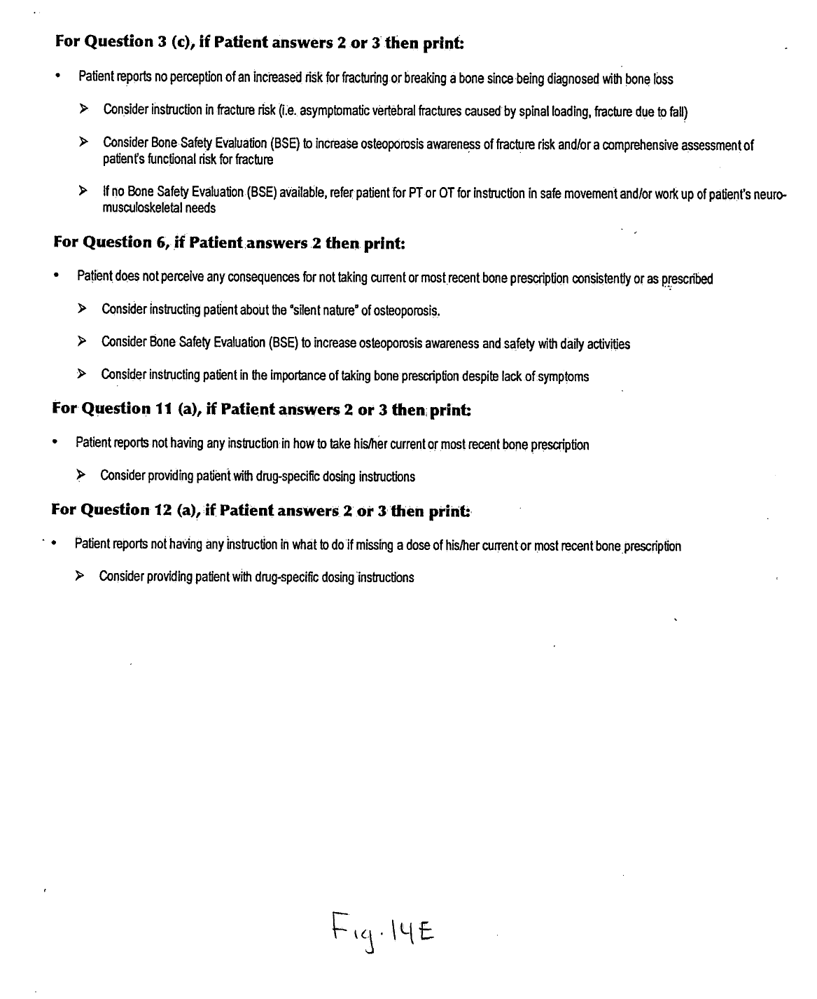

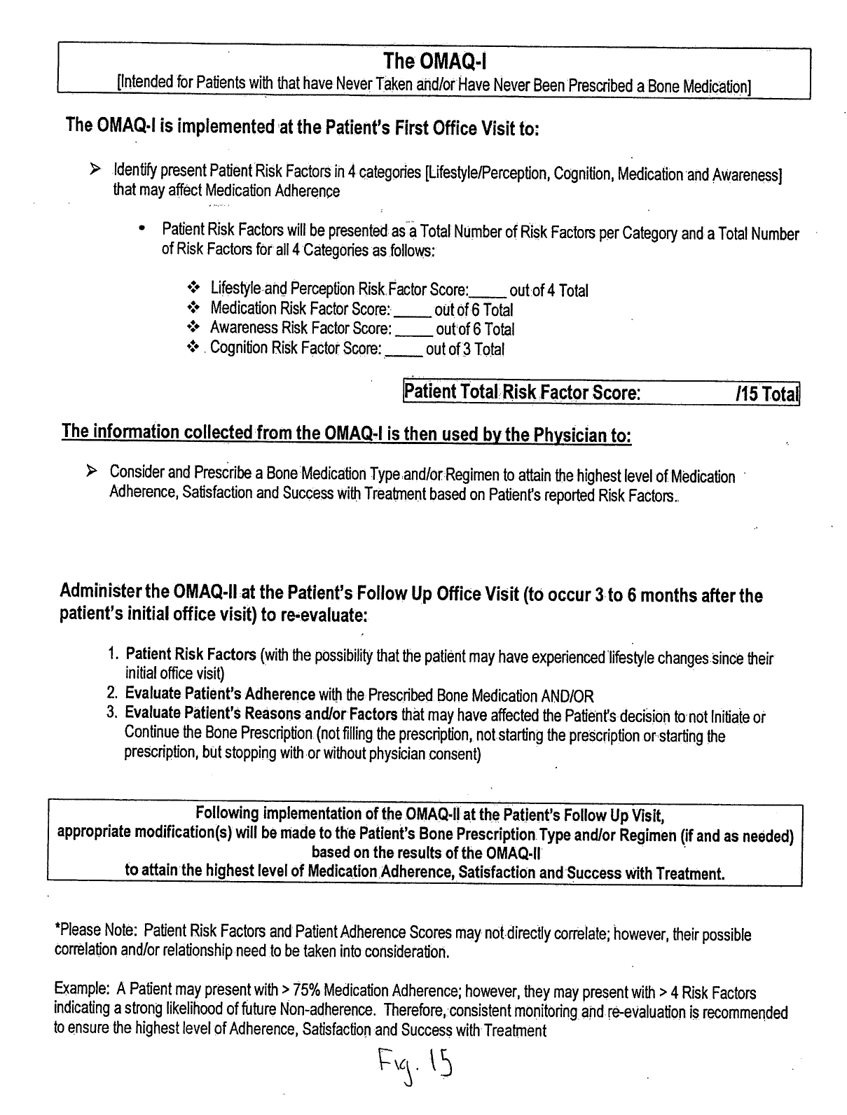

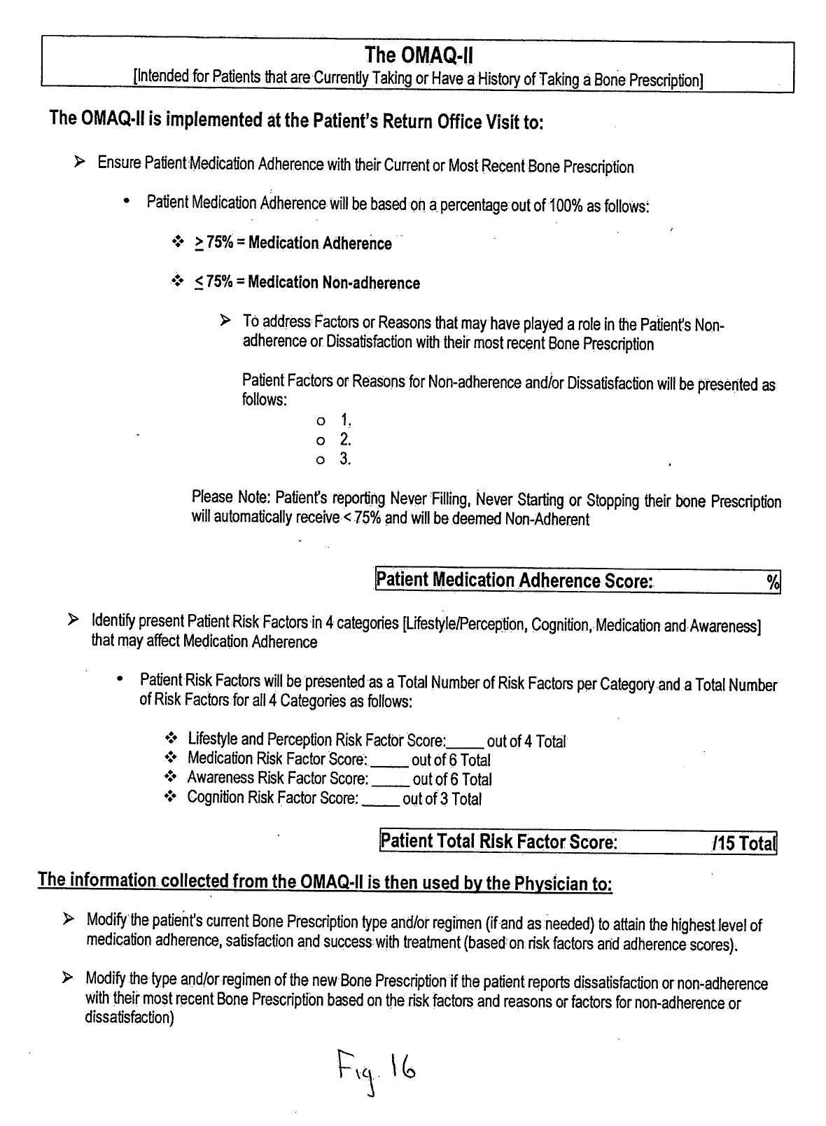

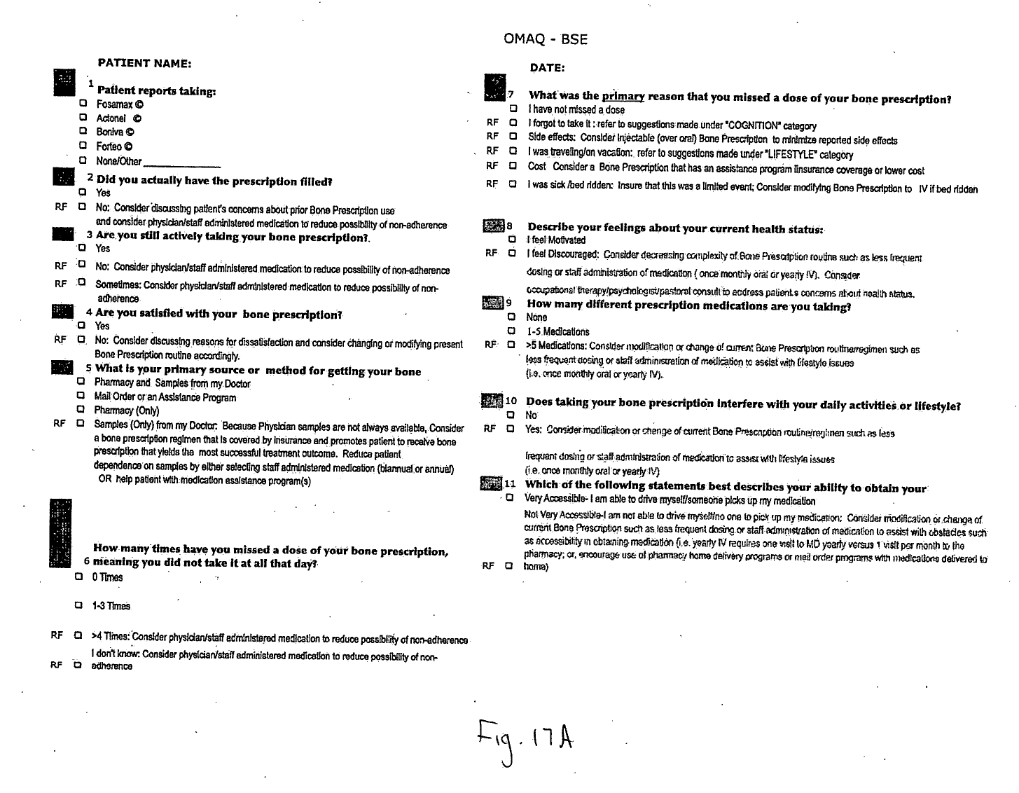

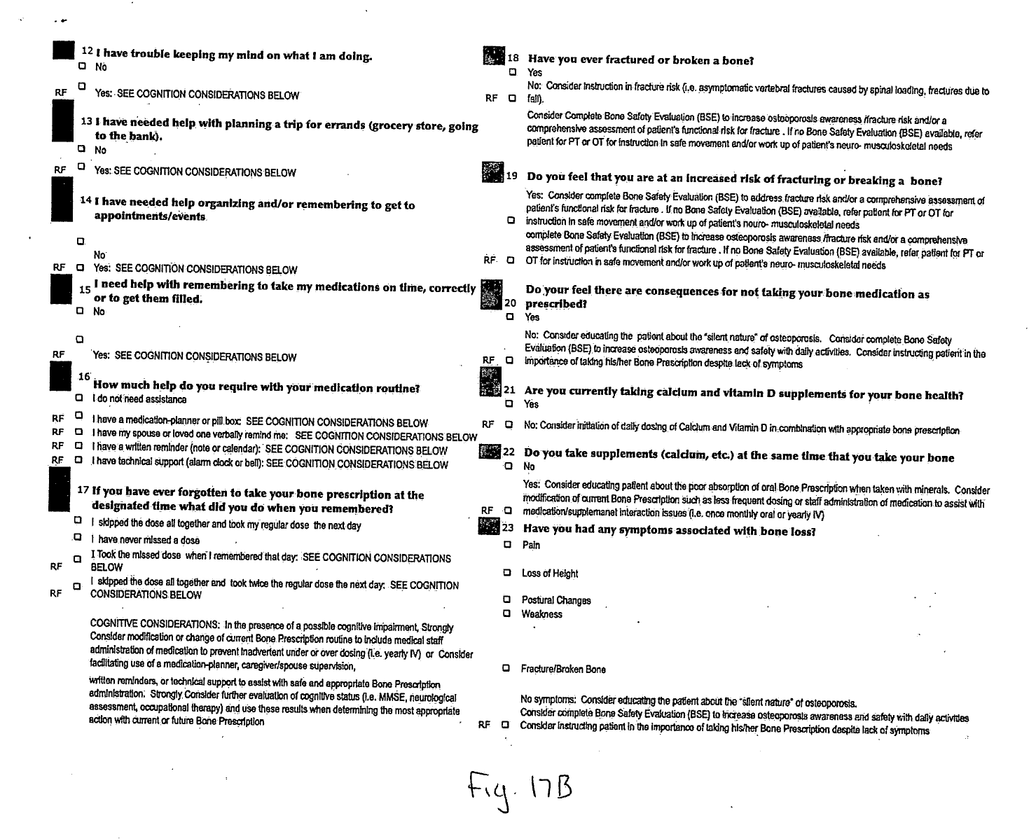

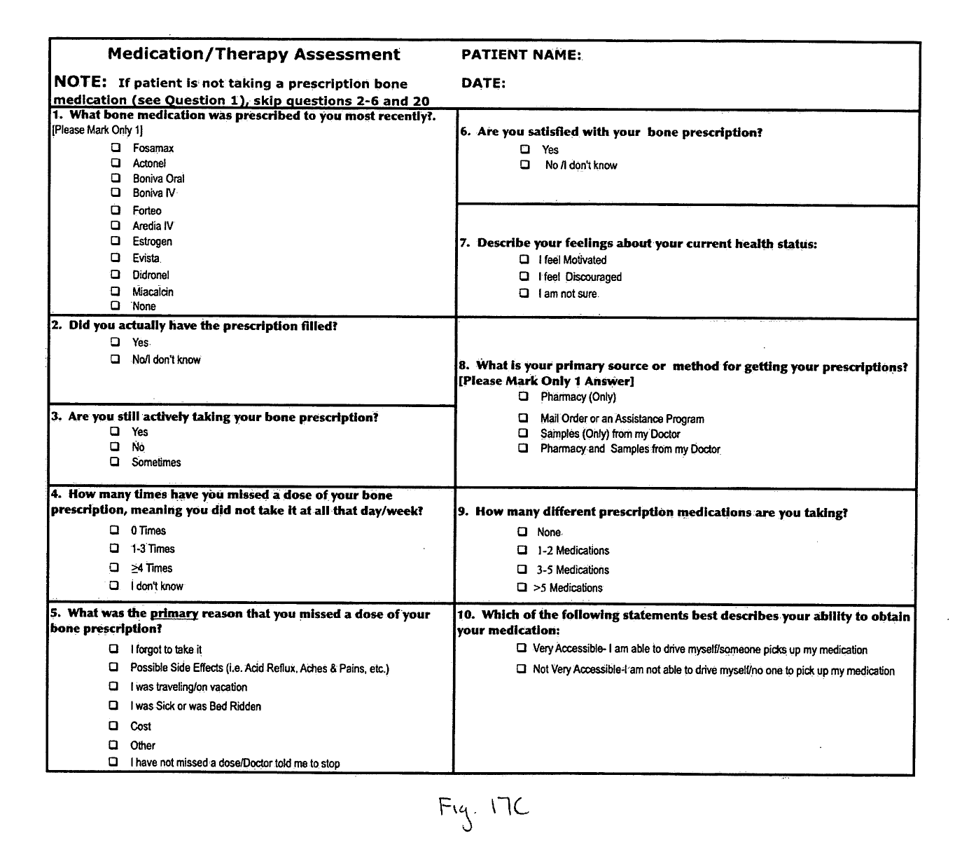

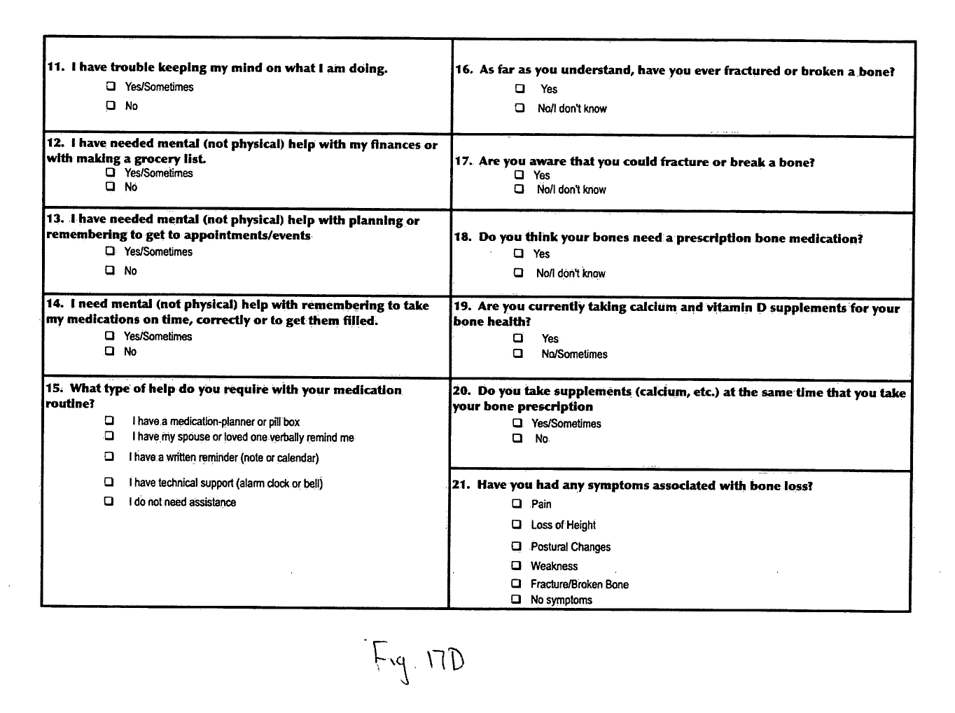

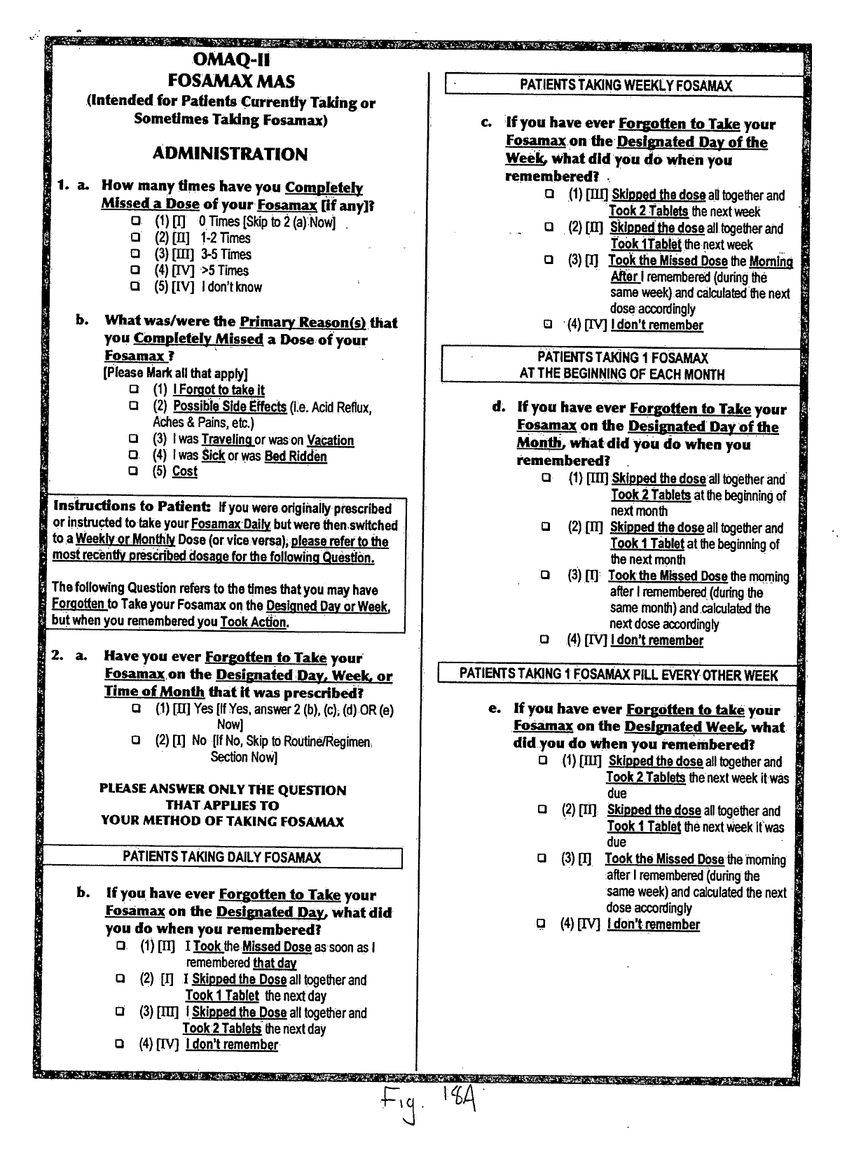

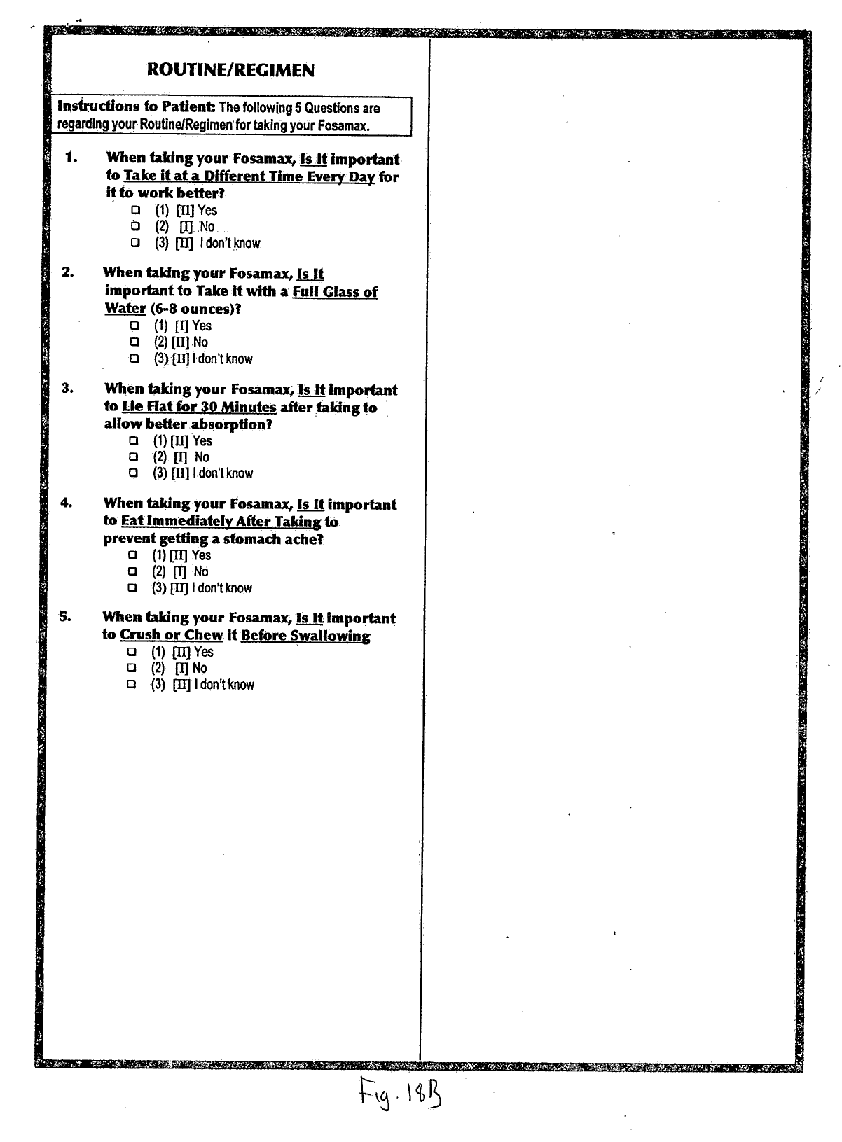

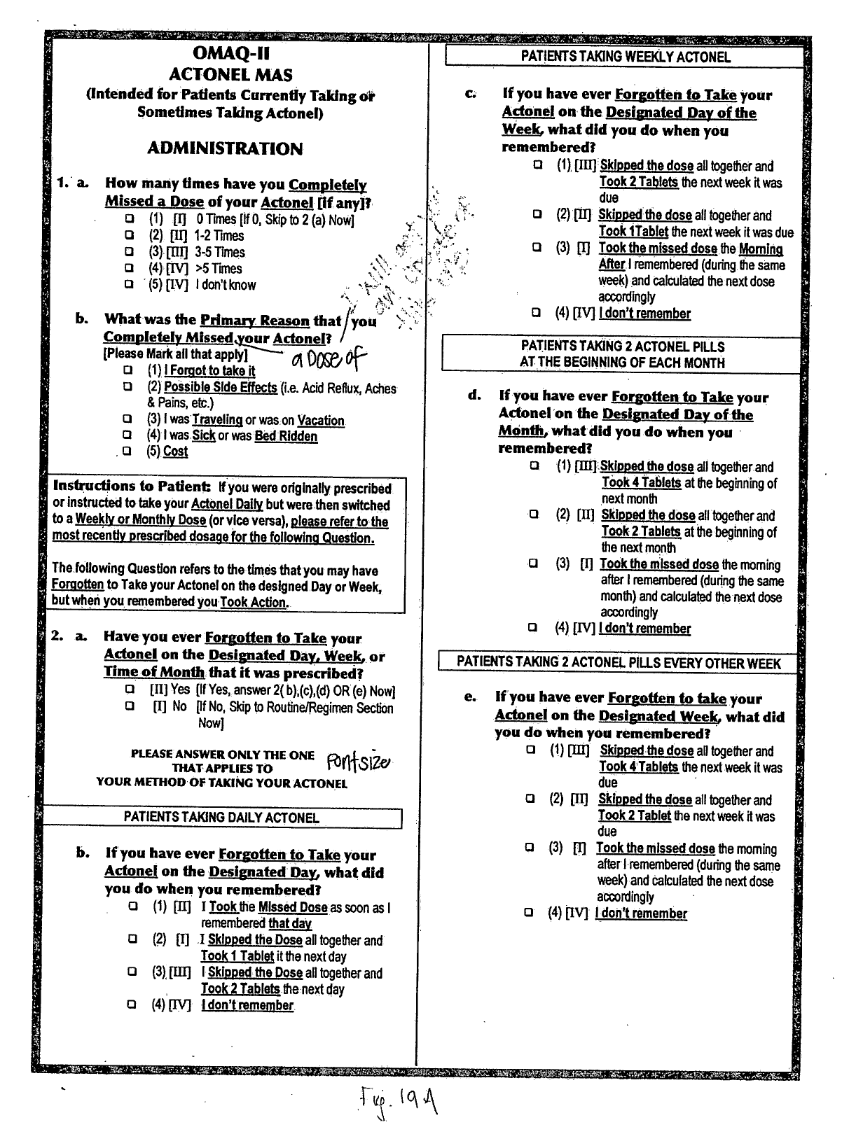

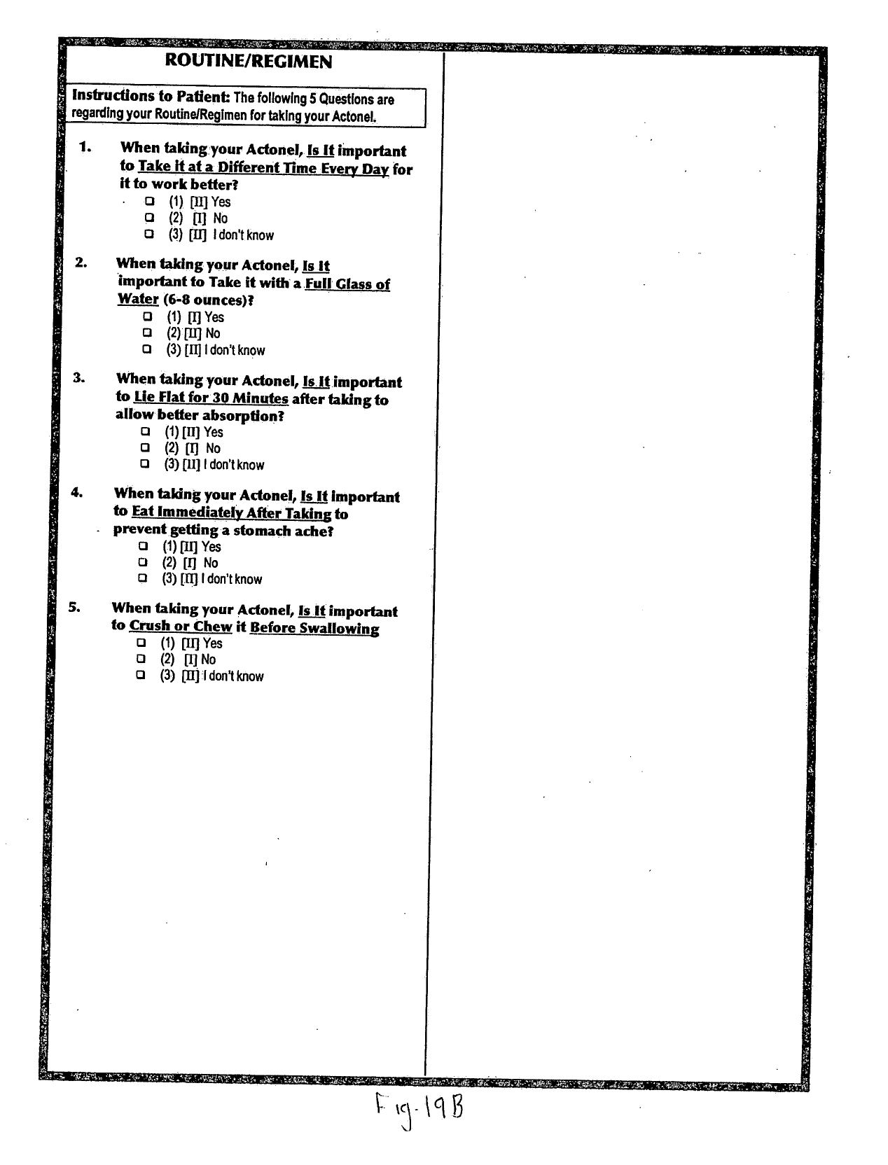

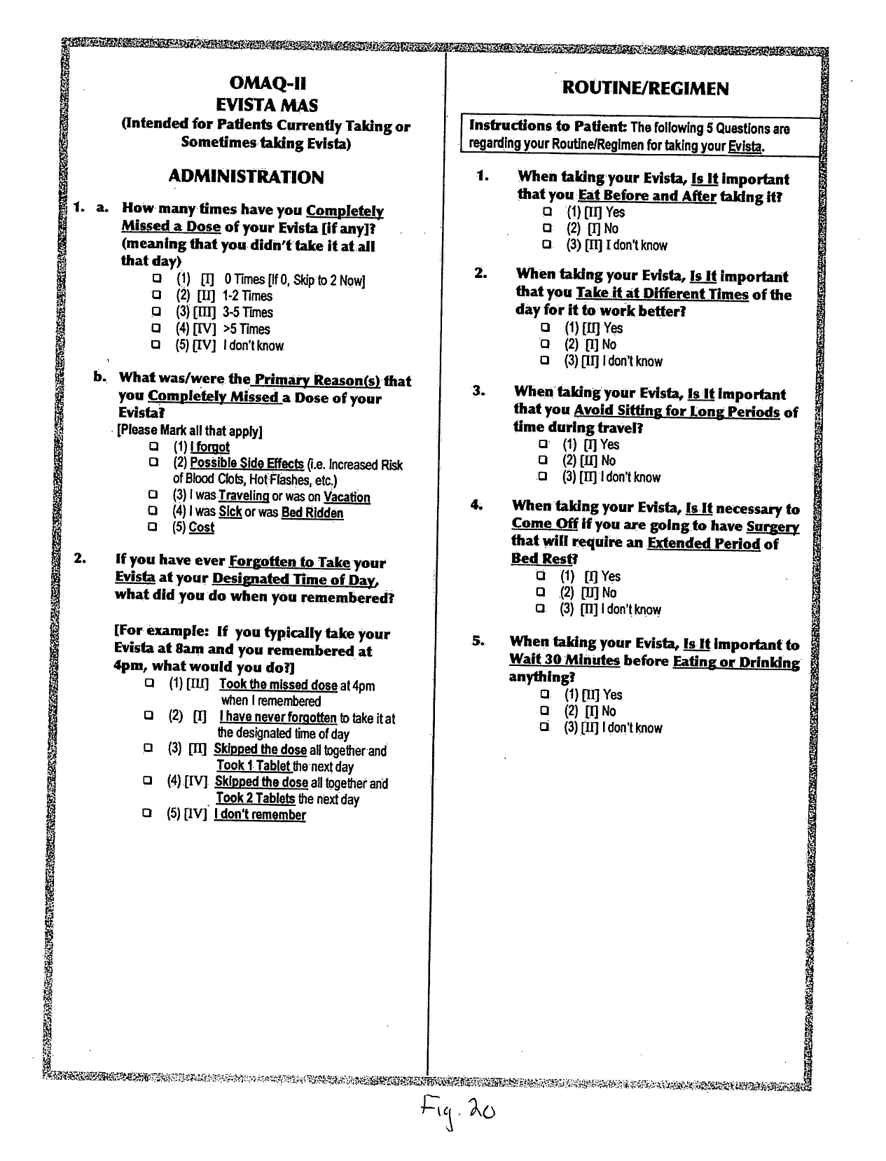

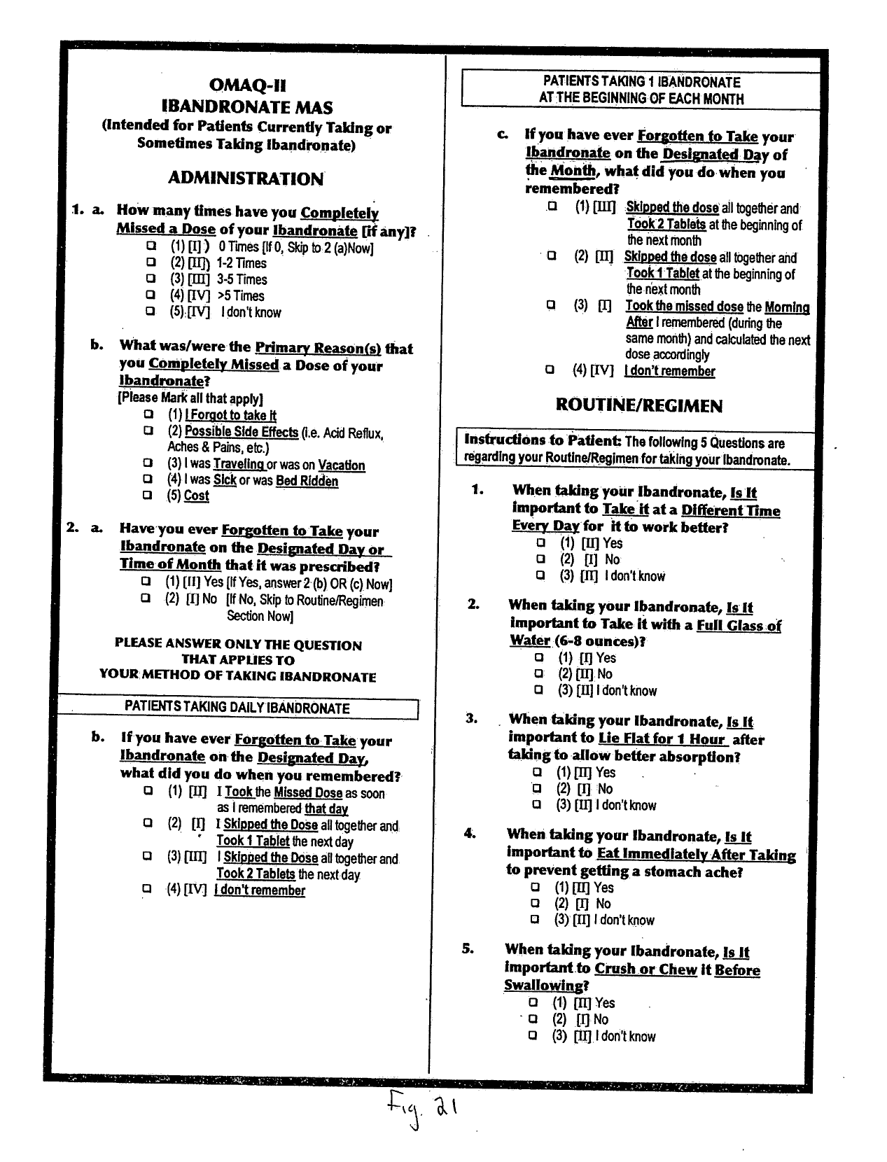

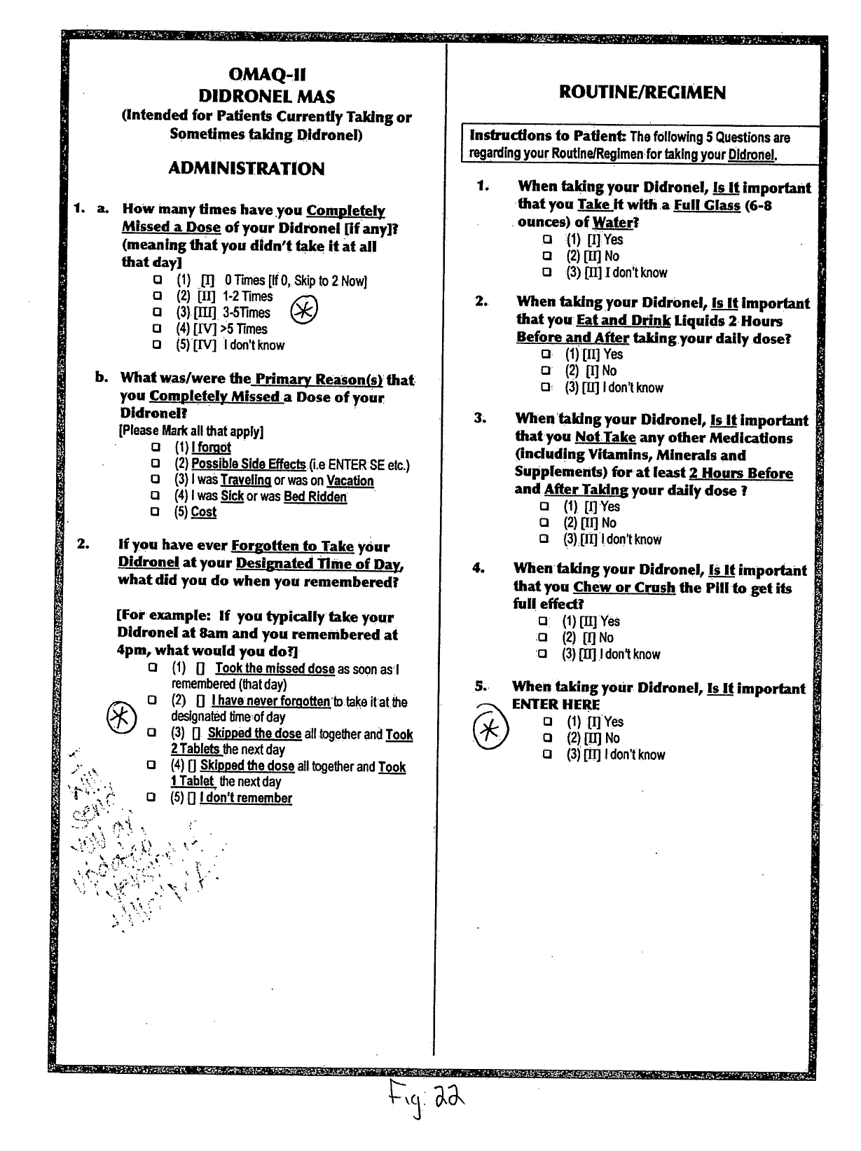

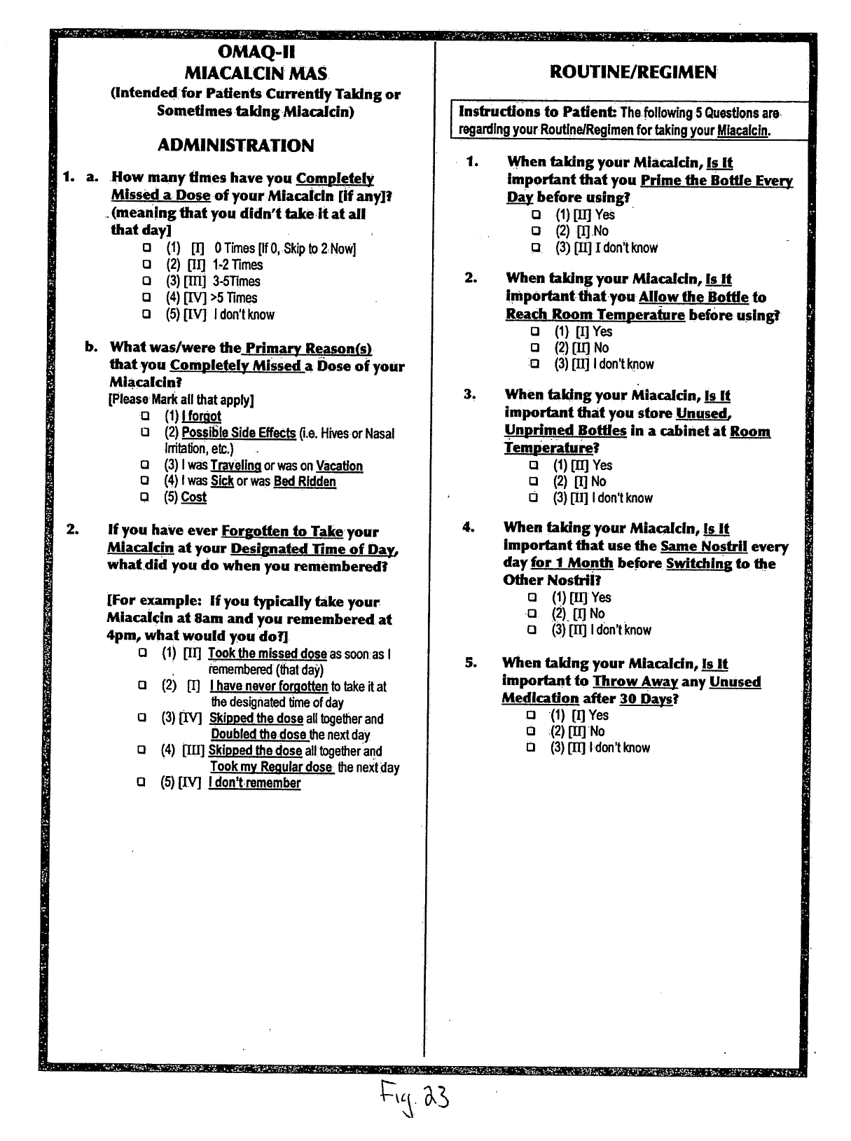

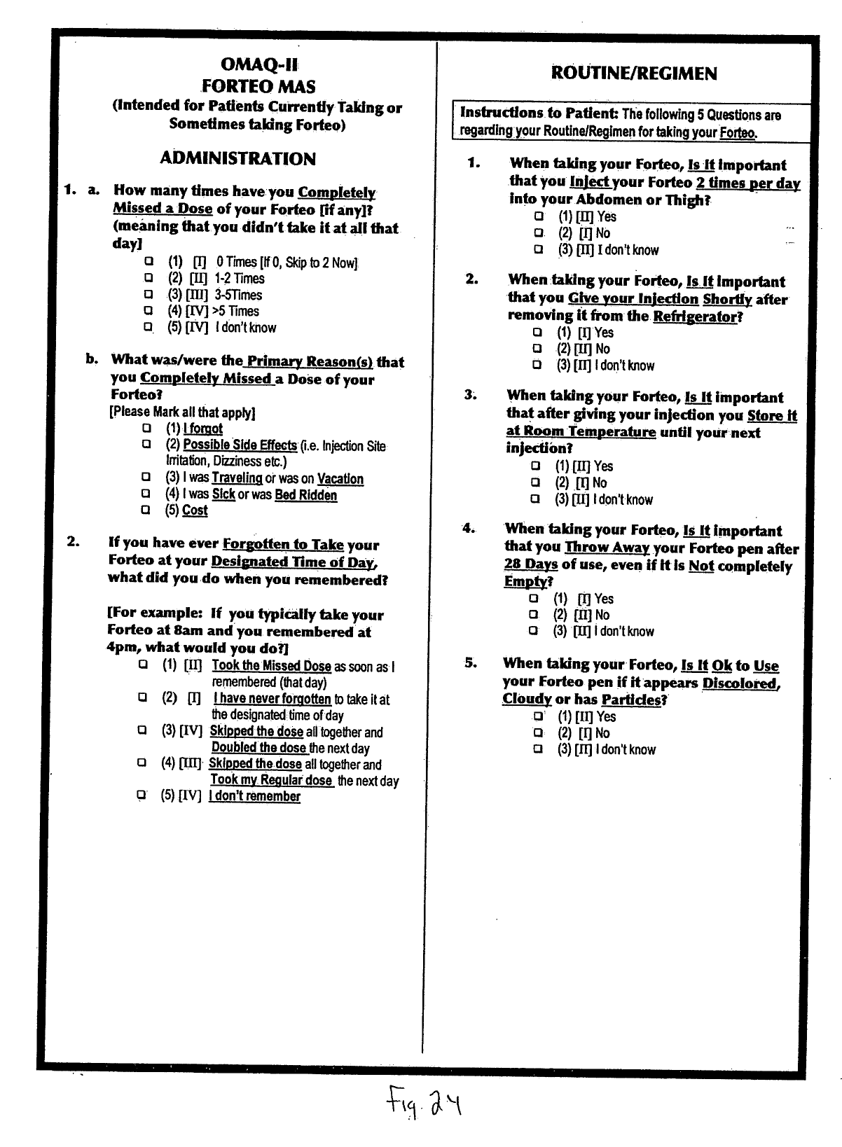

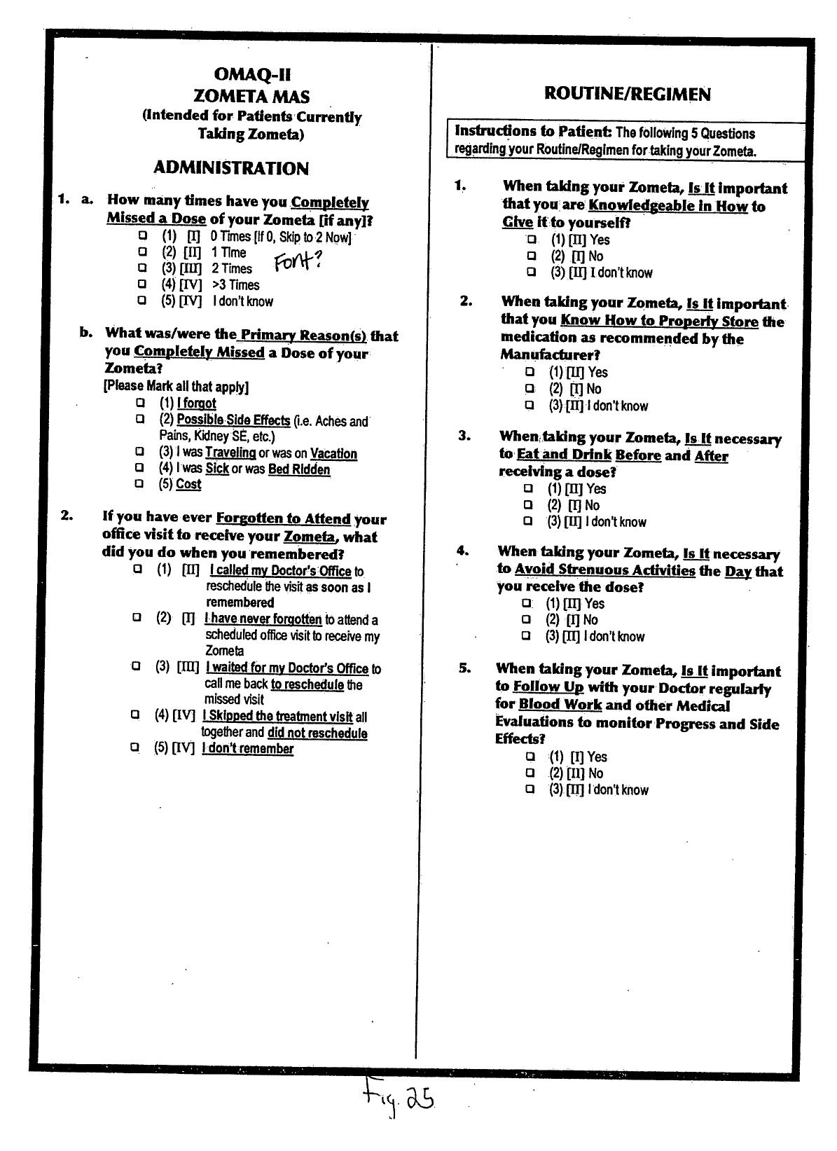

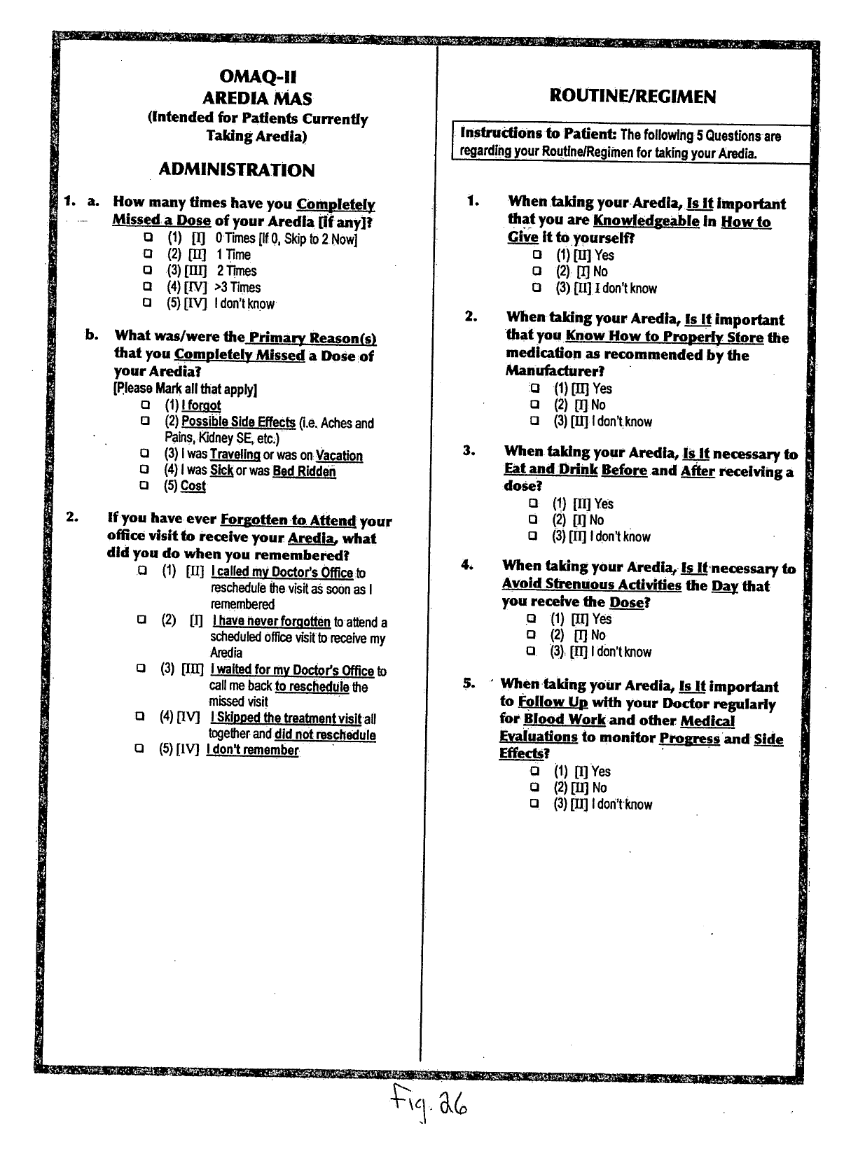

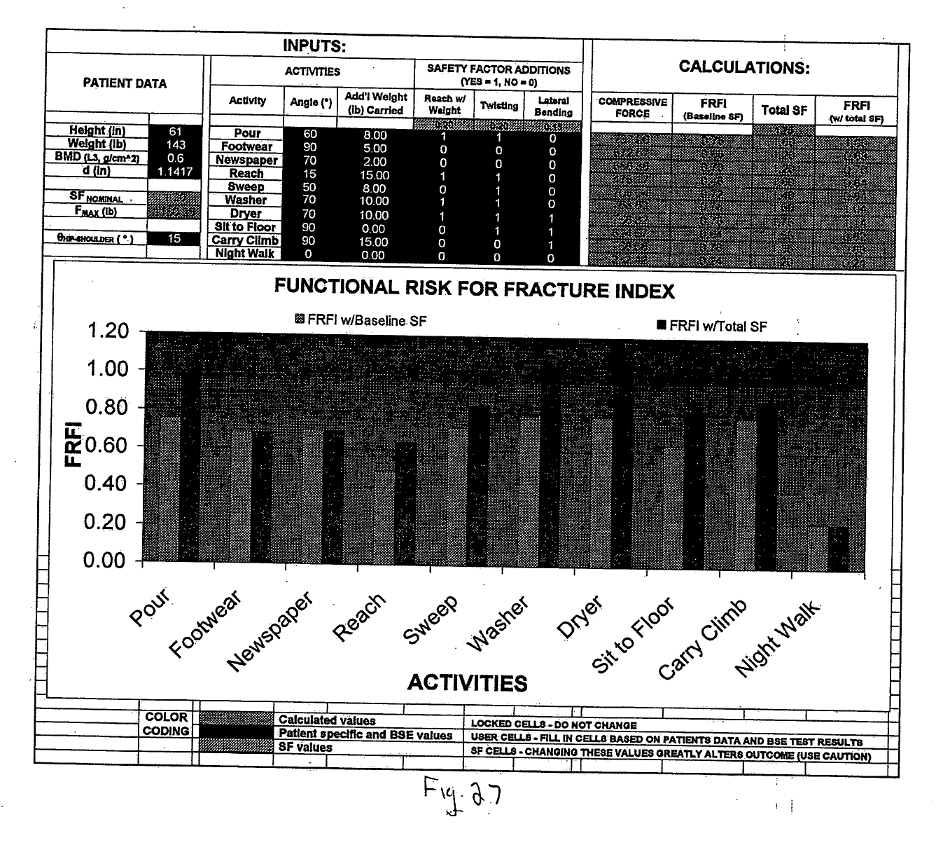

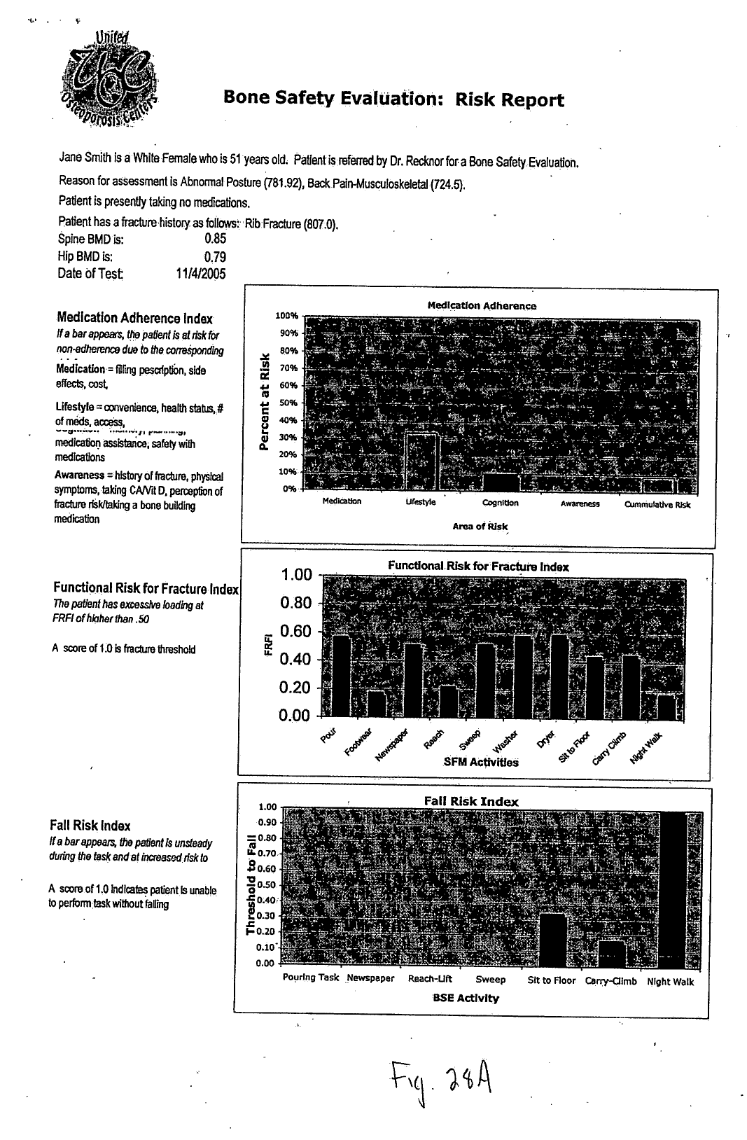

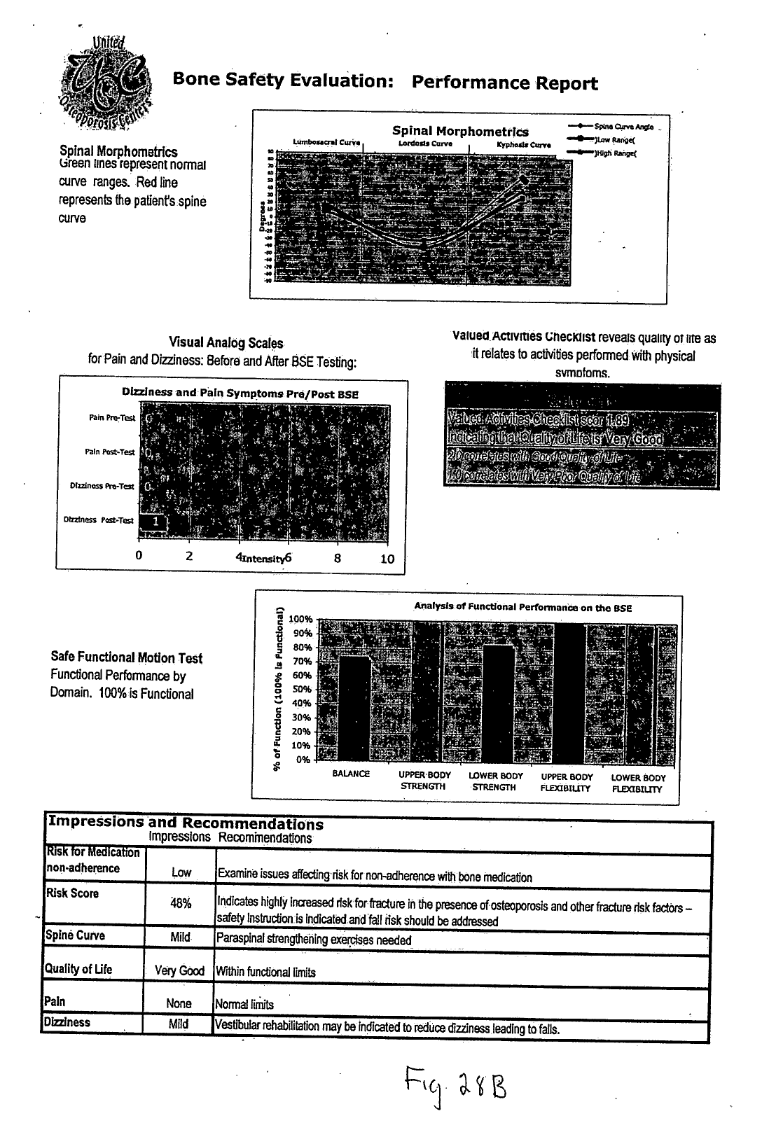

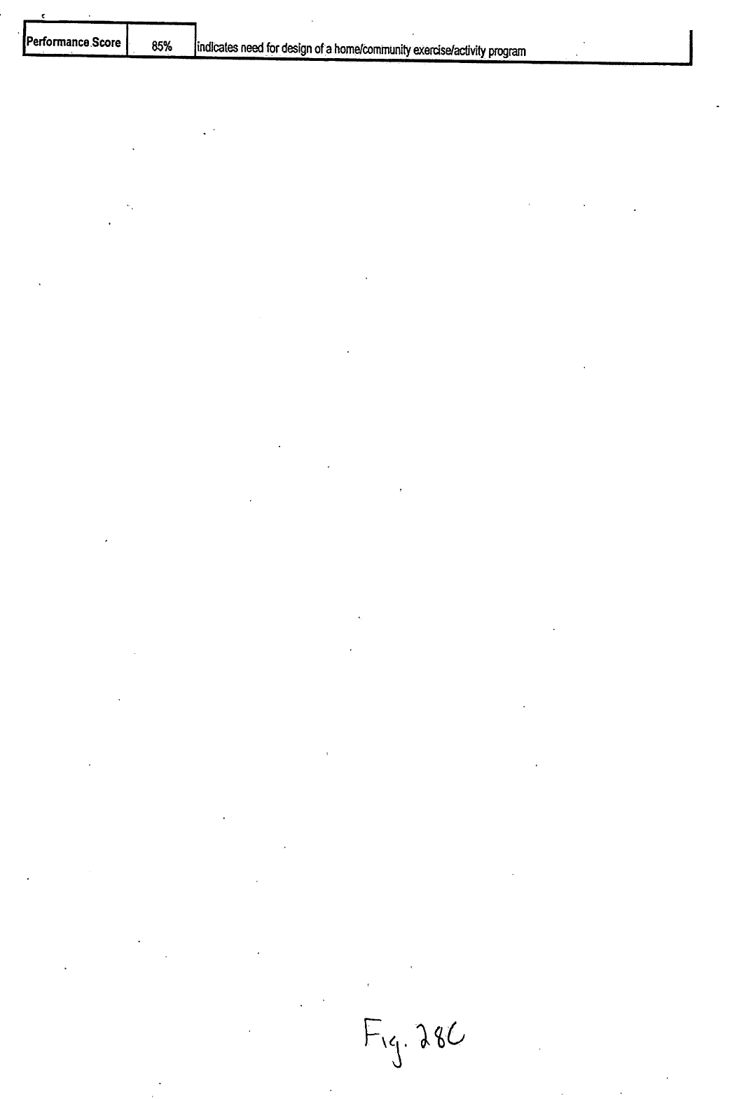

The following description incorporates both BSE™ and OMAQ™ into a single assessment tool in which a practitioner can use both assessment tools in order to fully evaluate not only a patient's risk, such as fracture risk, but also the associated adherence prediction of the particular patient. Reference is made to FIGS. 11A-26 that are embodiments of medical adherence questionnaires and scoring sheets. Reference is further made to FIGS. 27-28C that illustrate respective embodiments of risk reports described herein.

In general, many types of osteoporosis practitioners can implement BSE™-OMAQ™. A typical first step is to determine the version of OMAQ™ to use based on the patient's bone building medication history. A medication adherence assessment (MAA) is typically designed to be used as a quick screening on the same day as the BSE™, for quick medication risk assessment of patients that have taken or have never taken or have never been prescribed a bone building medication. OMAQ™-I is designed for patients that have never taken and/or have never been prescribed a bone building material medication and is generally more comprehensive more comprehensive. OMAQ™-II; is designed for patients that are currently taking and/or have ever been prescribed a bone building medication—more comprehensive.

In using MAA, a practitioner can record a number of risk factors for each of the four risk areas: lifestyle, medication, cognition, and awareness. The practitioner can calculate cumulative risk score by adding all risk areas. The practitioner can then cross reference the risks with the considerations sheet to identify recommendations. Any risk that is indicated can be addressed with a corresponding recommendation.

In using the OMAQ™-I (No Prior Use of Bone Building Medication), a practitioner can give the OMAQ™-I Data Form to the patient who can fill out the form in the office when he/she signs in with the receptionist. The practitioner can then collect the OMAQ™-I Data Form from the patient that can be done when he/she is called back to see the doctor.

In a typical implementation, the next step is to complete the cognitive questions (#12 (a) and/or (b), 13 and 17) and record the Patient's responses on the OMAQ™-I Data Form. The practitioner then generally transfers all of the patient's answers from the OMAQ™-I Data Form to the OMAQ™-I Risk Factor Scoring Sheet. Using the OMAQ™-I Risk Factor Scoring Interpretations (located on the OMAQ™-I Risk Factor Scoring Sheet), the Patient's Risk Factor Points will be tallied for each question category (Lifestyle and Perception, Medication, Awareness of Disease and Diagnosis and Cognition) and a Total Risk Factor Score is tallied and documented at the bottom of the OMAQ™-I Risk Factor Scoring Sheet”.

In addition, using the OMAQ™-I Risk Factor Scoring Sheet, the practitioner can identify what (if any) considerations and/or modifications for treatment are needed based on each of the Patient's identified Risk Factors (i.e. if the Patient receives a score of [I] or 1 Risk Factor, then the OMAQ™-I Risk Factor Scoring Sheet will indicate [C] for Patient Consideration for Treatment).

Using the OMAQ™-I Patient Considerations for Treatment, the practitioner can devise an OMAQ™-I Patient Risk Factor Report (see Sample Report located in the OMAQ™-I Section of the OMAQ™ Training Manual). For example, if the Patient receives a score of [I] or 1 Risk Factor for Question #6, indicating [C] for the Patient Consideration for Treatment, then the OMAQ™-I Patient Risk Factor Report will indicate the following: Patient reports that his/her previous or current Prescription Medication(s) routine/regimen interferes (d) with his/her daily activities or lifestyle. In such a situation, the practitioner can consider a Bone Prescription routine/regimen with less frequent dosing or staff administration of medication to assist with lifestyle issues (i.e. once monthly oral medication or once yearly IV medication).

In a typical embodiment, the information collected from the OMAQ™-I is then used by the practitioner to consider and Prescribe a Bone Medication type and/or regimen to attain the highest level of medication adherence, satisfaction and success with treatment (based on patient's risk factor score).

In using the OMAQ™-II (Prior Use of Bone Building Medication), the practitioner gives the OMAQ™-II Data Form to the Patient to fill out in the office when he/she signs in with the receptionist. The practitioner collects the OMAQ™-II Data Form from the Patient when he/she is called back to see the doctor. The practitioner then typically has the patient complete the Cognitive Questions (#13 (a) and/or (b), 14 and 18) and record the Patient's responses on the OMAQ™-II Data Form. The practitioner then transfers all of the patient's answers from the OMAQ™-II Data Form to the OMAQ™-II Risk Factor Scoring Sheet.

Using the OMAQ™-II Risk Factor Scoring Interpretations (located on the OMAQ™-II Risk Factor Scoring Sheet), the Patient's Risk Factor Points will be tallied for each question category (Lifestyle and Perception, Medication, Awareness of Disease and Diagnosis and Cognition) and a Total Risk Factor Score is tallied and documented at the bottom of the OMAQ™-II Risk Factor Scoring Sheet.

In using the OMAQ™-II Risk Factor Scoring Sheet, the practitioner can identify what (if any) considerations and/or modifications for treatment are needed based on each of the Patient's identified Risk Factors (i.e. if the Patient receives a score of [I] or 1 Risk Factor, then the OMAQ™-II Risk Factor Scoring Sheet will indicate [C] for Patient Consideration for Treatment). In using the OMAQ™-II Patient Considerations for Treatment, the practitioner can then devise an OMAQ™-II Patient Risk Factor Report. Figure **** illustrates (see Sample Report located in the OMAQ™-II Section of the OMAQ™ Training Manual)”

For example, if the Patient receives a score of [I] or 1 Risk Factor for Question #7, indicating [C] or Patient Consideration for Treatment, then the OMAQ™-II Patient Risk Factor Report will indicate the following: Patient reports that his/her current most recent Bone Prescription routine/regimen interferes (d) with his/her daily activities or lifestyle. Consider modification and/or change of current or most recent Bone Prescription routine/regimen such as less frequent dosing or staff administration of medication to assist with lifestyle issues (i.e. once monthly oral medication or once yearly IV medication).

In a typical embodiment, the OMAQ™ II Medication Adherence Section can next be completed. In a typical implementation, the OMAQ™-II Medication Adherence Section (For Patients that are Currently taking their Bone Prescription). The practitioner can give the appropriate (drug-specific) OMAQ™-II Medication Adherence Sheet (MAS) to the Patient that matches his/her current Bone Prescription (i.e. if the Patient is currently taking Fosamax, then give them the OMAQ™-II Fosamax MAS) to fill out when he/she signs in with the receptionist.

The practitioner can then collect the OMAQ™-II MAS from the Patient when he/she is called back to see the doctor and transfer all of the Patient's answers from his/her OMAQ™-II MAS to the correlating drug-specific OMAQ™-II MAS Scoring Sheet.

By using the OMAQ™-II MAS Scoring Interpretations (located on the OMAQ™-II) MAS Scoring Sheet), the Patient's Medication Administration and Routine/Regimen Points will be tallied and then a Total Medication Adherence Percentage is tallied and documented at the bottom of the OMAQ™-II MAS Scoring Sheet.

In a typical embodiment scoring can include the following criteria: Patients scoring <75% are deemed Adherent with their current Bone Prescription; and Patients scoring >75% are deemed Non-Adherent with their current Bone Prescription.

Using the OMAQ™-II MAS Scoring Sheet, the practitioner can identify what (if any) considerations and/or modifications for treatment are needed based on each of the Patient's answers (i.e. In the Medication Routine/Regimen Section, if the Patient receives a score of [II] or 0 Adherence Points for a question, then the OMAQ™-II MAS Scoring Sheet indicates [C] for Patient Consideration for Treatment). Using the OMAQ™-II MAS Patient Considerations for Treatment, the practitioner can then devise an OMAQ™-II Patient Medication Adherence Report (see Sample Report located in the OMAQ™-II Medication Adherence Section the OMAQ™ Training Manual).

For example, if the patient receives a score of [II] or 0 Adherence Points for Question #4 under the Medication Routine/Regimen Section, indicating [C] or Patient Consideration for Treatment, then the OMAQ™-II Patient MAS Report indicates the following: Patient is unable to correctly answer one of the Medication Routine/Regimen questions. The practitioner can then consider and Provide Patient with drug-specific dosing instructions, and consider and provide patient education regarding present bone health to increase medication adherence (i.e. via safe and proper self administration) with treatment routine/regimen to prevent further or future bone loss.

As discussed above, it is also possible that a patient did not adhere to the medication regime, and therefore can fill out an OMAQ™-II Non-Adherence and/or Dissatisfaction Section (For Patients “Did not Fill”, “Did not Start” and “Started but Stopped” their Bone Prescription). In a typical implementation, the practitioner gives the OMAQ™-II Medication NA-D Sheet to the Patient that matches his/her current Bone Prescription to fill out when he/she signs in with the receptionist. The practitioner can collect the OMAQ™-II Medication NA-D Sheet from the Patient when he/she is called back to see the doctor and transfer all of the Patient's answers from his/her OMAQ™-II Medication NA-D Sheet to the OMAQ™-II Medication NA-D Scoring Sheet.

Similar to as above, the practitioner can then use the Patient's answers from the OMAQ™-II Medication NA-D Scoring Sheet to tally the Patient's Reasons and/or Factors for each question category (Lifestyle and Perception, Medication, Awareness of Disease and Diagnosis and Cognition) and tally the Patient's Medication NA-D Reason and/or Factors and document at the bottom of the OMAQ™-II Medication NA-D Scoring sheet.

By using the OMAQ™-II Medication NA-D Scoring Sheet, the practitioner can identify what (if any) considerations and/or modifications for treatment are needed based on each of the Patient's answers (i.e. If the Patient marks “Yes” to one of the questions, then the OMAQ™-II NA-D Scoring Sheet will indicate [C] for Patient Consideration for Treatment). In addition, by using the OMAQ™-II Medication NA-D Patient Considerations for Treatment, the practitioner can further devise an OMAQ™-II Patient Medication NA-D Report (see Sample Report located in the OMAQ™-II Medication NA-D Section of the OMAQ™ Training Manual.

For example, if the Patient marks “Yes” for Question #1, indicating [C] or Patient Consideration for Treatment, then the OMAQ™-II Patient Medication NA-D Report indicates the following: Patient reports that his/her most recent Bone Prescription is/was too costly. The practitioner can then consider less costly Bone Prescription, a Bone Prescription with an assistance program or a Bone Prescription with insurance coverage.

Typically, the information collected from the OMAQ™-II is then used by the Physician to: Modify the patient's Current or Most Recent Bone Prescription type and/or regimen (if and as needed) to attain the highest level of medication adherence, satisfaction and success with treatment (based on the patient's risk factor score and medication adherence score); and/or modify the type and/or regimen of a new Bone Prescription if the patient reports dissatisfaction and/or non-adherence with their Most Recent Bone Prescription (based on the patient's risk factor score and their reasons and/or factors for non-adherence or dissatisfaction).

It is appreciated that the medical adherence systems and methods used in conjunction with BSE™ as discussed above can advantageously allow a practitioner to assess osteoporosis as well as medication adherence. The following description discussed the methodology for setting up a combined BSE™-OMAQ™ method and system.

In several implementations, the practitioner can select either MAA if the full BSE™ is being implemented or select OMAQ™/I/II.

In using the medical adherence assessment, the practitioner can use a two page sheet titled “Questions about your medication. The practitioner can ask the patient to complete the form. In general, the practitioner can state to patient “Please place a check mark (?) next to an answer for each question. Please check only one box for each question. If you are not taking a bone building medication, you will skip questions 2-6. Do you have any questions?” Clarify any questions that the patient has about the tasks.”

Similar to BSE™ alone, the practitioner can use two page sheet titled “Valued Activities Checklist and ask the patient to complete the Valued Activities Checklist. The practitioner can state to patient, “Please place a check mark next to each activity to indicate whether the activity is ongoing (more than 1 year), recently lost (within 1 year), recently gained (within 1 year). If the activity doesn't fit under the 3 indicated columns leave it blank. If you have any physical symptoms (back pain while standing, back pain while moving, dizziness, unsteadiness or weakness) that occur during these activities, place a check mark under the last column. Do you have any questions?” Clarify any questions that the patient has about the tasks”.

Physical Symptoms Assessment

The practitioner can further perform a physical symptoms assessment. For example, the practitioner can test posture by using an inclinometer. The practitioner can measure three locations on the patient's spine: Lumbosacral Angle; T12-L1 interspace; and C7-T1 interspace. To make these measurements, the tester typically follows these instructions. To locate the lumbosacral angle, the patient stands upright, and the practitioner kneels behind patient and places hands on right and left iliac crests, then palpates for the sacrum center. The practitioner places the inclinometer on this location, palpates and takes the measurement. Typically, normal range is 15°-20°. Next, the practitioner can “zero” out the reading by pressing the “ALT/Zero” button on the inclinometer until is reads “ALT” and then “0”. Next, palpate the T12-L1 interspace, place the inclinometer on this location and take the measurement. Typically, normal range is 30°-40°. Again, the practitioner can “zero” out the reading by pressing the “ALT/Zero”. Next, the practitioner can palpate the C7-T1 interspace, place the inclinometer on this location and take the measurement. Typically, normal range is also 30°-40°.

Similarly, for pain and dizziness, the practitioner can use a slide algometer. For height, the practitioner can use a stadiometer. For weight, the practitioner can use a scale. For BMD, the practitioner typically records the most recent spine bone mineral density (BMD) measurement. Similar to BSE™, the practitioner can perform a safe functional motion test as discussed above. In a typical implementation, the practitioner places a gait belt on patient for the entire duration of the test.

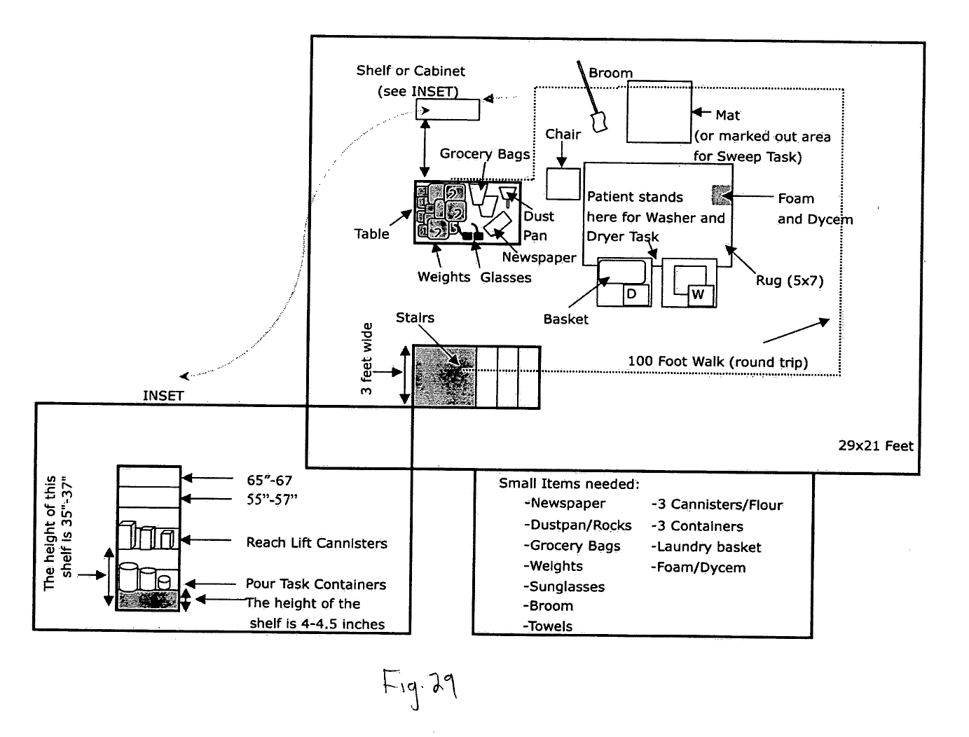

Similar as to discussed above, the patient then engages in a series of tests including, but not limited to: pour task; footwear task; newspaper task; reach-lift task; sweep task; washer task; dryer task; sit-to-floor task; carry-climb task; and night walk. The following description provides an example of how the above-discussed tasks can be implemented. FIG. 29 illustrates a map that can be implemented to set up the tasks in accordance with exemplary embodiments.

For the pour task, the equipment typically required is a 1 gallon container, filled with water, ½ gallon container filled with water, and a quart container filled with water; A cabinet or bookshelf with a shelf set up 3 inches from the floor; A table set at 28″-32″ in height. To set-up the practitioner sets the filled containers on the low shelf and place table 3 feet from the cabinet/shelf.

For the footwear task, the equipment typically required is a chair, at 16″-18″ seat height. The chair should typically be sitting on the floor, easily accessible to the patient.

For the newspaper task, the equipment typically required is three full size sheets of newspaper folded to 6″×12″. To set up, an area in the room is cleared with nothing to hold onto, place newspaper on the floor to start this test.

For the reach-lift task, the equipment typically required is 1 large container, filled with 8 pounds of flour; medium size container filled with 5 pounds of flour, and a small container filled with 2 pounds of flour; a cabinet or shelf unit with two shelves set up at 55″-57″ and 65″-67″ inches from the floor; a counter or table set up at 36″ in height. To set-up, the table or counter must be positioned below the cabinet or shelf. The practitioner cam set the filled containers on the table or the counter at 20″ away from the edge at which then patient stands.

For the sweep task, the equipment typically required is ½ cup aquarium rocks; tape-marked area on the floor that is a 4×3 rectangle; broom; hand-held dustpan; long-handled dustpan. To set-up, the practitioner can spread rocks on floor inside the taped-of area and have the broom and dustpans nearby.

For the washer task, the equipment typically required is a top-opening washer; 6 towels; three 2-pound sand weights; laundry basket. To set-up, the washer is placed to the left of the dryer. The practitioner can place 6 towels and 3 sand weights in the washer.

For the dryer task, the equipment typically required is a front-opening washer (opens down); 6 towels; three 2-pound sand weights; laundry basket. To set-up, the dryer is placed to the right of the washer. The practitioner can place 6 towels and 3 sand weights in the dryer.

For the sit-to-floor task, the equipment typically required is a chair, at 16″-18″ seat height; rug or mat that is not more than ½″ thick. To set-up, the chair should be sitting on the rug, easily accessible to the patient.

For the carry-climb task, the equipment typically required: is 24 lbs of weights: six 2-pound weights, two 3-pound weights and six 1-pound weights; Set of 4 stairs; two plastic grocery bags; one cabinet or shelf unit with a shelf set at 65″-67″ inches high; 36″ high counter or table. To set-up, the practitioner can place weights on the table/counter with plastic bags next to the weights; patient should walk 50 feet from the table before ascending stairs, then 50 addition (with at least 20 feet on a straight away for the head-turning portion of the test.

For the nightwalk, the equipment typically required is a chair, at 16″-18″ seat height; rug that is not more than ½″ thick; Visco-elastic open cell foam at 4½ inches thick. To set-up, the chair should be sitting at one end of the rug, easily accessible to the patient; place the foam cushion under the rug on the other side.

In a typical embodiment, BSE™ instructions are given to the patient. The patient is told that the BSE™ is a test to evaluate the way that the patient performs tasks that could increase the patient's risk for having a fracture (or a broken bone). The practitioner tells the patient that the patient typically completes a medication assessment so that the practitioner can understand concerns the patient has about taking medication for bones. In addition, the patient completes a checklist on the typical activities that the patient performs in everyday life. In addition, the patient is told to complete 10 tasks that closely represent typical movement patterns in which the patient engages daily. The practitioner typically informs the patient that the practitioner is watching how the patient completes each of the 10 tasks. The patient should complete each tasks as the patient would at home. The patient is told that if any assistance is needed during any task, let the practitioner know. The patient is further informed that the patient can request a rest break at any time during the testing process. The patient is further informed that the practitioner accompanies the patient throughout the testing process and gives specific directions for each task. The patient should ask for any clarification about instructions. The patient should inform the practitioner that if the patient has not completed the body movements involved in any of the tasks within the last 6 months. In general, the patient may elect to perform, but is not be expected to perform any task not done in the last 6 months. The practitioner typically then asks if any clarification is needed.

During implementation of the method, the practitioner asks the patient to complete the Medication Adherence Assessment. The practitioner typically states to patient, “Please place a check mark (√) next to an answer for each question. Please check only one box for each question. If you are not taking a bone building medication, you will skip the bone-building medication questions. Do you have any questions?” The practitioner should clarify any questions that the patient has about the questionnaire.

The practitioner further asks the patient to complete the Valued Activities Checklist. The practitioner should state to the patient, “Please place a check mark (√) next to each activity to indicate whether the activity is an ongoing activity (more than 1 year), recently lost (within 1 year), or recently gained (within 1 year). If the activity doesn't fit under the 3 indicated columns leave it blank. If you have any physical symptoms (back pain while standing, back pain while moving, dizziness, unsteadiness or weakness) that occur during these activities, place a check mark (√) under the last column. Do you have any questions?” The practitioner should clarify any questions that the patient has about the checklist. As discussed above, the patient typically wears this belt throughout the test for your safety.

For the physical symptoms assessment, the practitioner uses the inclinometer to test posture. The practitioner measures three locations on the patient's spine: Lumbosacral Angle; T12-L1 interspace; and C7-T1 interspace, as discussed above. To locate the lumbosacral angle, the patient stands upright, and the tester kneels behind patient and places hands on right and left iliac crests, then palpates for the sacrum center. The tester places the inclinometer on this location, palpates and takes the measurement. In general, normal range is 15°-20°. Next, the test “zeros” out the reading by pressing the “ALT/Zero” button on the inclinometer until is reads “ALT” and then “0”. Next, the tester palpates the T12-L1 interspace, and places the inclinometer on this location and takes the measurement. In general, normal range is 30°-40°. Again, the tester “zeros” out the reading by pressing the “ALT/Zero”. Next, the tester palpates the C7-T1 interspace, place the inclinometer on this location and takes the measurement. In general, normal range is also 30°-40°.

For pain, the practitioner uses the algometer and asks the patient, “How much pain have you bad in the last week?” Similarly for dizziness, the practitioner uses the algometer and asks the patient “How much dizziness have you had in the last week?” Next, the practitioner typically takes the patients height in inches and weight in pounds. Finally, the practitioner records the most recent BMD of spine at L1-4 measurement and BMD at left hip. The practitioner further performs the safe functional motion test. Figure illustrates an embodiment of asset-up map in accordance with exemplary embodiments.

For the pour task, the patient is informed that the patient picks up one of the milk containers from this shelf and carry it to the table behind the patient. The containers are labeled according to the amount they weigh. The patient is instructed to pick up the container with the maximal weight that the patient can safely carry to the table, which can be 28″-32″ in height. Then, the patient is instructed to pour the water into the cup until it is half full. The practitioner should give the patient time to feel any differences and ask if there are any questions.

For the footwear task, the patient is informed that the patient is to remove both shoes and socks then put them back on. The patient is told to perform the task the way he patient typically does at home. The practitioner should ask the patient to sit in a chair, which can be 16″-18″ seat height. If the person does not use ankle to knee approach, the practitioner can ask the following: “Can you place you ankle on your opposite knee? Can you position the other foot the same way?”

For the newspaper task, the patient is told to pick up a newspaper, which can be folded to 6″×12″, from the floor. The newspaper should be placed directly in front of subject, but not near a surface that can be leaned on. The patient is told to perform the task in the way the patient would normally pick something up from the floor. The practitioner should then ask if there are any questions.

For the reach-lift task, the patient is informed to place the heaviest container, up to about 8 pounds. The patient can then lift the container to the highest shelf (e.g., 55″-57″ and 65″-67″ inches from the floor) the patient can reach. In addition, a counter or table can be set up at 36″ in height. The patient is told to pick up the container with the maximal weight that the patient can safely place on the highest shelf. The patient should be given enough time to feel the differences. The patient is then typically told to reach back up to remove the container and told not to lean against the counter when you do this task. The patient is then typically asked if the patient has any questions.

For the sweep task, the practitioner can spread ½ cup aquarium rocks in a 4×3 block square rectangle. The patient is then asked if the patient uses a standard dustpan or a long-handled dustpan. The patient is then given the type of dustpan he/she uses. The patient is then informed that the patient is to sweep the rocks from the floor into the dustpan. The patient is then asked if the patient has any questions.

For the washer task, the practitioner can place 3 2 lb weights and 4-6 bath towels in the washing machine. The patient is informed that the patient is to simulate doing laundry. There are several towels and some weights in the washer. The patient started in front of the washer, opens the washer door, transfers all of the towels and weights from the washer to the dryer, and then closes the dryer door. The patient is then asked if the patient has any questions.

The dryer task is another task to simulate doing laundry. The patient starts in front of the dryer, opens the dryer door, and transfers the entire contents of the dryer to the laundry basket. The patient can move the basket anywhere if desired. When the patient is finished, the patient places the basket of towels on top of the dryer, and then closes the dryer door. The patient is then asked if the patient has any questions. In general, the practitioner places basket on the floor just behind subject. Typically, if the individual cannot pick up the basket, the practitioner removes two towels, an can ask the following: “Can you pick up the basket now?” In general, if patient uses spine flexion to pick up the basket, the practitioner can pickup the basket with the weight the patient can manage, and have the patient hold the basket and the practitioner should ask, “Can you squat down as far as you can and then stand back up?”

For the sit-to-floor task, the practitioner can use one chair, at 16″-18″ seat height, for test. The practitioner should have at least one hand on the belt to guard subject from dropping last few inches of the sit-down and if needed, to assist subject up from sit. The patient is informed that the patient is to sit down in the floor, stretch the legs out in front of the patient, and then come to a standing position. The patient can use the chair if desired, but if the patient can get on the floor without using the chair, the patient should do so. The patient is then asked if the patient has any questions. In general, if the patient is unable to do this task, the practitioner should test LE ROM by having patient sit in a chair, place legs on another chair of the same height and determine hip and knee ROM from this assessment.

For the carry-climb task, the patient is told to carry groceries from the counter top in this room, out a doorway, over to a set of stairs, up the stairs and down the stairs. The patient can use the stair railing if needed, but if the patient can climb and descend the stairs without using the railing, the patient should do so. Then, there is a walk back to this room while looking from one wall to the other 10 times as quickly as possible. The patient can stop moving the head and walk normally back to the this room to place the bag(s) on the shelf above the sink. Knowing this distance, the patient should place the maximal amount of weight the patient can safely carry into one or more of the grocery bags. The patient can carry the bags any way you like. In general, the practitioner should check to see if the weight is greater than 10 lbs. If so, the practitioner can remove weight until it=10 lbs. The patient is then asked if the patient has any questions. In another example, 24 lbs of weights, six 2-pound weights, two 3-pound weights and six 1-pound weights, a set of 4 stairs two plastic grocery bags, once cabinet or shelf unit with a shelf set at 65″-67″ inches high, 36″high counter or table can be used. The weights can be placed on the table/counter with plastic bags next to the weights and the patient should walk 50 feet from the table before ascending stairs, then 50 addition (with at least 20 feet on a straight away for the head-turning portion of the test.

For the nightwalk, the patient is told to stand up, walk over the rug and step up onto the foam obstacle under the rug three times (one time for practice). The patient is able to use your vision for the first trial, but for the second trial the patient wears glasses to block vision. This task is to simulate getting up in the night. When the patient stands up, which can be from a chair at 16″-18″ seat height, the patient tries not to use the patient's hands if possible The patient is then asked if the patient has any questions. In a typical implementation, the practitioner can give patient one trial with eyes open prior to two official trials. The practitioner can stand near the participant during all trials of this task in case of fall. The practitioner should give reminders to try to stand without hands before each trial.

In general, after the assessment, the practitioner should observe several characteristics. For pain, the practitioner uses the algometer and asks the patient, “How much pain have you had during this test today?” For dizziness, the practitioner uses algometer and asks the patient “How much dizziness have you had during this test today?

The BSE™-OMAQ™ has several scoring guidelines, one implementation of which is now discussed.

For the medication adherence assessment, the practitioner records a check mark next to an answer (one only) for each questions. The practitioner can tally the number of risk factors for each of the four risk areas: Lifestyle “ ”, Medication “ ”, Cognition “ ” and Awareness “ ”, and then calculate cumulative risk score by adding all risk areas. The practitioner typically cross-references the risks with the considerations sheet to identify recommendations. Any risk that is indicated should be addressed with a corresponding recommendation.

For the valued activities checklist, the practitioner can record the activities that the patient engages in according the instructions. At present, only the column labeled “physical symptoms” is scored. The practitioner can score a 2 if the patient does the task with no physical symptoms, or score a 1 if physical symptoms are present. In general, the practitioner can total the number of tasks with physical symptoms and divide by the total number of tasks performed. The following scoring guideline can be used:

“>0.895,“Very Good”

“>0.795,“Good”

“>0.695,“Fair”

“>0.595,“Poor”

“<0.595,“Very Poor”

For safe functional motion, if the person refuses to perform the task or the task is determined by supervising physician/therapist to be too difficult for the person at this time, the task is scored as a “0” unless components of the task—only as described below—can be assessed.

Balance and coordination is also generally scored. In general, no loss of balance (LOB) means the person is able to maintain balance using ankle strategies and needs no assistance to complete task. Unsteady means that the person uses upper extremity to steady self; therapist gives contact guard assist; person uses step strategy to maintain balance; person uses a wide base of support; person leans on object to support body weight and maintain balance; person does not turn head in fast manner. Loss of balance (LOB) means that the person is able to maintain balance only with assist from the therapist

Spinal compression forces are also scored. Squat/Kneel/Adaptation means that the person squats or kneels to complete task or uses adapted method to complete task, such as using a reacher, sock aide, asks for assistance, golfer's reach, use of stool, long-handled dust pan, or verbalizes a safe method of completing task (i.e. “I would ask my son to do that”). Bend Waist means that the person engages in spinal flexion at the lumbar or thoracic region at any time during the task. Twists means that the person twists spine during task (can be observed as shoulder motion opposite of hip motion). No Twist means that the person moves body as unit, avoiding spinal twist.

The tasks are also specifically scored. For the pour task, carried close means that the person holds the container close to trunk to assist in carrying container to table (includes close carry by the side). Carried Away means that the person holds the container away from the trunk (includes use of momentum to place the container on table).

For the newspaper task, if the person uses a bending at the spine to pick up the newspaper, score a 0 for spinal compression.

For the footwear task, knee full means that the person is able to place ankle on opposite knee with<Knee Full. Hip full means that the person is able to place ankle on opposite knee with>=45° ER. <Hip Full means that the person is unable to place ankle on opposite knee with>=45° ER.

For the reach-lift task, flat footed/adaptation means that the person reaches with both feet flat on the floor or uses a step stool with handle and no loss of balance to place or retrieve item. Tip toes means that the person comes up on one or both toes in order to place or retrieve item. In general, leaning against the counter would be scored as “unsteady”

For the sweep task, bend at the spine means that the person bends at upper or lower back when sweeping the rocks into a pile and/or when sweeping the rocks into the dustpan.

For the washer task, reach method, bend at the spine means that the person has lumbar or thoracic flexion when reaching into washing machine. Reach method, golfer's reach or adaptation means that the person uses a golfer's reach (kicking one leg straight into hip extension with knee extended as well to minimize lumbar flexion or thoracic flexion) or the person uses another adaptation (i.e. use a reacher or call for help) when reaching into washing machine. In general, ROM is scored only if the person engages in reaching motion themselves; if person can obtain articles with hands from bottom of washer—score>=90°.

For the dryer task, if the person uses a bending at the spine to pick up basket, or chooses to place the basket on the dryer when it is empty, the person is asked to attempt the basket-lifting portion of the task again by using a squat or kneel if possible—the practitioner can score flexibility and strength at this time. If person partially squats but lumbar flexion or thoracic flexion is still observed—the practitioner can score as “partial squat”.

For the sit to floor task, use chair. Yes: means that the person must use to chair to either sit to or get up from the floor. Use chair, No means that the person does not need the chair to either sit to or get up from the floor. Lowers self to floor, Yes means that the person is able to get on the floor. Lowers self to floor, No means that the person is not able get on the floor. Sits LE straight, Yes means that the person sits with knees straight with out reclining to more than 90° hip extension. Sits LE, Yes means that the person sits with knees bent or reclines to more than 90° hip extension.

For the carry-climb task, carried weight evenly, Yes means that the person has the same amount of weight in two bags and carries one bag in each hand for the entirety of the task with exception of stairs and opening door. Carried weight evenly, No means that the person carries only one bag; person carries two bags with unequal weight in each; person carries two bags in one hand. Climb—no rail/guide means that the person does not use the railing or only lightly uses the rail for safety. Climb—rail as assist means that the person clearly uses the rail to enable them to ascend or descend the stairs. Climb—no climb the person does not climb the stairs. Feet per step—One means that the person uses only on foot per step. Feet per step—two means that the person uses two feet per step. Feet per step—None means that the person does not climb.

For the night walk, balance with or without light means scoring is as follows: Score (0) LOB if person is unable to step onto the foam or is unable to stay on the foam; Score (1) unsteady if excessive sway is noted, but person is able to step onto foam and able to remain on the foam; and Score (2) no LOB if able to step onto foam, and no excessive sway is noted. In rising from the chair/couch: Score (0) Unable if person is unable to rise from the chair without help from examiner; Score (1) Hands if person is unable to rise from the chair with use of hands; and Score (2) Able if person is able to rise from the chair without hands.

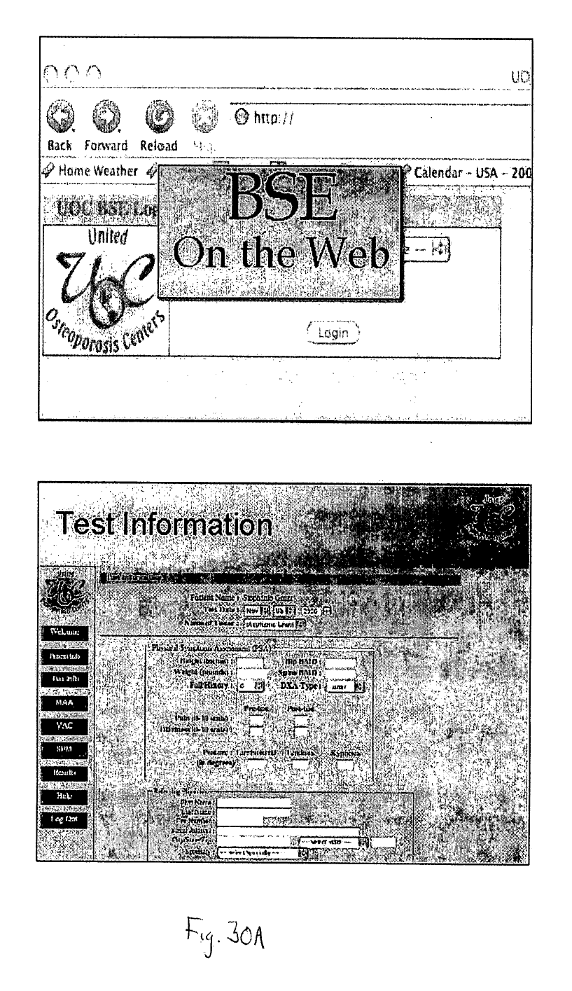

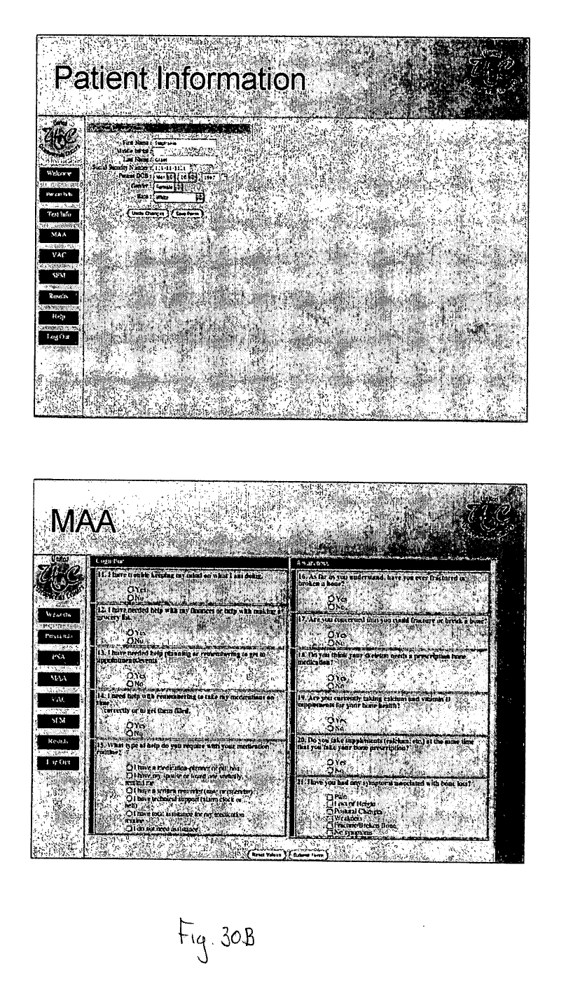

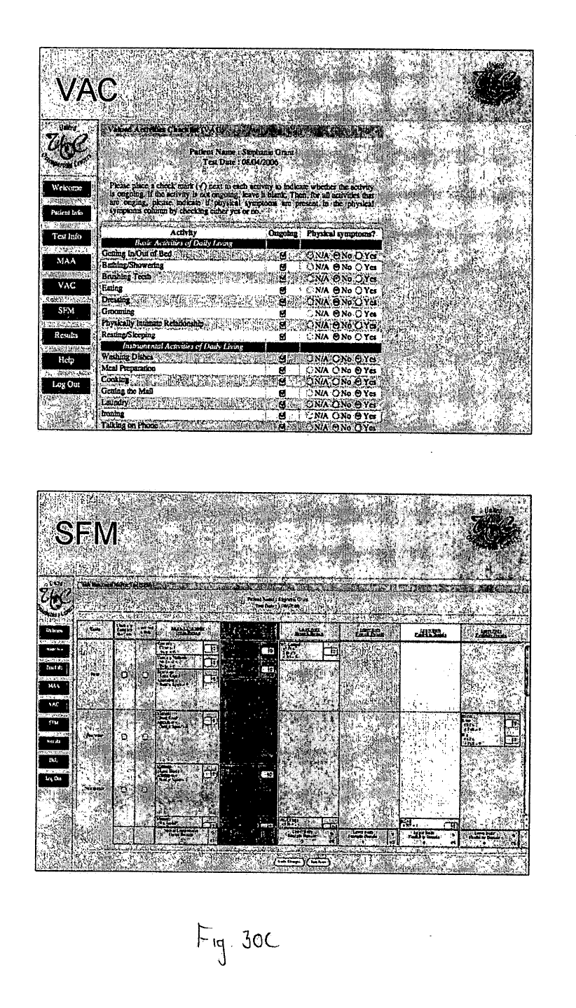

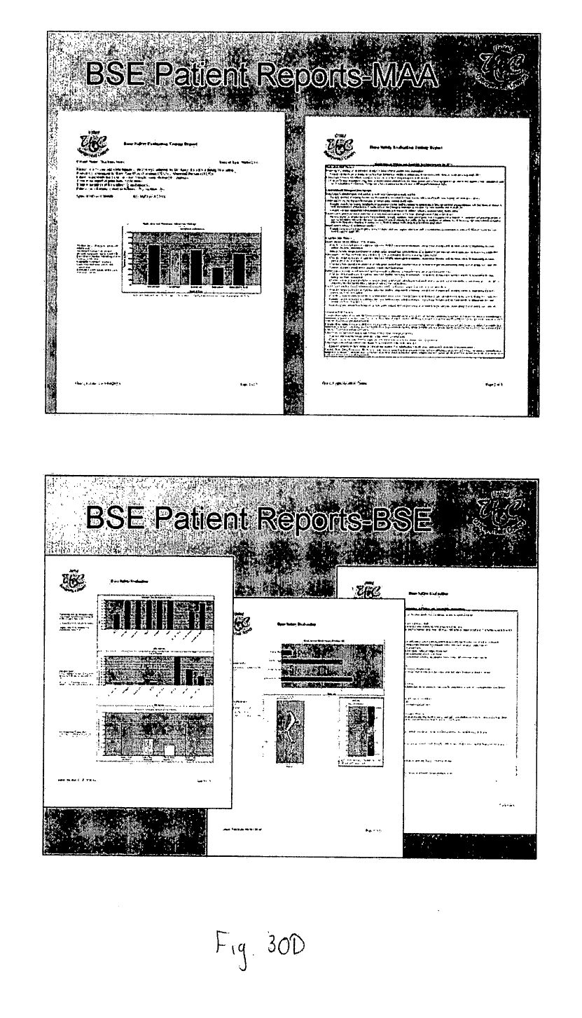

FIGS. 30A-30D illustrates screenshots of webpages implemented in accordance with exemplary embodiments.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magnento-optical disks; and CD-ROM disks. Any of the foregoing may be supplemented by, or incorporated in, specially designed application specific integrated circuits (ASICs).

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A method, comprising:
identifying a patient;
applying a first criteria set to the identified patient;
determining whether the patient has maintained within compliance as determined by the first criteria set; and
applying a second criteria set to the identified patient.

2. The method as claimed in claim 1 wherein applying the first criteria set further comprises having the identified patient provide a history of whether the identified patient has used a medication type.

3. The method as claimed in claim 2 further comprising soliciting responses from the identified patient.

4. A method, comprising:
identifying a patient;
optionally soliciting responses based on a first criteria set from the patient if the patient has no prior use of a first medication;
soliciting responses based on a second criteria set from the patient on the use of the first medication;
determining whether the patient has maintained compliance with the first medication;
soliciting responses based on a third criteria set if the patient has been non-compliant; and
soliciting responses based on a fourth criteria set if the patient has been compliant.

5. The method as claimed in claim 4 wherein the first criteria set includes questions based on at least one of no prior use and no history of taking the first medication.

6. The method as claimed in claim 4 wherein the second criteria set includes questions based on at least on of current use and history of taking the first medication type.

7. The method as claimed in claim 4 wherein the third criteria set includes questions based on non-adherence or dissatisfaction in taking the first medication.

8. The method as claimed in claim 4 wherein the fourth criteria set includes questions based on adherence to the medication.

9. The method as claimed in claim 4 wherein the medication is bone building medication.

10. The method as claimed in claim 8 wherein the medication is bone building medication.

11. The method as claimed in claim 10 wherein the bone building medication is chosen from the group consisting of: Fosamax®, Actonel® MAS, Evista® MAS, Ibandronate MAS, Didronel® MAS, Miacalcin® MAS, Forteo® MAS, Zometa® MAS and Aredia® MAS.

12. The method as claimed in claim 4 further comprising allowing a first period of time to pass between optionally soliciting responses based on a first criteria set from the patient if the patient has no prior use of a first medication and soliciting responses based on a second criteria set from the patient on the use of the first medication.

13. The method as claimed in claim 4 further comprising allowing a second period of time to pass between soliciting responses based on a second criteria set from the patient on the use of the first medication and soliciting responses based on a third criteria set if the patient has been non-compliant and soliciting responses based on a fourth criteria set if the patient has been compliant.

14. The method as claimed in claim 4 wherein the first set of criteria includes patient risk factors

15. The method as claimed in claim 14 wherein the risk factors include lifestyle and perception risk.

16. The method as claimed in claim 14 wherein the risk factors include medication risk.

17. The method as claimed in claim 14 wherein the risk factors include awareness risk.

18. The method as claimed in claim 14 wherein the risk factors include cognition risk.
